(19) United States
(12) Patent Application Publication
(10) Pub. No.: US 2026/0323669 A1
(43) Pub. Date: Oct. 15, 2026

(54) Sidelink Feedback Channel

(71) Applicant: Ofinno, LLC, Reston, VA (US)

(72) Inventors: Hyoungsuk Jeon, Centreville, VA (US); Huifa Lin, Herndon, VA (US); Esmael Hejazi Dinan, McLean, VA (US); Nazanin Rastegardoost, Arlington, VA (US); Gautham Prasad, Herndon, VA (US); Hua Zhou, Vienna, VA (US); Ali Cagatay Cirik, Chantilly, VA (US); Ryan Keating, Chicago, IL (US)

(73) Assignee: Ofinno, LLC, Reston, VA (US)

(21) Appl. No.: 19/705,336

(22) Filed: Jun. 11, 2026

Related U.S. Application Data
(63) Continuation of application No. PCT/US2024/059587, filed on Dec. 11, 2024.
(60) Provisional application No. 63/608,541, filed on Dec. 11, 2023.

(51) Int. Cl. H04W 72/25; H04B 7/06; H04L 1/1867

(52) U.S. Cl. CPC H04W 72/25; H04B 7/06964; H04L 1/1896

(57) ABSTRACT

A first wireless device determines that one or more first physical sidelink feedback channels (PSFCHs) are scheduled for transmission via a PSFCH resource and that one or more second PSFCHs are scheduled for reception via the same PSFCH resource. The device prioritizes a first PSFCH over a second PSFCH based on the first PSFCH containing beam information, where the first PSFCH and the second PSFCH are from different ones of the first PSFCHs or the second PSFCHs. Based on the prioritization, the device transmits the first PSFCH via the PSFCH resource when the first PSFCH is from the one or more first PSFCHs, or receives the first PSFCH via the PSFCH resource when the first PSFCH is from the one or more second PSFCHs.

### CROSS-REFERENCE TO RELATED APPLICATIONS

This application is a continuation of International Application No. PCT/US2024/059587, filed Dec. 11, 2024, which claims the benefit of U.S. Provisional Application No. 63/608,541, filed Dec. 11, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates examples of device-to-device (D2D) communication as per an aspect of an example embodiment of the present disclosure.

FIG. 18 illustrates an example of a resource pool for sidelink operations as per an aspect of an example embodiment of the present disclosure.

FIG. 19 illustrates an example of sidelink symbols in a slot as per an aspect of an example embodiment of the present disclosure.

FIG. 20 illustrates an example of resource indication for a first TB (e.g, a first data packet) and resource reservation for a second TB (e.g., a second data packet) as per an aspect of an example embodiment of the present disclosure.

FIG. 21 illustrates an example of configuration information for sidelink communication as per an aspect of an example embodiment of the present disclosure.

FIG. 22 illustrates an example of configuration information for sidelink communication as per an aspect of an example embodiment of the present disclosure.

FIG. 23 illustrates an example format of a MAC subheader for sidelink shared channel (SL-SCH) an aspect of an example embodiment of the present disclosure.

FIG. 24 illustrates an example time of a resource selection procedure as per an aspect of an example embodiment of the present disclosure.

FIG. 25 illustrates an example timing of a resource selection procedure as per an aspect of an example embodiment of the present disclosure.

FIG. 26 illustrates an example flowchart of a resource selection procedure by a wireless device for transmitting a TB via sidelink as per an aspect of an example embodiment of the present disclosure.

FIG. 27 illustrates an example diagram of the resource selection procedure among layers of the wireless device as per an aspect of an example embodiment of the present disclosure.

FIG. 28A and FIG. 28B illustrate examples of SL RSs as per an aspect of an example embodiment of the present disclosure.

FIG. 29A and FIG. 29B illustrate examples for SL RS transmission as per an aspect of an embodiment of the present disclosure.

FIG. 30A, FIG. 30B, FIG. 30C, and FIG. 30D illustrate examples of sidelink channels as per an aspect of an embodiment of the present disclosure.

FIG. 31 illustrates an example of simultaneous PSFCH transmission and receptions per an aspect of an embodiment of the present disclosure.

FIG. 32 illustrates an example of simultaneous PSFCH transmission and receptions per an aspect of an embodiment of the present disclosure.

FIG. 33 illustrates an example of PSFCH transmission per an aspect of an embodiment of the present disclosure.

FIG. 34 illustrates an example of PSFCH receptions per an aspect of an embodiment of the present disclosure.

FIG. 35 illustrates an example of simultaneous PSFCH transmission and receptions per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

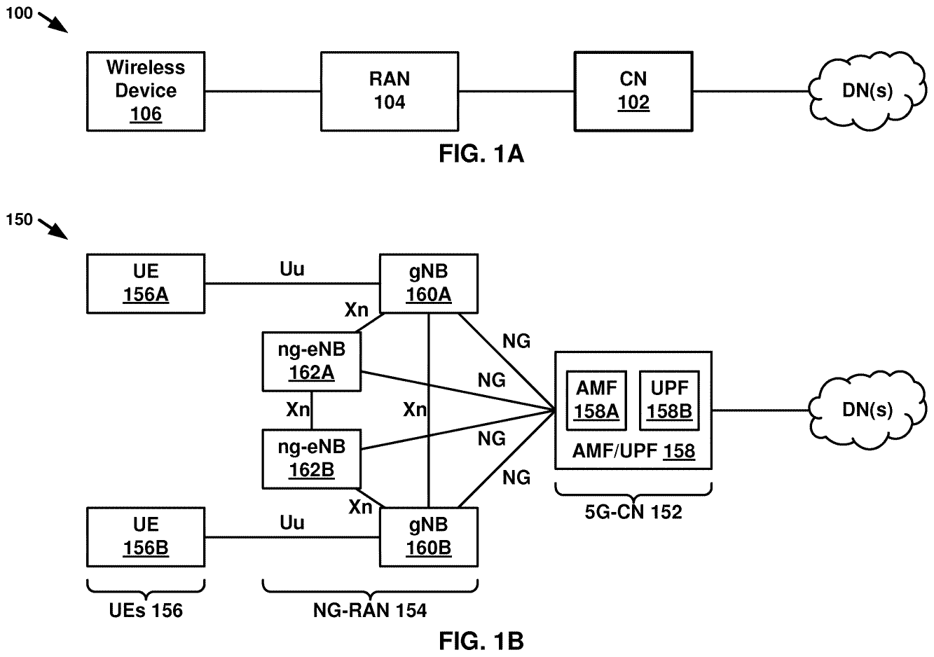

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

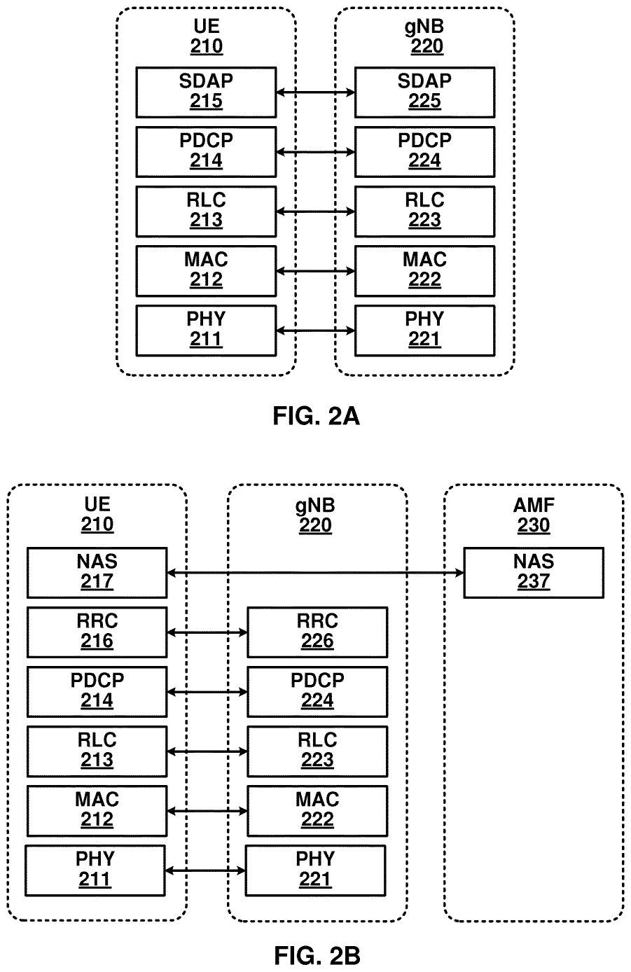

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

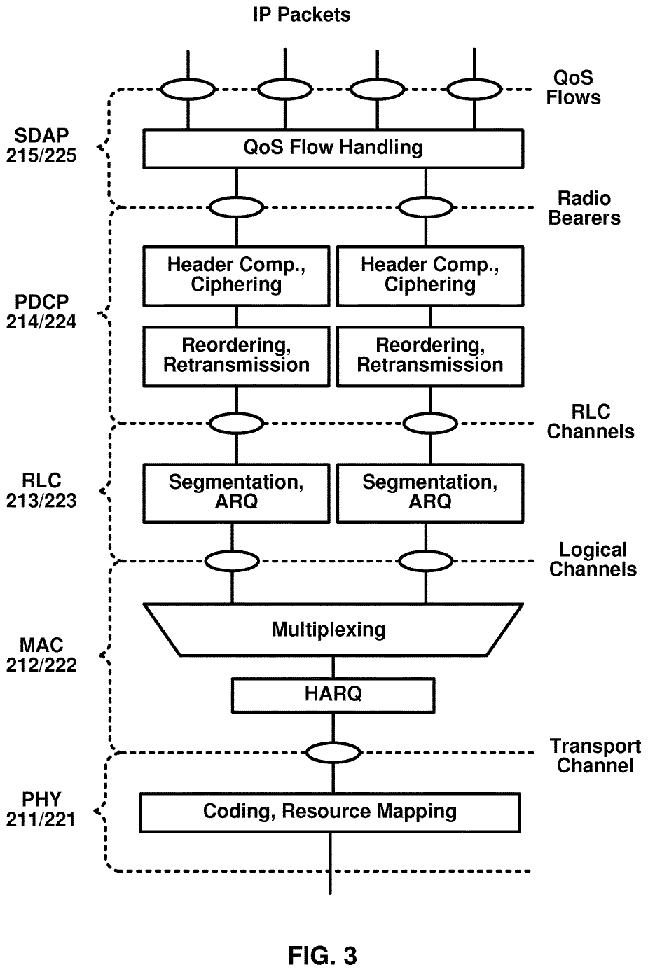

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

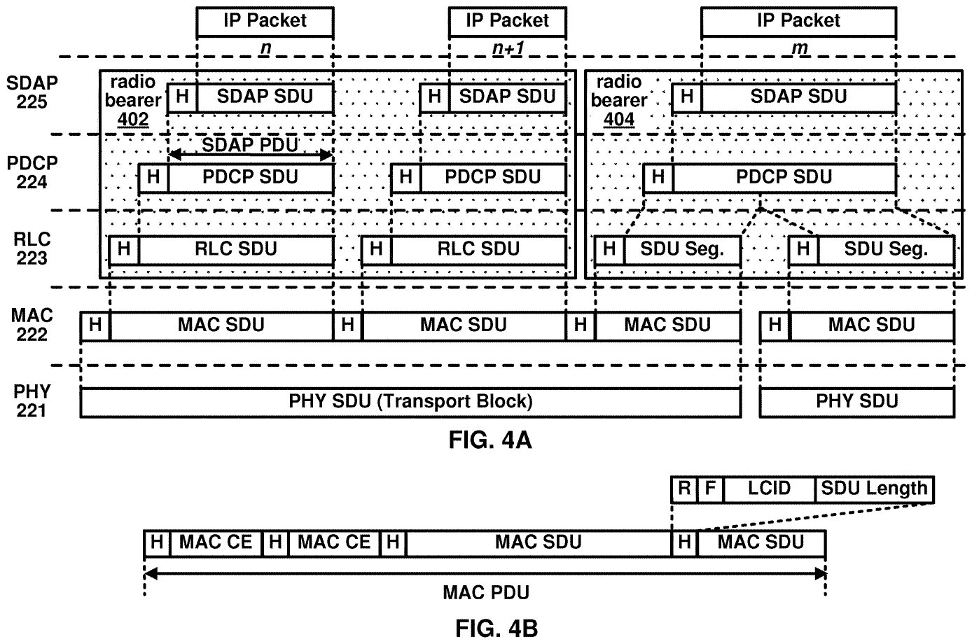

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 212 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

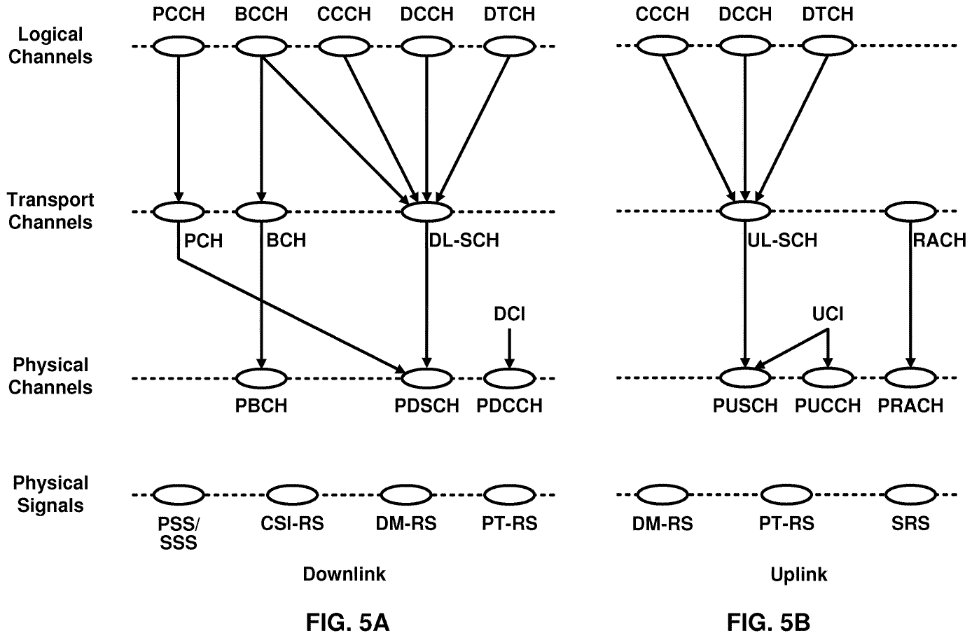

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

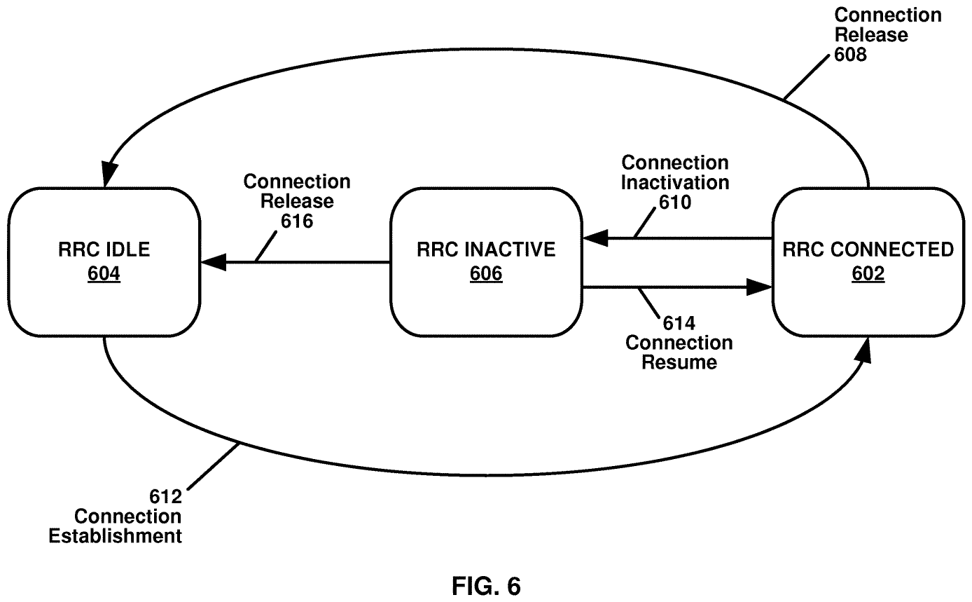

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

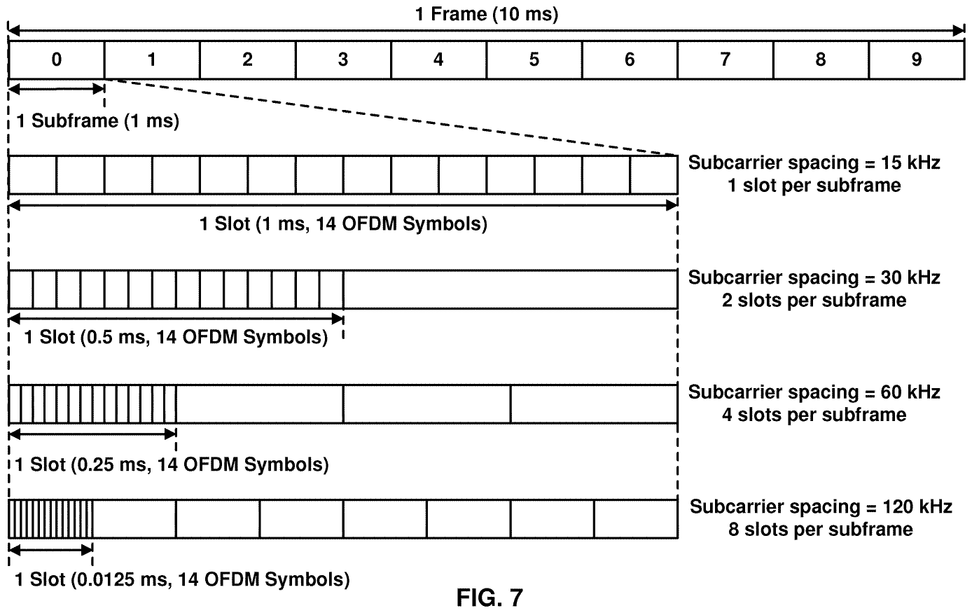

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 KHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

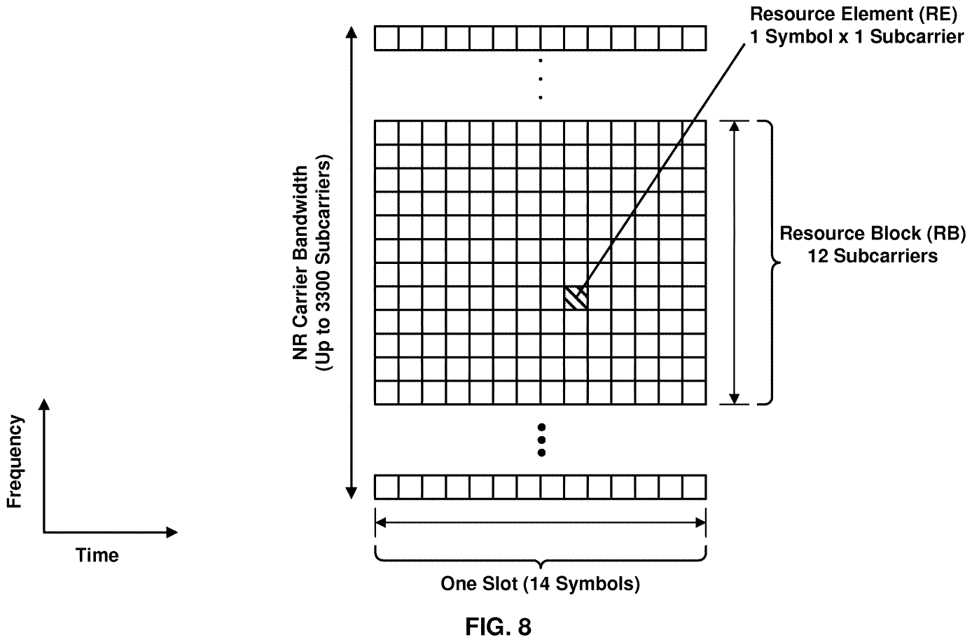

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 KHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

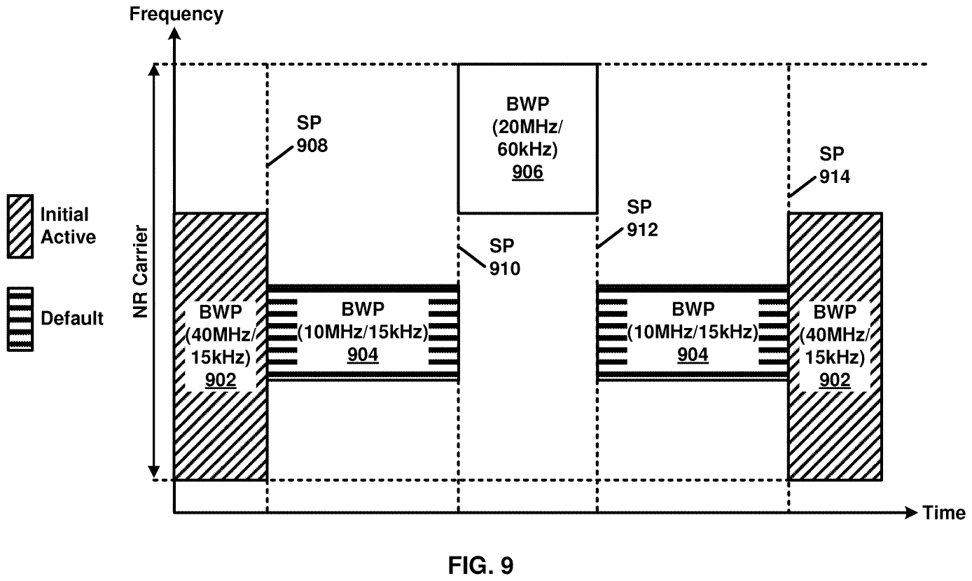

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 KHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

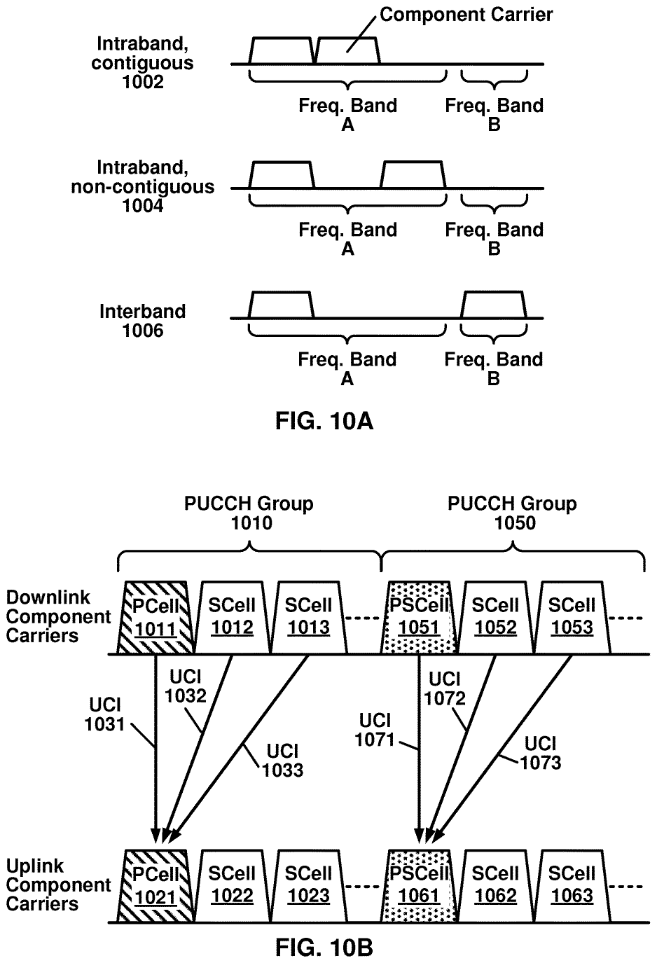

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

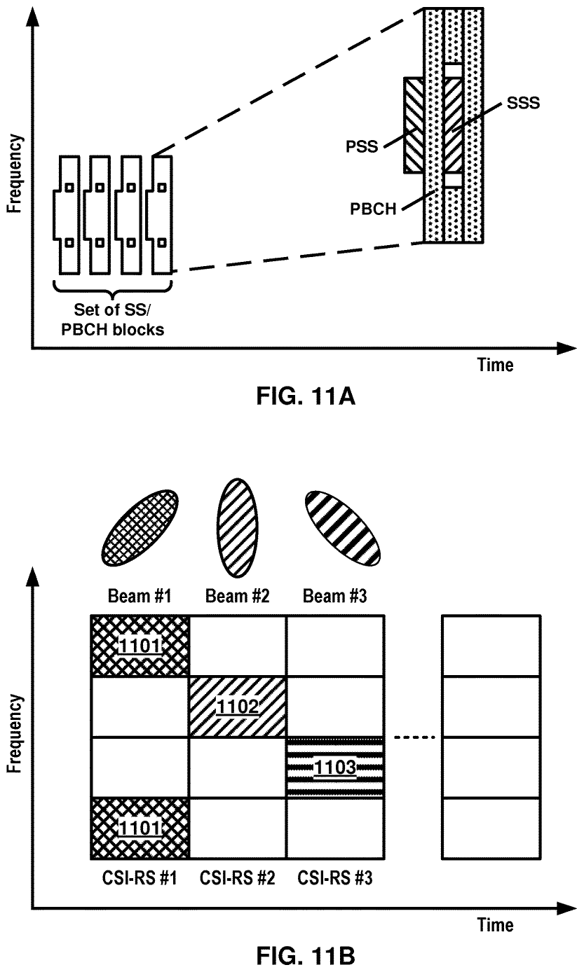

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

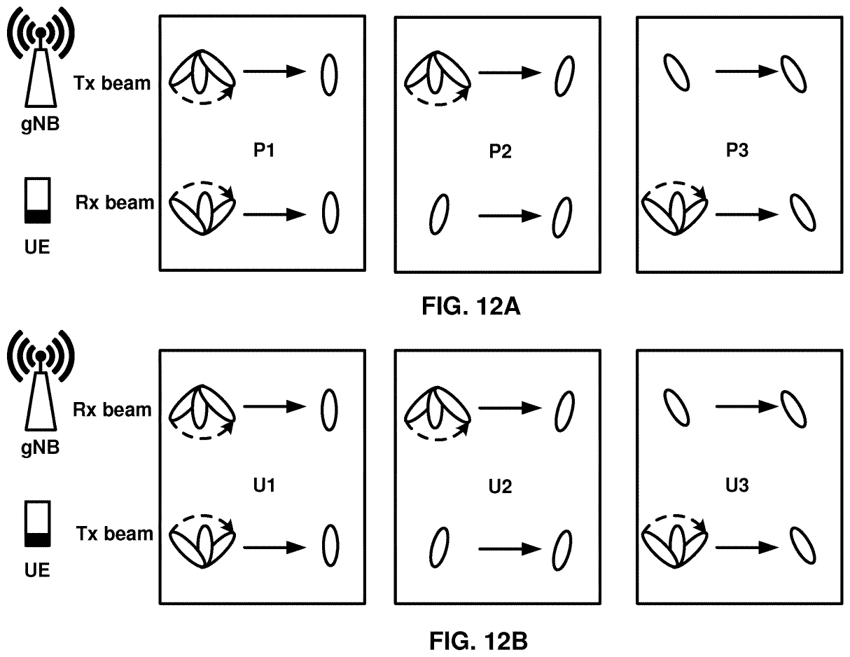

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

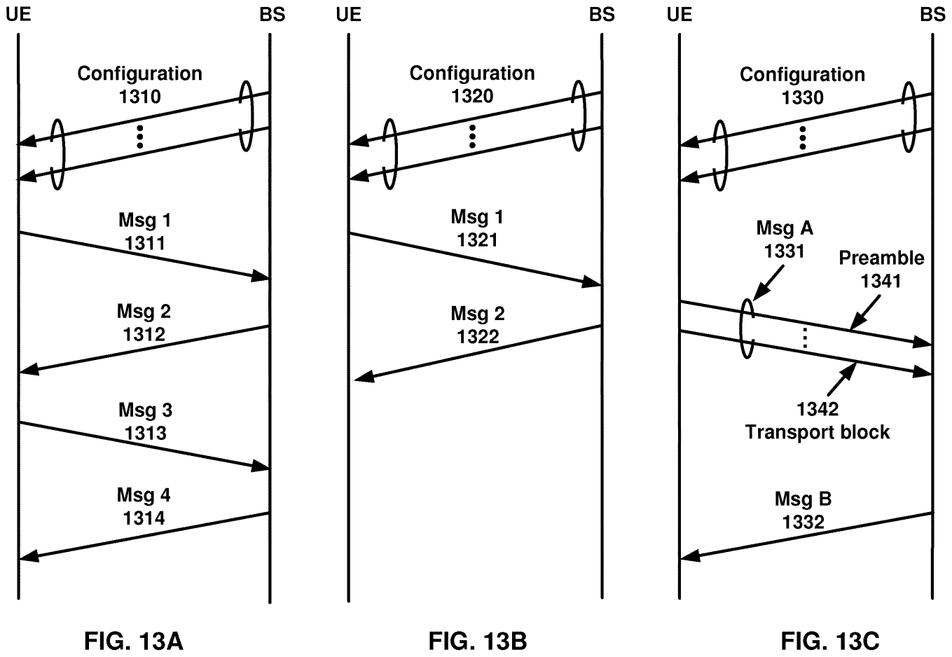

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:
RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceld). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

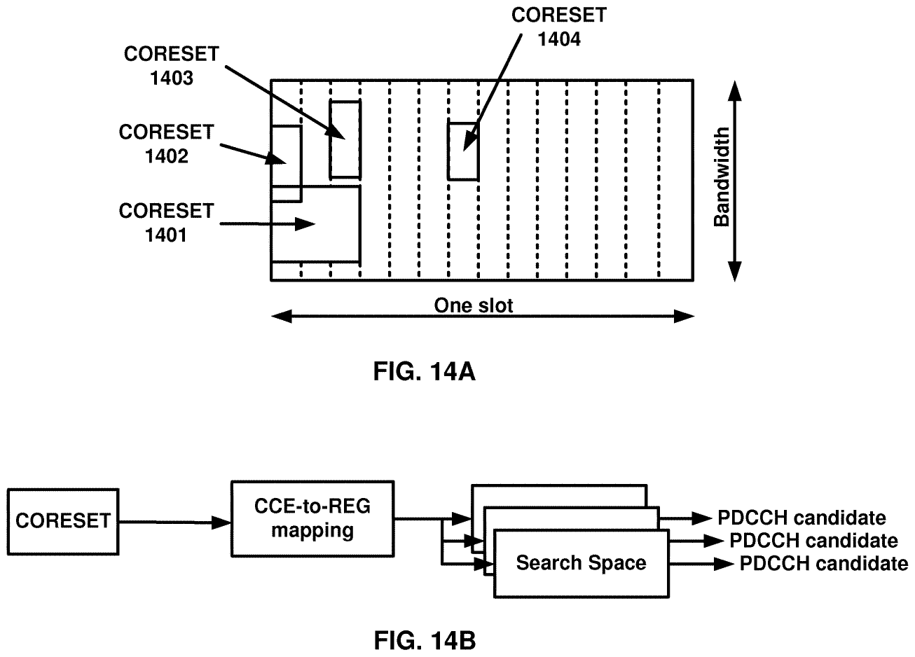

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

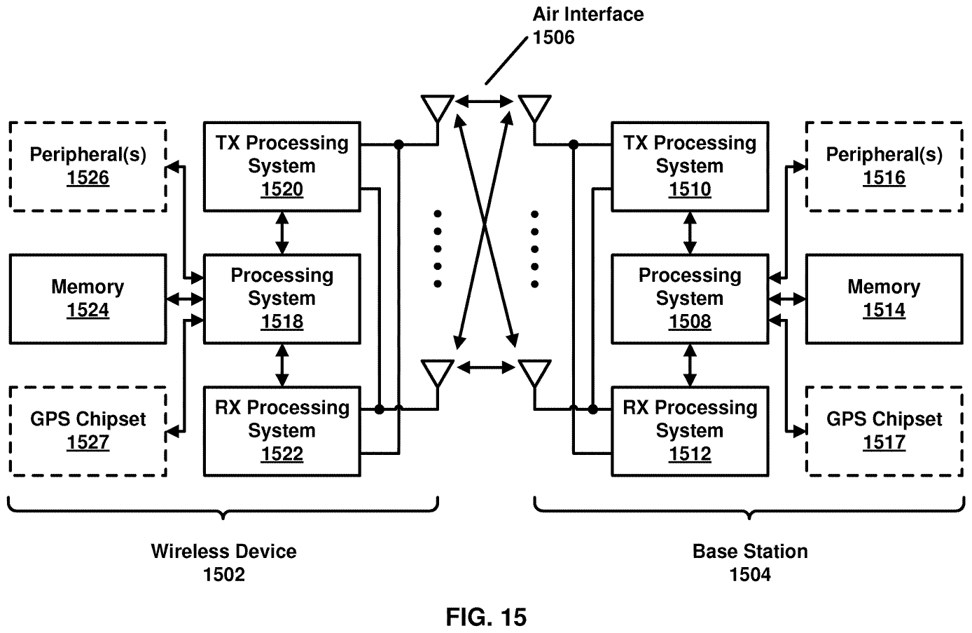

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

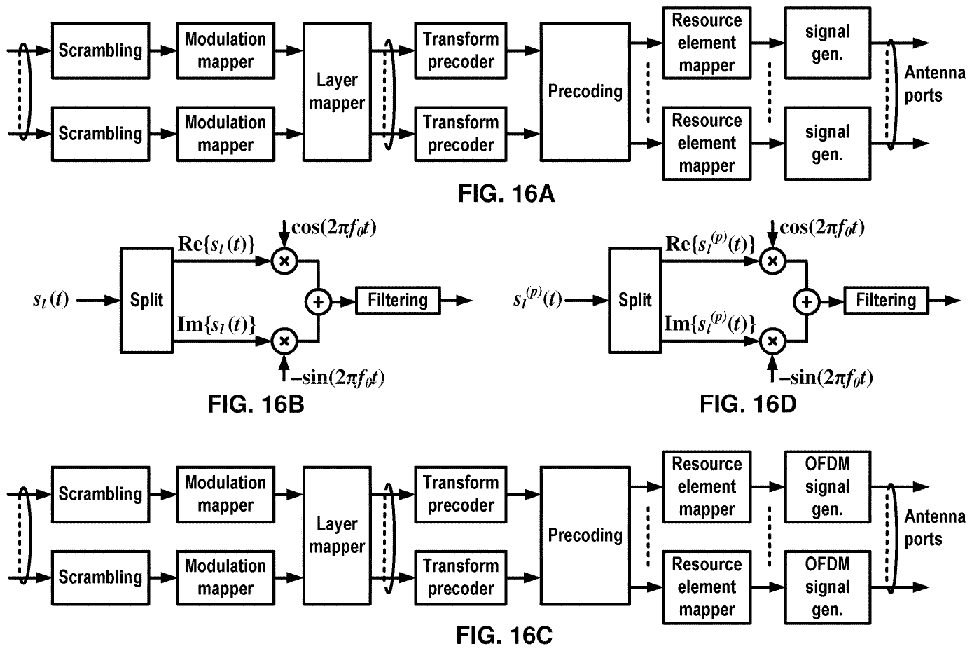

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

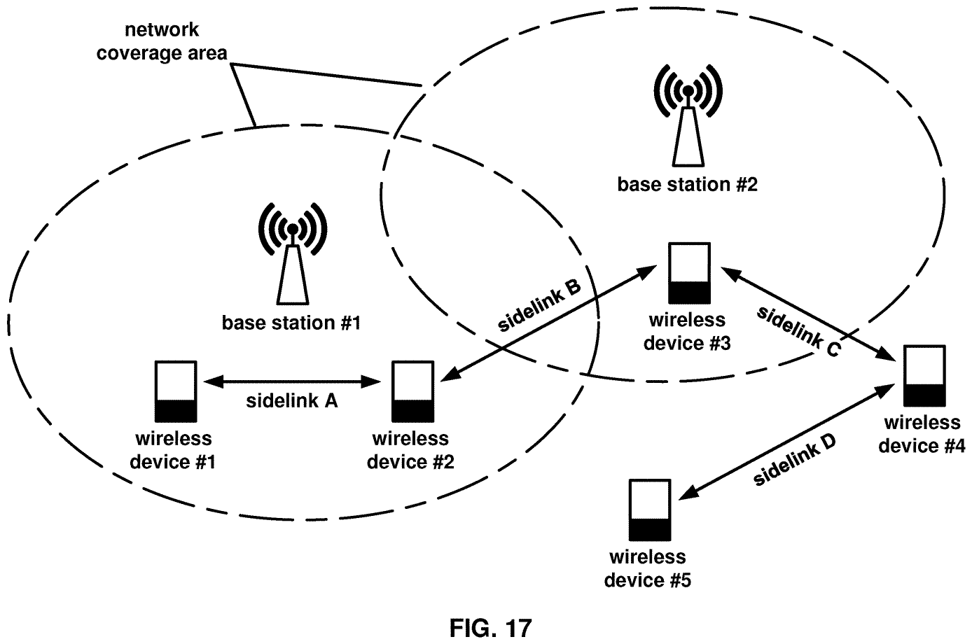

FIG. 17 illustrates examples of device-to-device (D2D) communication, in which there is a direct communication between wireless devices. In an example, D2D communication may be performed via a sidelink (SL). The wireless devices may exchange sidelink communications via a sidelink interface. The sidelink interface may refer to a PC5 interface, a Proximity-based Service (e.g., Direct) Communication (or control) 5 interface, and/or ProSe (e.g., Direct) Communication (or control) 5 interface. Sidelink differs from uplink (in which a wireless device communicates to a base station) and downlink (in which a base station communicates to a wireless device). A wireless device and a base station may exchange uplink and/or downlink communications via a user plane interface (e.g., a Uu interface).

As shown in the FIG. 17, wireless device #1 and wireless device #2 may be in a coverage area of base station #1. For example, both wireless device #1 and wireless device #2 may communicate with the base station #1 via a Uu interface. Wireless device #3 may be in a coverage area of base station #2. Base station #1 and base station #2 may share a network and may jointly provide a network coverage area. Wireless device #4 and wireless device #5 may be outside of the network coverage area.

In-coverage D2D communication may be performed when two wireless devices share a network coverage area. Wireless device #1 and wireless device #2 are both in the coverage area of base station #1. Accordingly, they may perform an in-coverage intra-cell D2D communication, labeled as sidelink A. Wireless device #2 and wireless device #3 are in the coverage areas of different base stations, but share the same network coverage area. Accordingly, they may perform an in-coverage inter-cell D2D communication, labeled as sidelink B. Partial-coverage D2D communications may be performed when one wireless device is within the network coverage area and the other wireless device is outside the network coverage area. Wireless device #3 and wireless device #4 may perform a partial-coverage D2D communication, labeled as sidelink C. Out-of-coverage D2D communications may be performed when both wireless devices are outside of the network coverage area. Wireless device #4 and wireless device #5 may perform an out-of-coverage D2D communication, labeled as sidelink D.

Sidelink communications may be configured using physical channels, for example, a physical sidelink broadcast channel (PSBCH), a physical sidelink feedback channel (PSFCH), a physical sidelink discovery channel (PSDCH), a physical sidelink control channel (PSCCH), and/or a physical sidelink shared channel (PSSCH). PSBCH may be used by a first wireless device to send broadcast information to a second wireless device. PSBCH may be similar in some respects to PBCH. The broadcast information may comprise, for example, a slot format indication, resource pool information, a sidelink system frame number, or any other suitable broadcast information. PSFCH may be used by a first wireless device to send feedback information to a second wireless device. The feedback information may comprise, for example, HARQ feedback information. PSDCH may be used by a first wireless device to send discovery information to a second wireless device. The discovery information may be used by a wireless device to signal its presence and/or the availability of services to other wireless devices in the area. PSCCH may be used by a first wireless device to send sidelink control information (SCI) to a second wireless device. PSCCH may be similar in some respects to PDCCH and/or PUCCH. The control information may comprise, for example, time/frequency resource allocation information (RB size, a number of retransmissions, etc.), demodulation related information (DMRS, MCS, RV, etc.), identifying information for a transmitting wireless device and/or a receiving wireless device, a process identifier (HARQ, etc.), or any other suitable control information. The PSCCH may be used to allocate, prioritize, and/or reserve sidelink resources for sidelink transmissions. PSSCH may be used by a first wireless device to send and/or relay data and/or network information to a second wireless device. PSSCH may be similar in some respects to PDSCH and/or PUSCH. Each of the sidelink channels may be associated with one or more demodulation reference signals. Sidelink operations may utilize sidelink synchronization signals to establish a timing of sidelink operations. Wireless devices configured for sidelink operations may send sidelink synchronization signals, for example, with the PSBCH. The sidelink synchronization signals may include primary sidelink synchronization signals (PSSS) and secondary sidelink synchronization signals (SSSS).

Sidelink resources may be configured to a wireless device in any suitable manner. A wireless device may be pre-configured for sidelink, for example, pre-configured with sidelink resource information. Additionally or alternatively, a network may broadcast system information relating to a resource pool for sidelink. Additionally or alternatively, a network may configure a particular wireless device with a dedicated sidelink configuration. The configuration may identify sidelink resources to be used for sidelink operation (e.g., configure a sidelink band combination).

The wireless device may operate in different modes, for example, an assisted mode (which may be referred to as mode 1) or an autonomous mode (which may be referred to as mode 2). Mode selection may be based on a coverage status of the wireless device, a radio resource control status of the wireless device, information and/or instructions from the network, and/or any other suitable factors. For example, if the wireless device is idle or inactive, or if the wireless device is outside of network coverage, the wireless device may select to operate in autonomous mode. For example, if the wireless device is in a connected mode (e.g., connected to a base station), the wireless device may select to operate (or be instructed by the base station to operate) in assisted mode. For example, the network (e.g., a base station) may instruct a connected wireless device to operate in a particular mode.

In an assisted mode, the wireless device may request scheduling from the network. For example, the wireless device may send a scheduling request to the network and the network may allocate sidelink resources to the wireless device. Assisted mode may be referred to as network-assisted mode, gNB-assisted mode, or base station-assisted mode. In an autonomous mode, the wireless device may select sidelink resources based on measurements within one or more resource pools (for example, pre-configure or network-assigned resource pools), sidelink resource selections made by other wireless devices, and/or sidelink resource usage of other wireless devices.

To select sidelink resources, a wireless device may observe a sensing window and a selection window. During the sensing window, the wireless device may observe SCI transmitted by other wireless devices using the sidelink resource pool. The SCIs may identify resources that may be used and/or reserved for sidelink transmissions. Based on the resources identified in the SCIs, the wireless device may select resources within the selection window (for example, resources that are different from the resources identified in the SCIs). The wireless device may transmit using the selected sidelink resources.

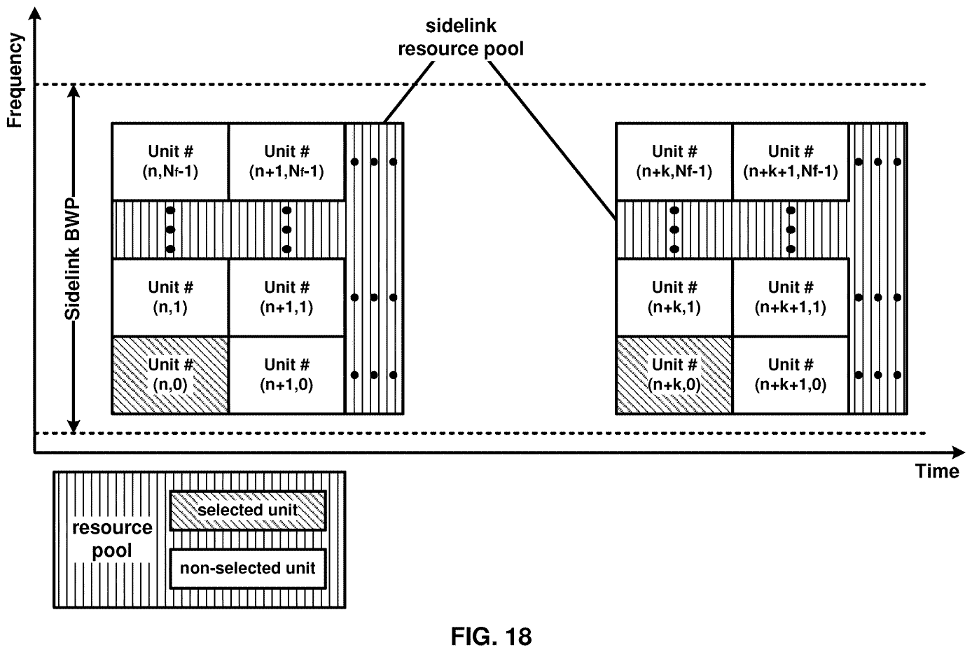

FIG. 18 illustrates an example of a resource pool for sidelink operations. A wireless device may operate using one or more sidelink cells. A sidelink cell may include one or more resource pools. Each resource pool may be configured to operate in accordance with a particular mode (for example, assisted or autonomous). The resource pool may be divided into resource units. In the frequency domain, each resource unit may comprise, for example, one or more resource blocks which may be referred to as a sub-channel. In the time domain, each resource unit may comprise, for example, one or more slots, one or more subframes, and/or one or more OFDM symbols. The resource pool may be continuous or non-continuous in the frequency domain and/or the time domain (for example, comprising contiguous resource units or non-contiguous resource units). The resource pool may be divided into repeating resource pool portions. The resource pool may be shared among one or more wireless devices. Each wireless device may attempt to transmit using different resource units, for example, to avoid collisions.

Sidelink resource pools may be arranged in any suitable manner. In the figure, the example resource pool is non-contiguous in the time domain and confined to a single sidelink BWP. In the example resource pool, frequency resources are divided into a Nf resource units per unit of time, numbered from zero to Nf−1. The example resource pool may comprise a plurality of portions (non-contiguous in this example) that repeat every k units of time. In the figure, time resources are numbered as n, n+1 . . . n+k, n+k+1 . . . , etc.

A wireless device may select for transmission one or more resource units from the resource pool. In the example resource pool, the wireless device selects resource unit (n,0) for sidelink transmission. The wireless device may further select periodic resource units in later portions of the resource pool, for example, resource unit (n+k,0), resource unit (n+2k,0), resource unit (n+3k,0), etc. The selection may be based on, for example, a determination that a transmission using resource unit (n,0) will not (or is not likely) to collide with a sidelink transmission of a wireless device that shares the sidelink resource pool. The determination may be based on, for example, behavior of other wireless devices that share the resource pool. For example, if no sidelink transmissions are detected in resource unit (n-k,0), then the wireless device may select resource unit (n,0), resource (n+k,0), etc. For example, if a sidelink transmission from another wireless device is detected in resource unit (n-k,1), then the wireless device may avoid selection of resource unit (n,1), resource (n+k,1), etc.

Different sidelink physical channels may use different resource pools. For example, PSCCH may use a first resource pool and PSSCH may use a second resource pool. Different resource priorities may be associated with different resource pools. For example, data associated with a first QoS, service, priority, and/or other characteristic may use a first resource pool and data associated with a second QoS, service, priority, and/or other characteristic may use a second resource pool. For example, a network (e.g., a base station) may configure a priority level for each resource pool, a service to be supported for each resource pool, etc. For example, a network (e.g., a base station) may configure a first resource pool for use by unicast UEs, a second resource pool for use by groupcast UEs, etc. For example, a network (e.g., a base station) may configure a first resource pool for transmission of sidelink data, a second resource pool for transmission of discovery messages, etc.

In an example of vehicle-to-everything (V2X) communications via a Uu interface and/or a PC5 interface, the V2X communications may be vehicle-to-vehicle (V2V) communications. A wireless device in the V2V communications may be a vehicle. In an example, the V2X communications may be vehicle-to-pedestrian (V2P) communications. A wireless device in the V2P communications may be a pedestrian equipped with a mobile phone/handset. In an example, the V2X communications may be vehicle-to-infrastructure (V2I) communications. The infrastructure in the V2I communications may be a base station/access point/node/road side unit. A wireless device in the V2X communications may be a transmitting wireless device performing one or more sidelink transmissions to a receiving wireless device. The wireless device in the V2X communications may be a receiving wireless device receiving one or more sidelink transmissions from a transmitting wireless device.

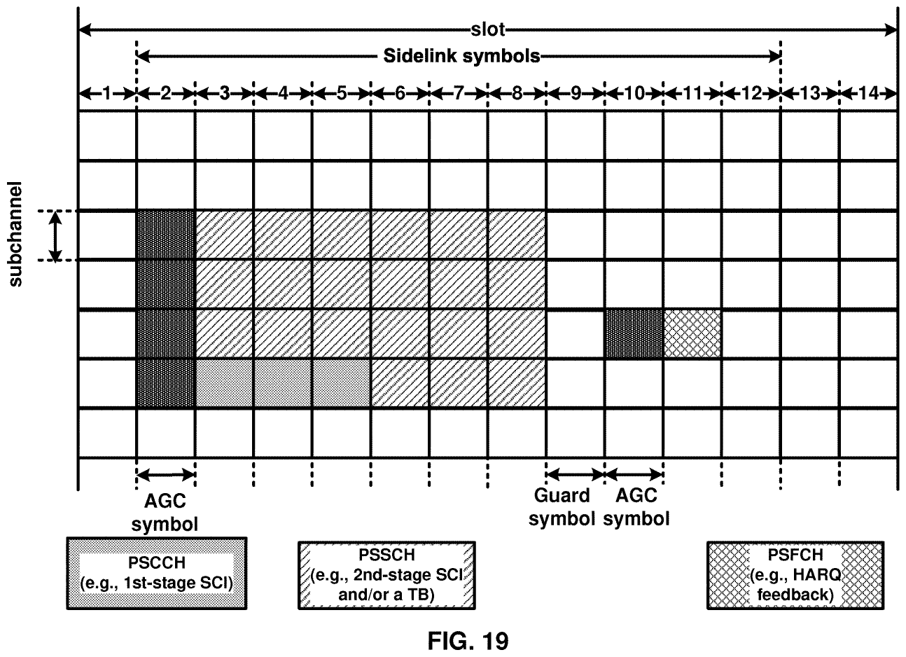

FIG. 19 illustrates an example of sidelink symbols in a slot. In an example, a sidelink transmission may be transmitted in a slot in the time domain. In an example, a wireless device may have data to transmit via sidelink. The wireless device may segment the data into one or more transport blocks (TBs). The one or more TBs may comprise different pieces of the data. A TB of the one or more TBs may be a data packet of the data. The wireless device may transmit a TB of the one or more TBs (e.g., a data packet) via one or more sidelink transmissions (e.g., via PSCCH/PSSCH in one or more slots). In an example, a sidelink transmission (e.g., in a slot) may comprise SCI. The sidelink transmission may further comprise a TB. The SCI may comprise a 1^{st}-stage SCI and a 2^{nd}-stage SCI. A PSCCH of the sidelink transmission may comprise the 1^{st}-stage SCI for scheduling a PSSCH (e.g., the TB). The PSSCH of the sidelink transmission may comprise the 2^{nd}-stage SCI. The PSSCH of the sidelink transmission may further comprise the TB. In an example, sidelink symbols in a slot may or may not start from the first symbol of the slot. The sidelink symbols in the slot may or may not end at the last symbol of the slot. In an example of FIG. 19, sidelink symbols in a slot start from the second symbol of the slot. In an example of FIG. 19, the sidelink symbols in the slot end at the twelfth symbol of the slot. A first sidelink transmission may comprise a first automatic gain control (AGC) symbol (e.g., the second symbol in the slot), a PSCCH (e.g., in the third, fourth and the fifth symbols in a sub-channel in the slot), a PSSCH (e.g., from the third symbol to the eighth symbol in the slot), and/or a first guard symbol (e.g., the ninth symbol in the slot). A second sidelink transmission may comprise a second AGC symbol (e.g., the tenth symbol in the slot), a PSFCH (e.g., the eleventh symbol in the slot), and/or a second guard symbol for the second sidelink transmission (e.g., the twelfth symbol in the slot). In an example, one or more HARQ feedbacks (e.g., positive acknowledgement or ACK and/or negative acknowledgement or NACK) may be transmitted via the PSFCH. In an example, the PSCCH, the PSSCH, and the PSFCH may have different number of sub-channels (e.g., a different number of frequency resources) in the frequency domain.

The 1st-stage SCI may be a SCI format 1-A. The SCI format 1-A may comprise a plurality of fields used for scheduling of the first TB on the PSSCH and the 2nd-stage SCI on the PSSCH. The following information may be transmitted by means of the SCI format 1-A.
A priority of the sidelink transmission. For example, the priority may be a physical layer (e.g., layer 1) priority of the sidelink transmission. For example, the priority may be determined based on logical channel priorities of the sidelink transmission;
Frequency resource assignment of the PSSCH;
Time resource assignment of the PSSCH;
Resource reservation period/interval for a second TB;
Demodulation reference signal (DMRS) pattern;
A format of the 2^{nd}-stage SCI;
Beta_offset indicator,
Number of DMRS port,
Modulation and coding scheme of the PSSCH;
Additional MCS table indicator,
PSFCH overhead indication;
Reserved bits.

The 2nd-stage SCI may be a SCI format 2-A. The SCI format 2-A may be used for the decoding of the PSSCH, with HARQ operation when HARQ-ACK information includes ACK or NACK, or when there is no feedback of HARQ-ACK information. The SCI format 2-A may comprise a plurality of fields indicating the following information.
HARQ process number,
New data indicator,
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator,
Cast type indicator indicating that the sidelink transmission is a broadcast, a groupcast and/or a unicast;
CSI request.

The 2nd-stage SCI may be a SCI format 2-B. The SCI format 2-B may be used for the decoding of the PSSCH, with HARQ operation when HARQ-ACK information includes only NACK, or when there is no feedback of HARQ-ACK information. The SCI format 2-B may comprise a plurality of fields indicating the following information.
HARQ process number,
New data indicator,
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator,
Zone ID indicating a zone in which a transmitter (e.g., a transmitting wireless device) of the sidelink transmission is geographic located;
Communication range requirement indicating a communication range of the sidelink transmission.

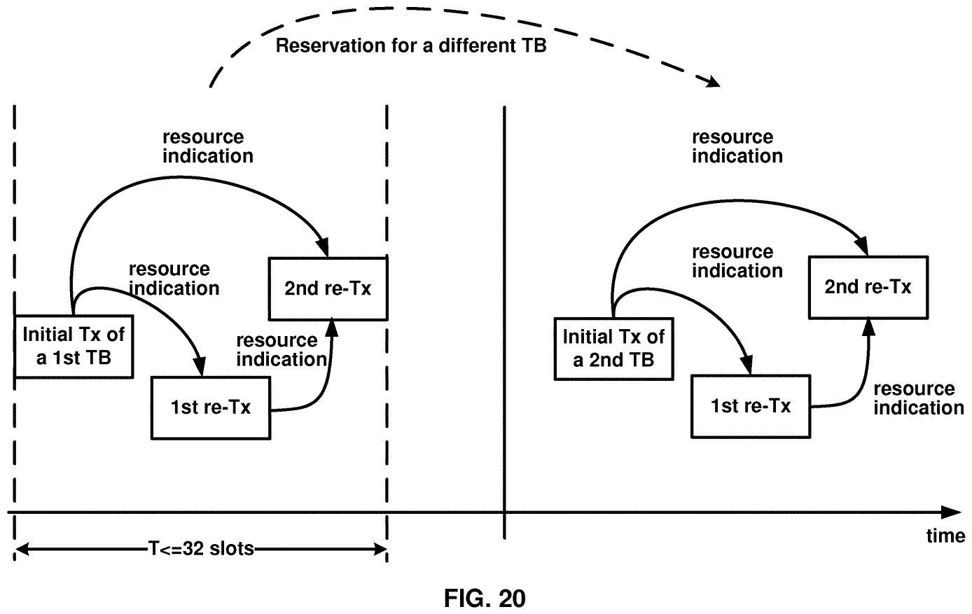

FIG. 20 illustrates an example of resource indication for a first TB (e.g., a first data packet) and resource reservation for a second TB (e.g., a second data packet). SCI of an initial transmission (e.g., a first transmission) and/or retransmission of the first TB may comprise one or more first parameters (e.g., Frequency resource assignment and Time resource assignment) indicating one or more first time and frequency (T/F) resources for transmission and/or retransmission of the first TB. The SCI may further comprise one or more second parameters (e.g., Resource reservation period) indicating a reservation period/interval of one or more second T/F resources for initial transmission and/or retransmission of the second TB.

In an example, in response to triggering a resource selection procedure, a wireless device may select one or more first T/F resources for initial transmission and/or retransmission of a first TB. As shown in FIG. 20, the wireless device may select three resources for transmitting the first TB. The wireless device may transmit an initial transmission (initial Tx of a first TB in FIG. 20) of the first TB via a first resource of the three resources. The wireless device may transmit a first retransmission (1st re-Tx in FIG. 20) of the first TB via a second resource of the three resources. The wireless device may transmit a second retransmission (2nd re-Tx in FIG. 20) of the first TB via a third resource of the three resources. A time duration between a starting time of the initial transmission of the first TB and the second retransmission of the first TB may be smaller than or equal to 32 sidelink slots (e.g., T≤32 slots in FIG. 20). A first SCI may be associated with the initial transmission of the first TB. The first SCI may indicate a first T/F resource indication for the initial transmission of the first TB, the first retransmission of the first TB and the second retransmission of the first TB. The first SCI may further indicate a reservation period/interval of resource reservation for a second TB. A second SCI may be associated with the first retransmission of the first TB. The second SCI may indicate a second T/F resource indication for the first retransmission of the first TB and the second retransmission of the first TB. The second SCI may further indicate the reservation period/interval of resource reservation for the second TB. A third SCI may be associated with the second retransmission of the first TB. The third SCI may indicate a third T/F resource indication for the second retransmission of the first TB. The third SCI may further indicate the reservation period/interval of resource reservation for the second TB.

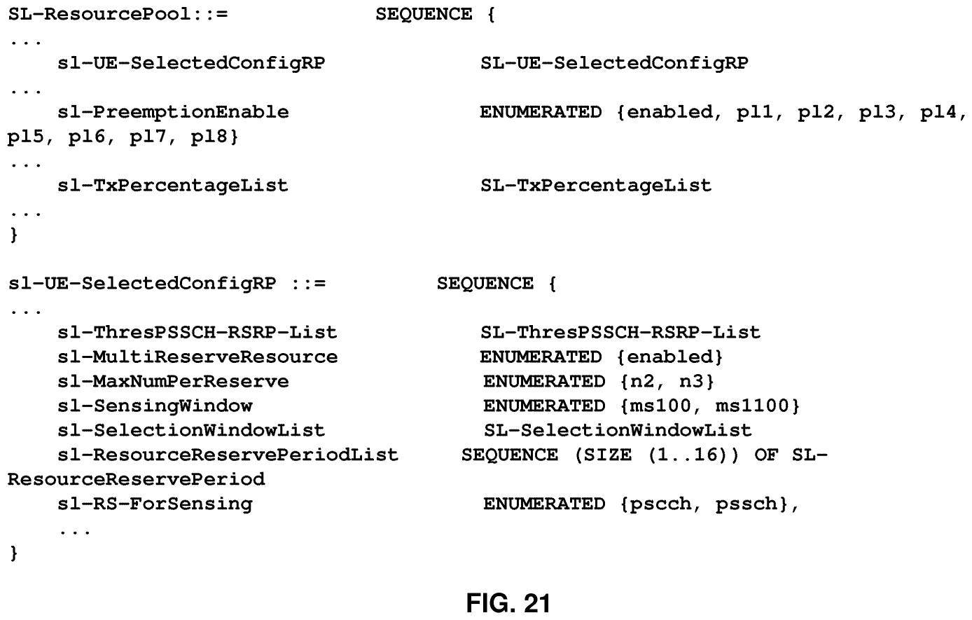

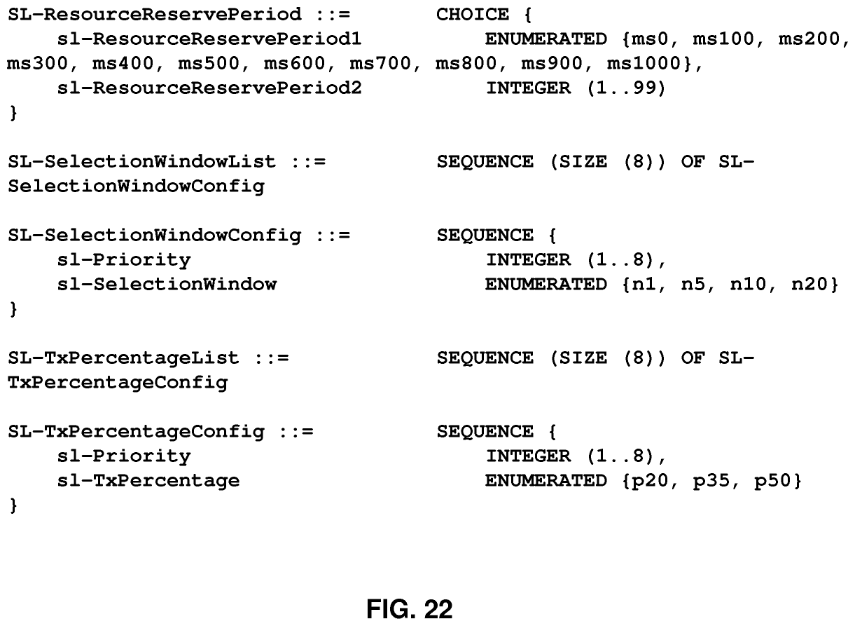

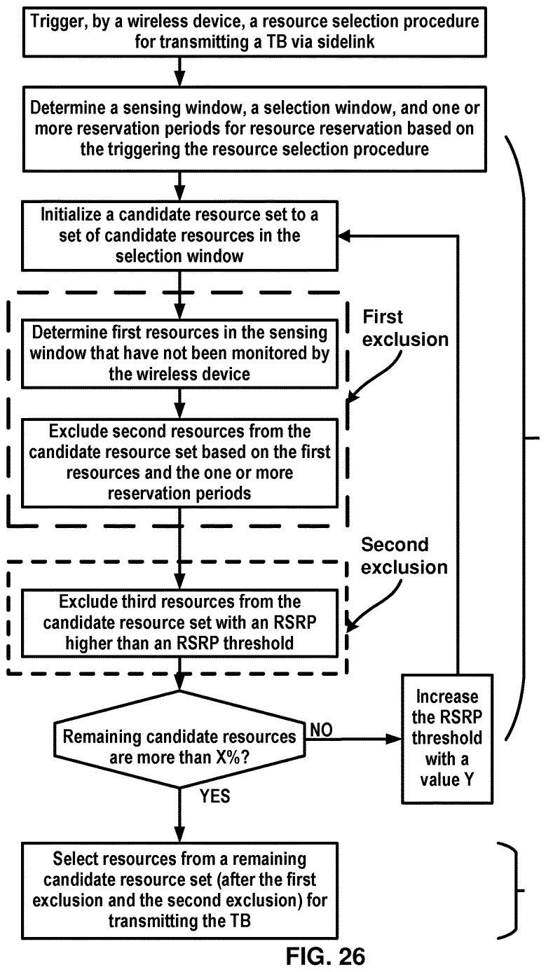

FIG. 21 and FIG. 22 illustrate examples of configuration information for sidelink communication. In an example, a base station may transmit one or more radio resource control (RRC) messages to a wireless device for delivering the configuration information for the sidelink communication. The configuration information may comprise a field of sl-UE-SelectedConfigRP. A parameter sl-ThresPSSCH-RSRP-List in the field may indicate a list of 64 thresholds. In an example, a wireless device may receive first sidelink control information (SCI) indicating a first priority. The wireless device may have second SCI to be transmitted. The second SCI may indicate a second priority. The wireless device may select a threshold from the list based on the first priority in the first SCI and the second priority in the second SCI. Referring to second exclusion in FIG. 26, the wireless device may exclude resources from candidate resource set based on the threshold. A parameter sl-MaxNumPerReserve in the field may indicate a maximum number of reserved PSCCH/PSSCH resources indicated in an SCI. A parameter sl-MultiReserveResource in the field may indicate if it is allowed to reserve a sidelink resource for an initial transmission of a TB by an SCI associated with a different TB, based on sensing and resource selection procedure. A parameter sl-ResourceReservePeriodList may indicate a set of possible resource reservation periods/intervals (e.g., SL-ResourceReservedPeriod) allowed in a resource pool. Up to 16 values may be configured per resource pool. A parameter sl-RS-ForSensing may indicate whether DMRS of PSCCH or PSSCH is used for layer 1 (e.g., physical layer) RSRP measurement in sensing operation. A parameter sl-SensingWindow may indicate a start of a sensing window. A parameter sl-SelectionWindowList may indicate an end of a selection window in resource selection procedure for a TB with respect to priority indicated in SCI. Value n1 may correspond to 1*2μ, value n5 corresponds to 5*2μ, and so on, where μ=0,1,2,3 for subcarrier spacing (SCS) of 15, 30, 60, and 120 KHz respectively. A parameter SL-SelectionWindowConfig may indicate a mapping between a sidelink priority (e.g., sl-Priority) and the end of the selection window (e.g., sl-SelectionWindow).

The configuration information may comprise a parameter sl-PreemptionEnable indicating whether sidelink pre-emption is disabled or enabled in a resource pool. For example, a priority level p_preemption may be configured if the sidelink pre-emption is enabled. For example, if the sidelink pre-emption is enabled but the p_preemption is not configured, the sidelink pre-emption may be applicable to all priority levels.

The configuration information may comprise a parameter sl-TxPercentageList indicating a portion of candidate single-slot PSSCH resources over total resources. For example, value p20 may correspond to 20%, and so on. A parameter SL-TxPercentageConfig may indicate a mapping between a sidelink priority (e.g., sl-Priority) and the portion of candidate single-slot PSSCH resources over total resources (e.g., sl-TxPercentage).

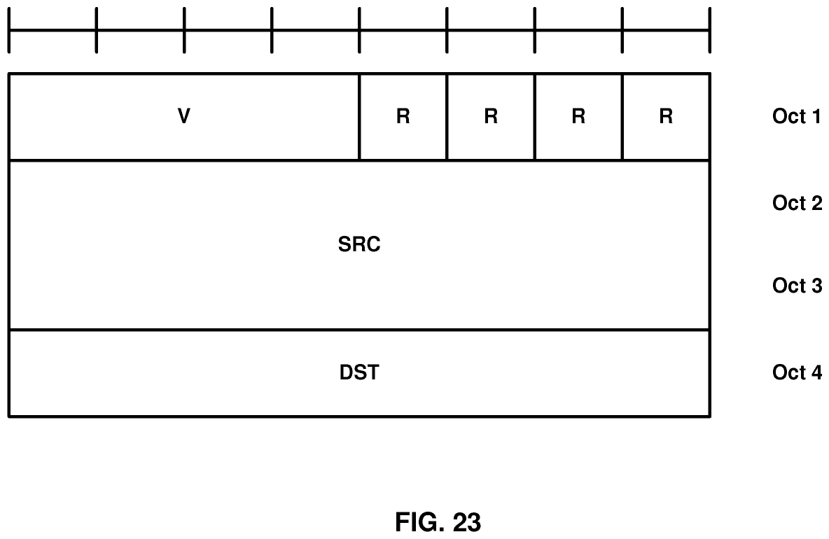

FIG. 23 illustrates an example format of a MAC subheader for sidelink shared channel (SL-SCH and/or SL MAC SDU). The MAC subheader for SL-SCH (and/or SL MAC SDU) may comprise seven header fields V/R/R/R/R/SCR/DST. The MAC subheader is octet aligned. For example, the V field may be a MAC protocol date units (PDU) format version number field indicating which version of the SL-SCH subheader is used. For example, the SRC field may carry 16 bits of a Source Layer-2 identifier (ID) field set to a first identifier provided by upper layers. For example, the DST field may carry 8 bits of the Destination Layer-2 ID set to a second identifier provided by upper layers. In an example, if the V field is set to “1”, the second identifier may be a unicast identifier. In an example, if the V field is set to “2”, the second identifier may be a groupcast identifier. In an example, if the V field is set to “3”, the second identifier may be a broadcast identifier. For example, the R field may indicate reserved bit.

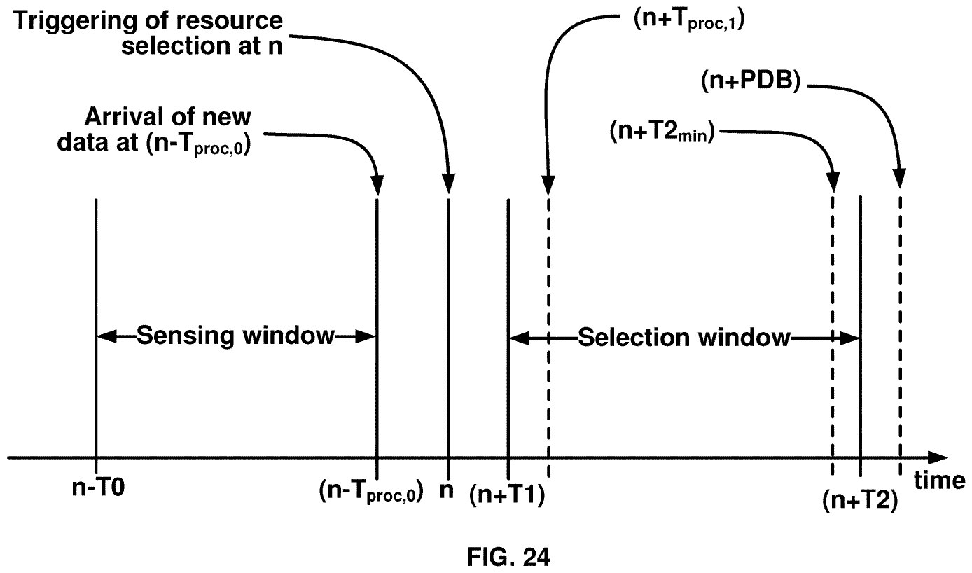

FIG. 24 illustrates an example time of a resource selection procedure. A wireless device may perform the resource selection procedure to select resources for one or more sidelink transmissions. As shown in FIG. 24, a sensing window of the resource selection procedure may start at time (n−T0) (e.g., parameter sl-SensingWindow). The sensing window may end at time (n−T_{proc,0}). New data of the one or more sidelink transmissions may arrive at the wireless device at time (n−T_{proc,0}). The time period T_{proc,0} may be a processing delay of the wireless device to determine to trigger the resource selection procedure. The wireless device may determine to trigger the resource selection procedure at time n to select the resources for the new data arrived at time (n−T_{proc,0}). The wireless device may complete the resource selection procedure at time (n+T1). The wireless device may determine the parameter T1 based on a capability of the wireless device. The capability of the wireless device may be a processing delay of a processor of the wireless device. A selection window of the resource selection procedure may start at time (n+T1). The selection window may end at time (n+T2) indicating the ending of the selection window. The wireless device may determine the parameter T2 based on a parameter T2 min (e.g., sl-SelectionWindow). In an example, the wireless device may determine the parameter T2 subject to T2min≤T2≤PDB, where the PDB (packet delay budget) may be the maximum allowable delay (e.g., a delay budget) for successfully transmitting the new data via the one or more sidelink transmissions. The wireless device may determine the parameter T2 min to a corresponding value for a priority of the one or more sidelink transmissions (e.g., based on a parameter SL-SelectionWindowConfig indicating a mapping between a sidelink priority sl-Priority and the end of the selection window sl-SelectionWindow). In an example, the wireless device may set the parameter T2=PDB if the parameter T2 min>PDB.

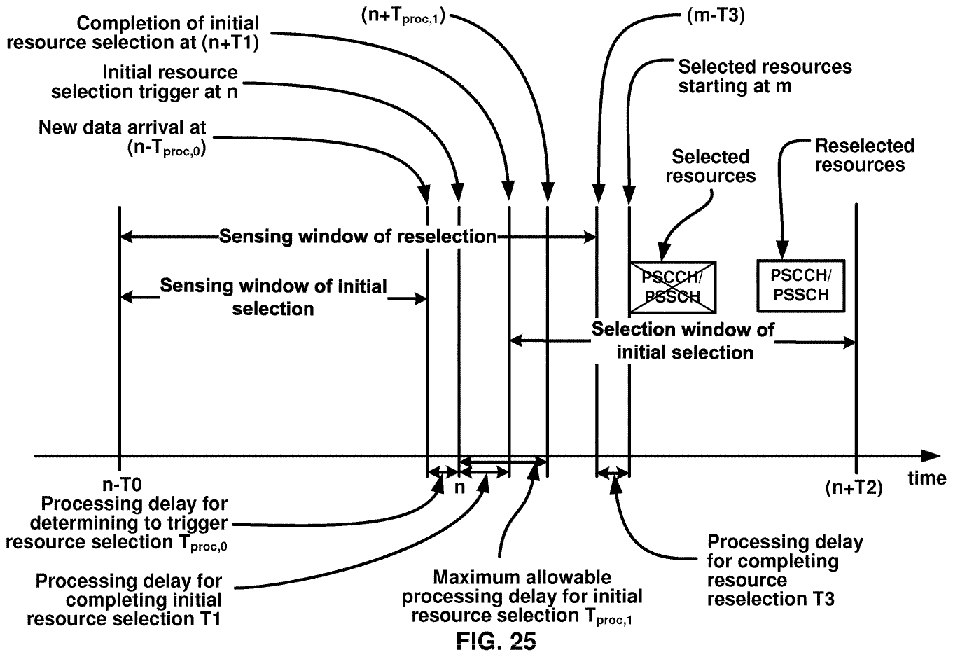

FIG. 25 illustrates an example timing of a resource selection procedure. A wireless device may perform the resource selection procedure for selecting resources for one or more sidelink transmissions. Referring to FIG. 24, a sensing window of initial selection may start at time (n−T0). The sensing window of initial selection may end at time (n−T_{proc,0}). New data of the one or more sidelink transmissions may arrive at the wireless device at the time (n−T_{proc,0}). The time period T_{proc,0} may be a processing delay for the wireless device to determine to trigger the initial selection of the resources. The wireless device may determine to trigger the initial selection at time n for selecting the resources for the new data arrived at the time (n−T_{proc,0}). The wireless device may complete the resource selection procedure at time (n+T1). The time (n+T_{proc,1}) may be the maximum allowable processing latency for completing the resource selection procedure being triggered at the time n, where 0<T1≤T_{proc,1}. A selection window of initial selection may start at time (n+T1). The selection window of initial selection may end at time (n+T2). The parameter T2 may be configured, preconfigured, or determined at the wireless device.

The wireless device may determine first resources (e.g., selected resources in FIG. 25) for the one or more sidelink transmissions based on the completion of the resource selection procedure at the time (n+T1). The wireless device may select the first resources from candidate resources in the selection window of initial selection based on measurements in the sensing window for initial selection. The wireless device may determine a resource collision between the first resources and other resources reserved by another wireless device. The wireless device may determine to drop the first resources for avoiding interference. The wireless device may trigger a resource reselection procedure (e.g., a second resource selection procedure) at time (m−T3) and/or before time (m−T3). The time period T3 may be a processing delay for the wireless device to complete the resource reselection procedure (e.g., a second resource selection procedure). The wireless device may determine second resources (e.g., reselected resource in FIG. 25) via the resource reselection procedure (e.g., a second resource selection procedure). The start time of the first resources may be time m (e.g., the first resources may be in slot m).

In an example, at least one of time parameters TO, T_{proc,0}, T_{proc,1}, T2, and PDB may be configured by a base station to the wireless device. In an example, the at least one of the time parameters TO, T_{proc,0}, T_{proc,1}, T2, and PDB may be preconfigured to the wireless device. The at least one of the time parameters TO, T_{proc,0}, T_{proc,1}, T2, and PDB may be stored in a memory of the wireless device. In an example, the memory may be a Subscriber Identity Module (SIM) card. In an example of FIG. 24 and FIG. 25, the time n, m, T0, T1, T_{proc,0}, T_{proc,1}, T2, T2 min, T3, and PDB may be in terms of slots and/or slot index.

FIG. 26 illustrates an example flowchart of a resource selection procedure by a wireless device for transmitting a TB (e.g., a data packet) via sidelink.

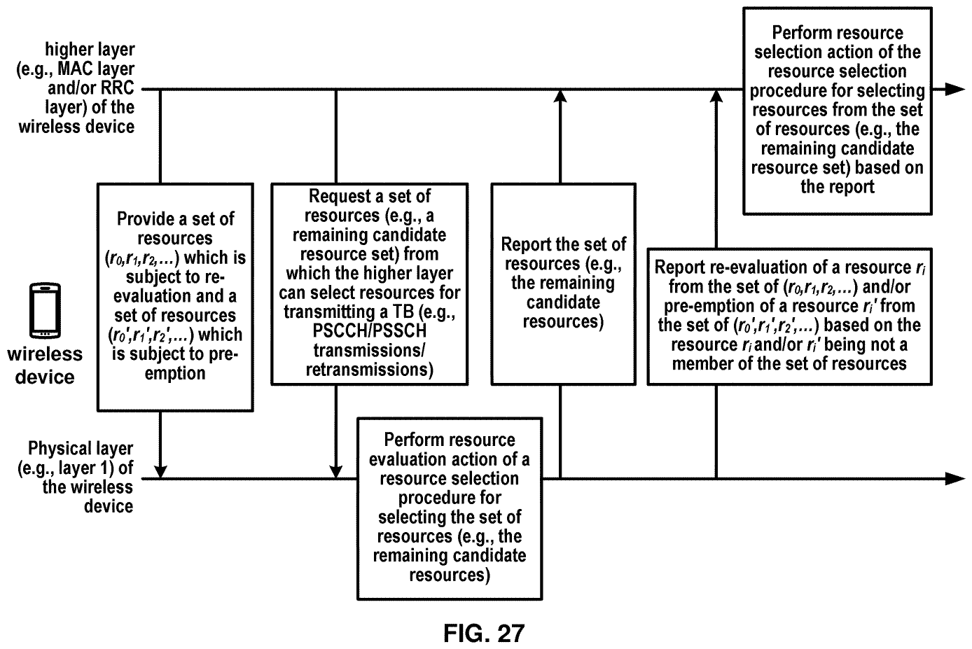

FIG. 27 illustrates an example diagram of the resource selection procedure among layers of the wireless device.

Referring to FIG. 26 and FIG. 27, the wireless device may transmit one or more sidelink transmissions (e.g., a first transmission of the TB and one or more retransmissions of the TB) for the transmitting of the TB. Referring to FIG. 19, a sidelink transmission of the one or more sidelink transmission may comprise a PSCCH. The sidelink transmission may comprise a PSSCH. The sidelink transmission may comprise a PSFCH. The wireless device may trigger the resource selection procedure for the transmitting of the TB. The resource selection procedure may comprise two actions. The first action of the two actions may be a resource evaluation action. Physical layer (e.g., layer 1) of the wireless device may perform the first action. The physical layer may determine a subset of resources based on the first action and report the subset of resources to higher layer (e.g., RRC layer and/or MAC layer) of the wireless device. The second action of the two actions may be a resource selection action. The higher layer (e.g., RRC layer and/or MAC layer) of the wireless device may perform the second action based on the reported the subset of resources from the physical layer.

In an example, higher layer (e.g., RRC layer and/or MAC layer) of a wireless device may trigger a resource selection procedure for requesting the wireless device to determine a subset of resources. The higher layer may select resources from the subset of resources for PSSCH and/or PSCCH transmission. To trigger the resource selection procedure, e.g., in slot n, the higher layer may provide the following parameters for the PSSCH and/or PSCCH transmission:
a resource pool, from which the wireless device may determine the subset of resources;
layer 1 priority, prio_{TX} (e.g., sl-Priority referring to FIG. 21 and FIG. 22), of the PSSCH/PSCCH transmission;
remaining packet delay budget (PDB) of the PSSCH and/or PSCCH transmission;
a number of sub-channels, L_{subCH}, for the PSSCH and/or PSCCH transmission in a slot;
a resource reservation period/interval, P_{rsvp_TX}, in units of millisecond (ms).

In an example, if the higher layer requests the wireless device to determine a subset of resources from which the higher layer will select the resources for the PSSCH and/or PSCCH transmission for re-evaluation and/or pre-emption, the higher layer may provide a set of resources (r₀, r₁, r₂, . . . ) which may be subject to the re-evaluation and a set of resources

$$( {r}_{0}^{′} , {r}_{1}^{′} , {r}_{2}^{′} , … )$$

which may be subject to the pre-emption.

In an example, a base station (e.g., network) may transmit a message comprising one or more parameters to the wireless device for performing the resource selection procedure. The message may be an RRC/SIB message, a MAC CE, and/or a DCI. In an example, a second wireless device may transmit a message comprising one or more parameters to the wireless device for performing the resource selection procedure. The message may be an RRC message, a MAC CE, and/or a SCI. The one or more parameters may indicate following information.
sl-SelectionWindowList (e.g., sl-SelectionWindow referring to FIG. 21 and FIG. 22): an internal parameter T2 min (e.g., T2 min referring to FIG. 24) may be set to a corresponding value from the parameter sl-SelectionWindowList for a given value of prio_{TX} (e.g., based on SL-SelectionWindowConfig referring to FIG. 21 and FIG. 22).
sl-ThresPSSCH-RSRP-List (e.g., sl-ThresPSSCH-RSRP-List referring to FIG. 21 and FIG. 22): a parameter may indicate an RSRP threshold for each combination (Pᵢ, Pⱼ), where pᵢ is a value of a priority field in a received SCI format 1-A and pⱼ is a priority of a sidelink transmission (e.g., the PSSCH/PSCCH transmission) of the wireless device; In an example of the resource selection procedure, an invocation of p; may be pⱼ=prio_{TX}.
sl-RS-ForSensing (e.g., sl-RS-ForSensing referring to FIG. 21 and FIG. 22): a parameter may indicate whether DMRS of a PSCCH or a PSSCH is used, by the wireless device, for layer 1 (e.g., physical layer) RSRP measurement in sensing operation.
sl-ResourceReservePeriodList (e.g., sl-ResourceReservePeriodList referring to FIG. 21 and FIG. 22)
sl-SensingWindow (e.g., sl-SensingWindow referring to FIG. 21 and FIG. 22): an internal parameter To may be defined as a number of slots corresponding to t0_SensingWindow ms.
sl-TxPercentageList (e.g., based on SL-TxPercentageConfig referring to FIG. 21 and FIG. 22): an internal parameter X (e.g., sl-TxPercentage referring to FIG. 21 and FIG. 22) for a given prio_{TX} (e.g., sl-Priority referring to FIG. 21 and FIG. 22) may be defined as sl-xPercentage(prio_{TX}) converted from percentage to ratio.
sl-PreemptionEnable (e.g., p_preemption referring to FIG. 21 and FIG. 22): an internal parameter prioₚᵣₑ may be set to a higher layer provided parameter sl-PreemptionEnable.

The resource reservation period/interval, P_{rsvp_TX}, if provided, may be converted from units of ms to units of logical slots, resulting in

$${P}_{rsvp \_ TX}^{′} .$$

Notation:

$$( {t}_{0}^{SL} , {t}_{1}^{SL} , {t}_{2}^{SL} , … )$$

may denote a set of slots of a sidelink resource pool.

In the resource evaluation action (e.g., the first action in FIG. 26), the wireless device may determine a sensing window (e.g., the sensing window shown in FIG. 24 and FIG. 25 based on sl-SensingWindow) based on the triggering the resource selection procedure. The wireless device may determine a selection window (e.g., the selection window shown in FIG. 24 and FIG. 25 based on sl-SelectionWindowList) based on the triggering the resource selection procedure. The wireless device may determine one or more reservation periods/intervals (e.g., parameter sl-ResourceReservePeriodList) for resource reservation. In an example, a candidate single-slot resource for transmission R_{x,y} may be defined as a set of L_{subCH} contiguous sub-channels with sub-channel x+j in slot

$${t}_{y}^{SL}$$

where j=0, . . . , L_{subCH}−1. The wireless device may assume that a set of L_{subCH} contiguous sub-channels in the resource pool within a time interval [n+T₁, n+T₂] correspond to one candidate single-slot resource (e.g., referring to FIG. 24 and FIG. 25). A total number of candidate single-slot resources may be denoted by Mₜₒₜₐₗ. In an example, referring to FIG. 24 and FIG. 25, the sensing window may be defined by a number of slots in a time duration of [n−T₀, n−T_{proc,0}). The wireless device may monitor a first subset of the slots, of a sidelink resource pool, within the sensing window. The wireless device may not monitor a second subset of the slots than the first subset of the slots due to half duplex. The wireless device may perform the following actions based on PSCCH decoded and RSRP measured in the first subset of the slots. In an example, an internal parameter Th(pᵢ, pⱼ) may be set to the corresponding value of RSRP threshold indicated by the i-th field in sl-ThresPSSCH-RSRP-List, where i=pᵢ+(pⱼ−1)*8.

Referring to FIG. 26 and FIG. 27, in the resource evaluation action (e.g., the first action in FIG. 26), the wireless device may initialize a candidate resource set (e.g., a set SA) to be a set of candidate resources. In an example, the candidate resource set may be the union of candidate resources within the selection window. In an example, a candidate resource may be a candidate single-subframe resource. In an example, a candidate resource may be a candidate single-slot resource. In an example, the set SA may be initialized to a set of all candidate single-slot resources.

Referring to FIG. 26 and FIG. 27, in the resource evaluation action (e.g., the first action in FIG. 26), the wireless device may perform a first exclusion for excluding second resources from the candidate resource set based on first resources and one or more reservation periods/intervals. In an example, the wireless device may not monitor the first resources within a sensing window. In an example, the one or more reservation periods/intervals may be configured/associated with a resource pool of the second resources. In an example, the wireless device may determine the second resources within a selection window which might be reserved by a transmission transmitted via the first resources based on the one or more reservation periods/intervals. In an example, the wireless device may exclude a candidate single-slot resource R_{x,y} from the set SA based on following conditions:
the wireless device has not monitored slot

$${t}_{m}^{SL}$$

in the sensing window.
for any periodicity value allowed by the parameter sl-ResourceReservePeriodList and a hypothetical SCI format 1-A received in the slot

$${t}_{m}^{SL}$$

with “Resource reservation period” field set to that periodicity value and indicating all sub-channels of the resource pool in this slot, condition c of a second exclusion would be met.

Referring to FIG. 26 and FIG. 27, in the resource evaluation action (e.g., the first action in FIG. 26), the wireless device may perform a second exclusion for excluding third resources from the candidate resource set. In an example, a SCI may indicate a resource reservation of the third resources. The SCI may further indicate a priority value (e.g., indicated by a higher layer parameter sl-Priority). The wireless device may exclude the third resources from the candidate resource set based on a reference signal received power (RSRP) of the third resources being higher than an RSRP threshold (e.g., indicated by a higher layer parameter sl-ThresPSSCH-RSRP-List). The RSRP threshold may be related to the priority value based on a mapping list of RSRP thresholds to priority values configured and/or pre-configured to the wireless device. In an example, a base station may transmit a message to the wireless device for configuring the mapping list. The message may be a radio resource control (RRC) message. In an example, the mapping list may be pre-configured to the wireless device. A memory of the wireless device may store the mapping list. In an example, a priority indicated by the priority value may be a layer 1 priority (e.g., physical layer priority). In an example, a bigger priority value may indicate a higher priority of a sidelink transmission. A smaller priority value may indicate a lower priority of the sidelink transmission. In another example, a bigger priority value may indicate a lower priority of a sidelink transmission. A smaller priority value may indicate a higher priority of the sidelink transmission. In an example, the wireless device may exclude a candidate single-slot resource R_{x,y} from the set S_{A} based on following conditions:
a) the wireless device receives an SCI format 1-A in slot

$${t}_{m}^{S L} ,$$

and “Resource reservation period” field, if present, and “Priority” field in the received SCI format 1-A indicate the values P_{rsvp_RX} and prio_{RX};
b) the RSRP measurement performed, for the received SCI format 1-A, is higher than Th(prio_{RX}, prio_{TX});
c) the SCI format received in slot

$${t}_{m}^{SL}$$

or the same SCI format which, if and only if the “Resource reservation period” field is present in the received SCI format 1-A, is assumed to be received in slot(s)

$${t}_{m + q \times {P}_{rsvp \_ RX}^{′}}^{S L}$$

determines the set of resource blocks and slots which overlaps with

$${R}_{x , y + j \times {P}_{rsvp \_ TX}^{′}}$$

for q=1, 2, . . . , Q and j=0, 1, . . . , Cᵣₑₛₑₗ−1. Here,

$${P}_{rsvp \_ RX}^{′}$$

is P_{rsvp_RX} converted to units of logical slots,

$$Q = ⌈ \frac{{T}_{scal}}{{P}_{rsvp \_ RX}} ⌉$$

if P_{rsvp_RX}<T_{scal} and

$${n}^{′} - m \leq {P}_{rsvp \_ RX}^{′} ,$$

where

$${t}_{{n}^{′}}^{SL} = n$$

if Slot n belongs to the set

$$( {t}_{0}^{SL} , {t}_{1}^{SL} , … , {t}_{{T}_{max}}^{S L} ) ,$$

otherwise slot

$${t}_{{n}^{′}}^{S L}$$

is the first slot after slot n belonging to set

$$( {t}_{0}^{SL} , {t}_{1}^{SL} , … , {t}_{{T}_{max}}^{S L} ) ;$$

otherwise Q=1. T_{scal} is set to selection evaluation action (e.g., the first action in FIG. 26)

Referring to FIG. 26 and FIG. 27, in the resource evaluation action (e.g., the first action in FIG. 26), the wireless device may determine whether remaining candidate resources in the candidate resource set are sufficient for selecting resources for the one or more sidelink transmissions of the TB based on a condition, after performing the first exclusion and the second exclusion. In an example, the condition may be the total amount of the remaining candidate resources in the candidate resource set being more than X percent (e.g., indicated by a higher layer parameter sl-TxPercentageList) of the candidate resources in the candidate resource set before performing the first exclusion and the second exclusion. If the condition is not met, the wireless device may increase the RSRP threshold used to exclude the third resources with a value Y and iteratively re-perform the initialization, first exclusion, and second exclusion until the condition being met. In an example, if the number of remaining candidate single-slot resources in the set SA is smaller than X·Mₜₒₜₐₗ, then Th(pᵢ, Pⱼ) may be increased by 3 dB and the procedure continues with re-performing of the initialization, first exclusion, and second exclusion until the condition being met. In an example, the wireless device may report the set SA (e.g., the remaining candidate resources of the candidate resource set) to the higher layer of the wireless device. In an example, the wireless device may report the set SA (e.g., the remaining candidate resources of the candidate resource set when the condition is met) to the higher layer of the wireless device, based on that the number of remaining candidate single-slot resources in the set SA being greater than or equal to X. Mₜₒₜₐₗ.

Referring to FIG. 26 and FIG. 27, in the resource selection action (e.g., the second action in FIG. 26), the wireless device (e.g., the higher layer of the wireless device) may select fourth resources from the remaining candidate resources of the candidate resource set (e.g., the set SA reported by the physical layer) for the one or more sidelink transmissions of the TB. In an example, the wireless device may randomly select the fourth resources from the remaining candidate resources of the candidate resource set.

Referring to FIG. 26 and FIG. 27, in an example, if a resource rᵢ from the set (r₀, r₁, r₂, . . . ) is not a member of S_{A} (e.g., the remaining candidate resources of the candidate resource set when the condition is met), the wireless device may report re-evaluation of the resource rᵢ to the higher layers.

Referring to FIG. 26 and FIG. 27, in an example, if a resource

$${r}_{i}^{′}$$

from the set

$$( {r}_{0}^{′} , {r}_{1}^{′} , {r}_{2}^{′} , … )$$

meets the conditions below, then the wireless device may report pre-emption of the resource

$${r}_{i}^{′}$$

to the higher layers.

$${r}_{i}^{′}$$

is not a member of S_{A}, and

$${r}_{i}^{′}$$

meets the conditions for the second exclusion, with Th(prio_{RX},prio_{TX}) set to a final threshold for reaching X·Mₜₒₜₐₗ, and
the associated priority prio_{RX}, satisfies one of the following conditions:
sl-PreemptionEnable is provided and is equal to ‘enabled’ and prio_{TX}>prio_{RX}
sl-PreemptionEnable is provided and is not equal to ‘enabled’, and prio_{RX}<prioₚᵣₑ and prio_{TX}>prio_{RX}

In an example, if the resource rt is indicated for re-evaluation by the wireless device (e.g., the physical layer of the wireless device), the higher layer of the wireless device may remove the resource rt from the set (r₀, r₁, r₂, . . . ). In an example, if the resource

$${r}_{i}^{′}$$

is indicated for pre-emption by the wireless device (e.g., the physical layer of the wireless device), the higher layer of the wireless device may remove the resource

$${r}_{i}^{′}$$

from the set

$$( {r}_{0}^{′} , {r}_{1}^{′} , {r}_{2}^{′} , … ) .$$

The higher layer of the wireless device may randomly select new time and frequency resources from the remaining candidate resources of the candidate resource set (e.g., the set S_{A} reported by the physical layer) for the removed resources rᵢ and/or

$${r}_{i}^{′} .$$

The higher layer of the wireless device may replace the removed resources rᵢ and/or

$${r}_{i}^{′}$$

by the new time and frequency resources. For example, the wireless device may remove the resources rᵢ and/or

$${r}_{i}^{′}$$

from the set (r₀, r₁, r₂, . . . ) and/or the set

$$( {r}_{0}^{′} , {r}_{1}^{′} , {r}_{2}^{′} , … )$$

and add new time and frequency resources to the set (r₀, r₁, r₂, . . . ) and/or the set

$$( {r}_{0}^{′} , {r}_{1}^{′} , {r}_{2}^{′} , … )$$

based on the removing of the resources rᵢ and/or

$${r}_{i}^{′} .$$

Sidelink pre-emption may happen between a first wireless device and a second wireless device. The first wireless device may select first resources for a first sidelink transmission. The first sidelink transmission may have a first priority. The second wireless device may select second resources for a second sidelink transmission. The second sidelink transmission may have a second priority. The first resources may partially and/or fully overlap with the second resources. The first wireless device may determine a resource collision between the first resources and the second resources based on that the first resources and the second resources being partially and/or fully overlapped. The resource collision may imply fully and/or partially overlapping between the first resources and the second resources in time, frequency, code, power, and/or spatial domain. Referring to an example of FIG. 18, the first resources may comprise one or more first sidelink resource units in a sidelink resource pool. The second resources may comprise one or more second sidelink resource units in the sidelink resource pool. A partial resource collision between the first resources and the second resources may indicate that the at least one sidelink resource unit of the one or more first sidelink resource units belongs to the one or more second sidelink resource units. A full resource collision between the first resources and the second resources may indicate that the one or more first sidelink resource units may be the same as or a subset of the one or more second sidelink resource units. In an example, a bigger priority value may indicate a lower priority of a sidelink transmission. A smaller priority value may indicate a higher priority of the sidelink transmission. In an example, the first wireless device may determine the sidelink pre-emption based on the resource collision and the second priority being higher than the first priority. That is, the first wireless device may determine the sidelink pre-emption based on the resource collision and a value of the second priority being smaller than a value of the first priority. In another example, the first wireless device may determine the sidelink pre-emption based on the resource collision, the value of the second priority being smaller than a priority threshold, and the value of the second priority being smaller than the value of the first priority.

Referring to FIG. 25, a first wireless device may trigger a first resource selection procedure for selecting first resources (e.g., selected resources after resource selection with collision in FIG. 25) for a first sidelink transmission. A second wireless device may transmit an SCI indicating resource reservation of the first resource for a second sidelink transmission. The first wireless device may determine a resource collision on the first resources between the first sidelink transmission and the second sidelink transmission. The first wireless device may trigger a resource re-evaluation (e.g., a resource evaluation action of a second resource selection procedure) at and/or before time (m−T3) based on the resource collision. The first wireless device may trigger a resource reselection (e.g., a resource selection action of the second resource selection procedure) for selecting second resources (e.g., reselected resources after resource reselection in FIG. 25) based on the resource re-evaluation. The start time of the second resources may be time m.

A UE may receive one or more messages (e.g., RRC messages and/or SIB messages) comprising configuration parameters of a sidelink BWP. The configuration parameters may comprise a first parameter (e.g., sl-StartSymbol) indicating a sidelink starting symbol. The first parameter may indicate a starting symbol (e.g., symbol #0, symbol #1, symbol #2, symbol #3, symbol #4, symbol #5, symbol #6, symbol #7, etc.) used for sidelink in a slot. For example, the slot may not comprise a SL-SSB (S-SSB). In an example, the UE may be (pre-)configured with one or more values of the sidelink starting symbol per sidelink BWP. The configuration parameters may comprise a second parameter (e.g., sl-LengthSymbols) indicating number of symbols (e.g., 7 symbols, 8 symbols, 9 symbols, 10 symbols, 11 symbols, 12 symbols, 13 symbols, 14 symbols, etc.) used sidelink in a slot. For example, the slot may not comprise a SL-SSB (S-SSB). In an example, the UE may be (pre-)configured with one or more values of the sidelink number of symbols (symbol length) per sidelink BWP.

The configuration parameters of the sidelink BWP may indicate one or more sidelink (communication) resource pools of the sidelink BWP (e.g., via SL-BWP-PoolConfig and/or SL-BWP-PoolConfigCommon). A resource pool may be a sidelink receiving resource pool (e.g., indicated by sl-RxPool) on the configured sidelink BWP. For example, the receiving resource pool may be used for PSFCH transmission/reception, if configured. A resource pool may be a sidelink transmission resource pool (e.g., indicated by sl-TxPool, and/or sl-ResourcePool) on the configured sidelink BWP. For example, the transmission resource pool may comprise resources by which the UE is allowed to transmit NR sidelink communication (e.g., in exceptional conditions and/or based on network scheduling) on the configured BWP. For example, the transmission resource pool may be used for PSFCH transmission/reception, if configured.

Configuration parameters of a resource pool may indicate a size of a sub-channel of the resource pool (e.g., via sl-SubchannelSize) in unit of PRB. For example, the sub-channel size may indicate a minimum granularity in frequency domain for sensing and/or for PSSCH resource selection. Configuration parameters of a resource pool may indicate a lowest/starting RB index of a sub-channel with a lowest index in the resource pool with respect to lowest RB index RB index of the sidelink BWP (e.g., via sl-StartRB-Subchannel). Configuration parameters of a resource pool may indicate a number of sub-channels in the corresponding resource pool (e.g., via sl-NumSubchannel). For example, the sub-channels and/or the resource pool may consist of contiguous PRBs.

Configuration parameters of a resource pool may indicate configuration of one or more sidelink channels on/in the resource pool. For example, the configuration parameters may indicate that the resource pool is configured with PSSCH and/or PSCCH and/or PSFCH.

Configuration parameters of PSCCH may indicate a time resource for a PSCCH transmission in a slot. Configuration parameters of PSCCH (e.g., SL-PSCCH-Config) may indicate a number of symbols of PSCCH (e.g., 2 or 3) in the resource pool (e.g., via sl-TimeResourcePSCCH). Configuration parameters of PSCCH (e.g., SL-PSCCH-Config) may indicate a frequency resource for a PSCCH transmission in a corresponding resource pool (e.g., via sl-FreqResourcePSCCH). For example, the configuration parameters may indicate a number of PRBs for PSCCH in a resource pool, which may not be greater than a number of PRBs of a sub-channel of the resource pool (sub-channel size).

Configuration parameters of PSSCH may indicate one or more DMRS time domain patterns (e.g., PSSCH DMRS symbols in a slot) for the PSSCH that may be used in the resource pool.

A resource pool may or may not be configured with PSFCH. Configuration parameters of PSFCH may indicate a period for the PSFCH in unit/number of slots within the resource pool (e.g., via sl-PSFCH-Period). For example, a value 0 of the period may indicate that no resource for PSFCH is configured in the resource pool and/or HARQ feedback for (all) transmissions in the resource pool is disabled. For example, the period may be 1 slot or 2 slots or 4 slots, etc. Configuration parameters of PSFCH may indicate a set of PRBs that are (actually) used for PSFCH transmission and reception (e.g., via sl-PSFCH-RB-Set). For example, a bitmap may indicate the set of PRBs, wherein a leftmost bit of the bitmap may refer to a lowest RB index in the resource pool, and so on. Configuration parameters of PSFCH may indicate a minimum time gap between PSFCH and the associated PSSCH in unit of slots (e.g., via sl-MinTimeGapPSFCH). Configuration parameters of PSFCH may indicate a number of PSFCH resources available for multiplexing HARQ-ACK information in a PSFCH transmission (e.g., via sl-PSFCH-CandidateResourceType).

A UE may be configured by higher layers (e.g., by RRC configuration parameters) with one or more sidelink resource pools. A sidelink resource pool may be for transmission of PSSCH and/or for reception of PSSCH. A sidelink resource pool may be associated with sidelink resource allocation mode 1 and/or sidelink resource allocation mode 2. In the frequency domain, a sidelink resource pool consists of one or more (e.g., sl-NumSubchannel) contiguous sub-channels. A sub-channel consists of one or more (e.g., sl-SubchannelSize) contiguous PRBs. For example, higher layer parameters (e.g., RRC configuration parameters) may indicate a number of sub-channels in a sidelink resource pool (e.g., sl-Num Subchannel) and/or a number of PRBs per sub-channel (e.g., si-SubchannelSize).

A set of slots that may belong to a sidelink resource pool. The set of slots may be denoted by

$$( {t}_{0}^{SL} , {t}_{1}^{SL} , … , {t}_{{T}_{ma x} - 1}^{SL} )$$

where

$$0 \leq {t}_{i}^{SL} < 10240 \times {2}^{μ} , 0 \leq i < {T}_{m ax} .$$

The slot index may be relative to slot #0 of the radio frame corresponding to SFN 0 of the serving cell or DFN 0. The set includes all the slots except N_{S_SSB} slots in which S-SS/PSBCH block (S-SSB) is configured. The set includes all the slots except N_{nonSL} slots in each of which at least one of Y-th, (Y+1)-th, . . . , (Y+X−1)-th OFDM symbols are not semi-statically configured as UL as per the higher layer parameter (e.g., tdd-UL-DL-ConfigurationCommon-r16 of the serving cell if provided and/or sl-TDD-Configuration-r16 if provided and/or sl-TDD-Config-r16 of the received PSBCH if provided). For example, a higher layer (e.g., MAC or RRC) parameter may indicate a value of Y as the sidelink starting symbol of a slot (e.g., sl-StartSymbol). For example, a higher layer (e.g., MAC or RRC) parameter may indicate a value of X as the number of sidelink symbols in a slot (e.g., sl-LengthSymbols). The set includes all the slots except one or more reserved slots. The slots in the set may be arranged in increasing order of slot index. The UE may determine the set of slot assigned to a sidelink resource pool based on a bitmap (b₀, b₁, . . . , b_{L}_{_{bitmap}}₋₁) associated with the resource pool where L_{bitmap} the length of the bitmap is configured by higher layers. A slot

$${t}_{k}^{SL} ( 0 \leq k < 10240 \times {2}^{μ} - {N}_{{S}_{SSB}} - {N}_{nonSL} - {N}_{reserved} )$$

may belong to the set of slots if b_{k′}=1 where k′=k mod L_{bitmap}. The slots in the set are re-indexed such that the subscripts i of the remaining slots

$${t}_{i}^{′ SL}$$

are successive {0, 1, . . . , T′ₘₐₓ−1} where T′ₘₐₓ is the number of the slots remaining in the set.

The UE may determine the set of resource blocks assigned to a sidelink resource pool, wherein the resource pool consists of N_{PRB} PRBs. The sub-channel m for m=0,1, . . . , numSubchannel−1 consists of a set of n_{subCHsize} contiguous resource blocks with the physical resource block number n_{PRB}=n_{subCHRBstart}+m·n_{subCHsize}+j for j=0,1, . . . , n_{subCHsize}−1, where n_{subCHRBstart} and n_{subCHsize} are given by higher layer parameters sl-StartRB-Subchannel and si-SubchannelSize, respectively. A UE may not be expected to use the last N_{PRB} mod n_{subCHsize} PRBs in the resource pool.

A UE may be provided/configured with a number of symbols in a resource pool for PSCCH (e.g., by sl-TimeResourcePSCCH). The PSCCH symbols may start from a second symbol that is available for sidelink transmissions in a slot. The UE may be provided/configured with a number of PRBs in the resource pool for PSCCH (e.g., by sl-FreqResourcePSCCH). The PSCCH PRBs may start from the lowest PRB of the lowest sub-channel of the associated PSSCH, e.g., for a PSCCH transmission with a SCI format 1-A. In an example, PSCCH resource/symbols may be configured in every slot of the resource pool. In an example, PSCCH resource/symbols may be configured in a subset of slot of the resource pool (e.g., based on a period comprising two or more slots).

In an example, each PSSCH transmission is associated with an PSCCH transmission. The PSCCH transmission may carry the 1^{st} stage of the SCI associated with the PSSCH transmission. The 2^{nd} stage of the associated SCI may be carried within the resource of the PSSCH. In an example, the UE transmits a first SCI (e.g., 1^{st} stage SCI, SCI format 1-A) on PSCCH according to a PSCCH resource configuration in slot n and PSCCH resource m. For the associated PSSCH transmission in the same slot, the UE may transmit one transport block (TB) with up to two layers (e.g., one layer or two layers). The number of layers (v) may be determined according to the ‘Number of DMRS port’ field in the SCI. The UE may determine the set of consecutive symbols within the slot for transmission of the PSSCH. The UE may determine the set of contiguous resource blocks for transmission of the PSSCH. Transform precoding may not be supported for PSSCH transmission. For example, wideband precoding may be supported for PSSCH transmission.

The UE may set the contents of the second SCI (e.g., 2^{nd} stage SCI, SCI format 2-A). The UE may set values of the SCI fields comprising the ‘HARQ process number’ field, the ‘NDI’ field, the ‘Source ID’ field, the ‘Destination ID’ field, the ‘HARQ feedback enabled/disabled indicator field, the ‘Cast type indicator’ field, and/or the ‘CSI request field’, as indicated by higher (e.g., MAC and/or RRC) layers. The UE may set the contents of the second SCI (e.g., 2^{nd} stage SCI, SCI format 2-B). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Zone ID’ field, and/or the ‘Communication range requirement’ field, as indicated by higher (e.g., MAC and/or RRC) layers.

In an example, one transmission scheme may be defined for the PSSCH and may be used for all PSSCH transmissions. PSSCH transmission may be performed with up to two antenna ports, e.g., with antenna ports 1000-1001.

In sidelink resource allocation mode 1, for PSSCH and/or PSCCH transmission, dynamic grant, configured grant type 1 and/or configured grant type 2 may be supported. The configured grant Type 2 sidelink transmission is semi-persistently scheduled by a SL grant in a valid activation DCI.

The UE may transmit the PSSCH in the same slot as the associated PSCCH. The (minimum) resource allocation unit in the time domain may be a slot. The UE may transmit the PSSCH in consecutive symbols within the slot. The UE may not transmit PSSCH in symbols which are not configured for sidelink. A symbol may be configured for sidelink, according to higher layer parameters indicating the starting sidelink symbol (e.g., startSLsymbols) and a number of consecutive sidelink symbols (e.g., lengthSLsymbols). For example, startSLsymbols is the symbol index of the first symbol of length SLsymbols consecutive symbols configured for sidelink. Within the slot, PSSCH resource allocation may start at symbol startSLsymbols+1 (e.g., second sidelink symbol of the slot). The UE may not transmit PSSCH in symbols which are configured for use by PSFCH, if PSFCH is configured in this slot. The UE may not transmit PSSCH in the last symbol configured for sidelink (e.g., last sidelink symbol of the slot). The UE may not transmit PSSCH in the symbol immediately preceding the symbols which are configured for use by PSFCH, if PSFCH is configured in this slot. FIG. 19 shows an example of sidelink symbols and the PSSCH resource allocation within the slot.

A Sidelink grant may be received dynamically on the PDCCH, and/or configured semi-persistently by RRC, and/or autonomously selected by the MAC entity of the UE. The MAC entity may have a sidelink grant on an active SL BWP to determine a set of PSCCH duration(s) in which transmission of SCI occurs and a set of PSSCH duration(s) in which transmission of SL-SCH (and/or SL MAC SDU) associated with the SCI occurs. A sidelink grant addressed to SLCS-RNTI with NDI=1 is considered as a dynamic sidelink grant. The UE may be configured with Sidelink resource allocation mode 1. The UE may for each PDCCH occasion and for each grant received for this PDCCH occasion (e.g., for the SL-RNTI or SLCS-RNTI of the UE), use the sidelink grant to determine PSCCH duration(s) and/or PSSCH duraiton(s) for initial tranmsission and/or one or more retranmsission of a MAC PDU for a corresponding sidelink process (e.g., associated with a HARQ buffer and/or a HARQ process ID).

The UE may be configured with Sidelink resource allocation mode 2 to transmit using pool(s) of resources in a carrier, based on sensing or random selection. The MAC entity for each Sidelink process may select to create a selected sidelink grant corresponding to transmissions of multiple MAC PDUs, and SL data may be available in a logical channel. The UE may select a resource pool, e.g., based on a parameter enabling/disabling sidelink HARQ feedback. The UE may perform the TX resource (re-)selection check on the selected pool of resources. The UE may select the time and frequency resources for one transmission opportunity from the resources pool and/or from the resources indicated by the physical layer, according to the amount of selected frequency resources and the remaining PDB of SL data available in the logical channel(s) allowed on the carrier. The UE may use the selected resource to select a set of periodic resources spaced by the resource reservation interval for transmissions of PSCCH and PSSCH corresponding to the number of transmission opportunities of MAC PDUs. The UE may consider the first set of transmission opportunities as the initial transmission opportunities and the other set(s) of transmission opportunities as the retransmission opportunities. The UE may consider the sets of initial transmission opportunities and retransmission opportunities as the selected sidelink grant. The UE may consider the set as the selected sidelink grant. The UE may use the selected sidelink grant to determine the set of PSCCH durations and the set of PSSCH durations.

The UE may for each PSSCH duration and/or for each sidelink grant occurring in this PSSCH duration, select a MCS table allowed in the pool of resource which is associated with the sidelink grant. The UE may determine/set the resource reservation interval to a selected value (e.g., 0 or more). In an example, if the configured sidelink grant has been activated and this PSSCH duration corresponds to the first PSSCH transmission opportunity within this period of the configured sidelink grant, the UE may set the HARQ Process ID to the HARQ Process ID associated with this PSSCH duration and, if available, all subsequent PSSCH duration(s) occurring in this period for the configured sidelink grant. The UE may flush the HARQ buffer of Sidelink process associated with the HARQ Process ID. The UE may deliver the sidelink grant, the selected MCS, and the associated HARQ-ACK information to the Sidelink HARQ Entity for this PSSCH duration.

The MAC entity may include at most one Sidelink HARQ entity for transmission on SL-SCH (and/or SL MAC SDU), which maintains a number of parallel Sidelink processes. The (maximum) number of transmitting Sidelink processes associated with the Sidelink HARQ Entity may be a value (e.g., 16). A sidelink process may be configured for transmissions of multiple MAC PDUs. For transmissions of multiple MAC PDUs with Sidelink resource allocation mode 2, the (maximum) number of transmitting Sidelink processes associated with the Sidelink HARQ Entity may be a second value (e.g., 4). A delivered sidelink grant and its associated Sidelink transmission information may be associated with a Sidelink process. Each Sidelink process may support one TB.

For each sidelink grant and for the associated Sidelink process, the Sidelink HARQ Entity may obtain the MAC PDU to transmit from the Multiplexing and assembly entity, if any. The UE may determine Sidelink transmission information of the TB for the source and destination pair of the MAC PDU. The UE may set the Source Layer-1 ID to the 8 LSB of the Source Layer-2 ID of the MAC PDU, and set the Destination Layer-1 ID to the 16 LSB of the Destination Layer-2 ID of the MAC PDU. The UE may set the following information of the TB: cast type indicator, HARQ feedback (e.g., transmission of HARQ-ACK information) enabler/disabler, priority, NDI, RV. The UE may deliver the MAC PDU, the sidelink grant and the Sidelink transmission information of the TB to the associated Sidelink process. The MAC entity of the UE may instruct the associated Sidelink process to trigger a new transmission or a retransmission.

In sidelink resource allocation mode 1, for sidelink dynamic grant, the PSSCH transmission may be scheduled by a DCI (e.g., DCI format 3_0). In sidelink resource allocation mode 1, for sidelink configured grant type 2, the configured grant may be activated by a DCI (e.g., DCI format 3_0). In sidelink resource allocation mode 1, for sidelink dynamic grant and sidelink configured grant type 2 the “Time gap” field value m of the DCI may provide an index m+1 into a slot offset table (e.g., the table may be configured by higher layer parameter sl-DCI-ToSL-Trans). The table value at index m+1 may be referred to as slot offset K_{SL}. The slot of the first sidelink transmission scheduled by the DCI may be the first SL slot of the corresponding resource pool that starts not earlier than

$${T}_{DL} - \frac{{T}_{TA}}{2} + {K}_{SL} \times {T}_{slot} ,$$

where T_{DL} is the starting time of the downlink slot carrying the corresponding DCI, T_{TA} is the timing advance value corresponding to the TAG of the serving cell on which the DCI is received and K_{SL} is the slot offset between the slot of the DCI and the first sidelink transmission scheduled by DCI and Tₛₗₒₜ is the SL slot duration. The “Configuration index” field of the DCI, if provided and not reserved, may indicate the index of the sidelink configured type 2. In sidelink resource allocation mode 1, for sidelink configured grant type 1, the slot of the first sidelink transmissions may follow the higher layer configuration.

The resource allocation unit in the frequency domain may be the sub-channel. The sub-channel assignment for sidelink transmission may be determined using the “Frequency resource assignment” field in the associated SCI. The lowest sub-channel for sidelink transmission may be the sub-channel on which the lowest PRB of the associated PSCCH is transmitted. For example, if a PSSCH scheduled by a PSCCH would overlap with resources containing the PSCCH, the resources corresponding to a union of the PSCCH that scheduled the PSSCH and associated PSCCH DM-RS may not be available for the PSSCH.

The redundancy version for transmitting a TB may be given by the “Redundancy version” field in the 2^{nd} stage SCI (e.g., SCI format 2-A or 2-B). The modulation and coding scheme I_{MCS} may be given by the ‘Modulation and coding scheme’ field in the 1st stage SCI (e.g., SCI format 1-A). The UE may determine the MCS table based on the following: a pre-defined table may be used if no additional MCS table is configured by higher layer parameter sl-MCS-Table; otherwise an MCS table is determined based on the ‘MCS table indicator’ field in the 1st stage SCI (e.g., SCI format 1-A). The UE may use I_{MCS} and the MCS table determined according to the previous step to determine the modulation order (Qₘ) and Target code rate (R) used in the physical sidelink shared channel.

The UE may determine the TB size (TBS) based on the number of RES (N_{RE}) within the slot. The UE may determine the number of REs allocated for PSSCH within a PRB

$$( {N}_{RE}^{′} ) by {N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} ,$$

where

$$\\ {N}_{sc}^{RB} = 12$$

is the number of subcarriers in a physical resource block;

$$\\ {N}_{symb}^{sh} = sl - LengthSymbols - 2 ,$$

where sl-Length Symbols is the number of sidelink symbols within the slot provided by higher layers;

$$\\ {N}_{symb}^{PSFCH} = 3$$

if ‘PSFCH overhead indication’ field of SCI format 1-A indicates “1”, and

$$\\ {N}_{symb}^{PSFCH} = 0$$

otherwise, if higher layer parameter si-PSFCH-Period is 2 or 4. If higher layer parameter sl-PSFCH-Period is 0,

$$\\ {N}_{symb}^{PSFCH} = 0.$$

If higher layer parameter si-PSFCH-Period is 1,

$$\\ {N}_{symb}^{PSFCH} = 3. {N}_{oh}^{PRB}$$

is the overhead given by higher layer parameter sl-X-Overhead.

$$\\ {N}_{RE}^{DMRS}$$

is given by higher layer parameter sl-PSSCH-DMRS-TimePattern. The UE may determine the total number of REs allocated for PSSCH (N_{RE}) by

$$\\ {N}_{RE} = {N}_{RE}^{′} \cdot {n}_{PRB} - {N}_{RE}^{SCI , 1} - {N}_{RE}^{SCI , 2} ,$$

where n_{PRB} is the total number of allocated PRBs for the PSSCH;

$$\\ {N}_{RE}^{SCI , 1}$$

is the total number of REs occupied by the PSCCH and PSCCH DM-RS;

$$\\ {N}_{RE}^{SCI , 2}$$

is the number of coded modulation symbols generated for 2^{nd}-stage SCI transmission (prior to duplication for the 2^{nd} layer, if present). The UE may determine the TBS based on the total number of REs allocated for PSSCH (N_{RE}) and/or the modulation order (Qₘ) and Target code rate (R) used in the physical sidelink shared channel.

For the single codeword q=0 of a PSSCH, the block of bits

$$\\ {b}^{( q )} ( 0 ) , … , {b}^{( q )} ( {M}_{bit}^{( q )} - 1 ) ,$$

where

$$\\ {M}_{bit}^{( q )} = {M}_{bit , SCI 2}^{( q )} + {M}_{bit , data}^{( q )}$$

is the number of bits in codeword q transmitted on the physical channel, may be scrambled prior to modulation (e.g., using a scrambling sequence based on a CRC of the PSCCH associated with the PSSCH). For the single codeword q=0, the block of scrambled bits may be modulated, resulting in a block of complex-valued modulation symbols

$$\\ {d}^{( q )} ( 0 ) , … , {d}^{( q )} ( {M}_{symb}^{( q )} - 1 )$$

where

$$\\ {M}_{symb}^{( q )} = {M}_{symb , 1}^{( q )} + {M}_{symb , 2}^{( q )} .$$

Layer mapping may be done with the number of layers v∈{1,2}, resulting in

$$\\ x ( i ) = {[ {x}^{( 0 )} ( i ) … {x}^{( v - 1 )} ( i ) ]}^{T} , i = 0 , 1 , … , {M}_{symb}^{layer} - 1.$$

The block of vectors [x⁽⁰⁾(i) . . . x^{(v-1)}(i)]^{T} may be pre-coded where the precoding matrix W equals the identity matrix and

$$\\ {M}_{symb}^{ap} = {M}_{symb}^{layer} .$$

For each of the antenna ports used for transmission of the PSSCH, the block of complex-valued symbols

$$\\ {z}^{( p )} ( 0 ) , … , {z}^{( p )} ( {M}_{symb}^{ap} - 1 )$$

may be multiplied with the amplitude scaling factor

$$\\ {β}_{DMRS}^{PSSCH}$$

in order to conform to the transmit power and mapped to resource elements (k′, l)_{p,μ} in the virtual resource blocks assigned for transmission, where k′=0 is the first subcarrier in the lowest-numbered virtual resource block assigned for transmission. The mapping operation may be done in two steps: first, the complex-valued symbols corresponding to the bit for the 2^{nd}-stage SCI in increasing order of first the index k′ over the assigned virtual resource blocks and then the index l, starting from the first PSSCH symbol carrying an associated DM-RS, wherein the corresponding resource elements in the corresponding physical resource blocks are not used for transmission of the associated DM-RS, PT-RS, or PSCCH; secondly, the complex-valued modulation symbols not corresponding to the 2^{nd}-stage SCI shall be in increasing order of first the index k′ over the assigned virtual resource blocks, and then the index l with the starting position, wherein the resource elements are not used for 2^{nd}-stage SCI in the first step; and/or the corresponding resource elements in the corresponding physical resource blocks are not used for transmission of the associated DM-RS, PT-RS, CSI-RS, or PSCCH.

The resource elements used for the PSSCH in the first OFDM symbol in the mapping operation above, including DM-RS, PT-RS, and/or CSI-RS occurring in the first OFDM symbol, may be duplicated in the OFDM symbol immediately preceding the first OFDM symbol in the mapping (e.g., for AGC training purposes).

Virtual resource blocks may be mapped to physical resource blocks according to non-interleaved mapping. For non-interleaved VRB-to-PRB mapping, virtual resource block n is mapped to physical resource block n.

For a PSCCH, the block of bits b(0), . . . , b(M_{bit}−1), where M_{bit} is the number of bits transmitted on the physical channel, may be scrambled prior to modulation, resulting in a block of scrambled bits \tilde{b}(0), . . . , \tilde{b}(M_{bit}−1) according to \tilde{b}(i)=(b(i)+c(i)) mod 2. The block of scrambled bits \tilde{b}(0), . . . , \tilde{b}(M_{bit}−1) may be modulated using QPSK, resulting in a block of complex-valued modulation symbols d(0), . . . , d(M_{symb}−1) where M_{symb}=M_{bit}/2. The set of complex-valued modulation symbols d(0), . . . , d(M_{symb}−1) may be multiplied with the amplitude scaling factor

$$\\ {β}_{DMRS}^{PSCCH}$$

in order to conform to the transmit power and mapped in sequence starting with d(0) to resource elements (k, l)_{p,μ} assigned for transmission, and not used for the demodulation reference signals associated with PSCCH, in increasing order of first the index k over the assigned physical resources, and then the index l on antenna port p (e.g., p=2000).

The resource elements used for the PSCCH in the first OFDM symbol in the mapping operation above, including DM-RS, PT-RS, and/or CSI-RS occurring in the first OFDM symbol, may be duplicated in the immediately preceding OFDM symbol (e.g., for AGC training purposes).

For sidelink resource allocation mode 1, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. For sidelink resource allocation mode 2, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. A UE may be required to decode neither the corresponding second SCI (e.g., SCI formats 2-A and/or 2-B) nor the PSSCH associated with a first SCI (e.g., SCI format 1-A) if the first SCI indicates an MCS table that the UE does not support.

Throughout this disclosure, a (sub) set of symbols of a slot, associated with a resource pool of a sidelink BWP, that is (pre-)configured for sidelink communication (e.g., transmission and/or reception) may be referred to as ‘sidelink symbols’ of the slot. The sidelink symbols may be contiguous/consecutive symbols of a slot. The sidelink symbols may start from a sidelink starting symbol (e.g., indicated by an RRC parameter), e.g., sidelink starting symbol may be symbol #0 or symbol #1, and so on. The sidelink symbols may comprise one or more symbols of the slot, wherein a parameter (e.g., indicated by RRC) may indicate the number of sidelink symbols of the slot. The sidelink symbols may comprise one or more guard symbols, e.g., to provide a time gap for the UE to switch from a transmission mode to a reception mode. For example, the OFDM symbol immediately following the last symbol used for PSSCH, PSFCH, and/or S-SSB may serve as a guard symbol. As shown in FIG. 19, the sidelink symbols may comprise one or more PSCCH resources/occasions and/or one or more PSCCH resources and/or zero or more PSFCH resources/occasions. The sidelink symbols may comprise one or more AGC symbols.

An AGC symbol may comprise duplication of (content of) the resource elements of the immediately succeeding/following symbol (e.g., a TB and/or SCI may be mapped to the immediately succeeding symbol). In an example, the AGC symbol may be a dummy OFDM symbol. In an example, the AGC symbol may comprise a reference signal. For example, the first OFDM symbol of a PSSCH and its associated PSCCH may be duplicated (e.g., in the AGC symbol that is immediately before the first OFDM symbol of the PSSCH). For example, the first OFDM symbol of a PSFCH may be duplicated (e.g., for AGC training purposes).

In a sidelink slot structure configuration, the first symbol is used for automatic gain control (AGC) a nd the last symbol is used for a gap. During an AGC symbol, a receiving and/or sensing UE may perform AGC training. For AGC training, a UE detects the energy/power of a signal in the channel during the AGC symbol and applies a hardware gain to maximize the signal amplitude to the dynamic range of the analog to digital converter (ADC) at the receiver. The receiver may determine a gain for a received signal, and an AGC duration allows time for the receiver to determine the gain and apply the gain (e.g., hardware gain component) such that when the receiver receives the data (e.g., in the next symbol(s), the gain of the amplifier has already been adjusted.

In the example embodiment of the present disclosure, for sidelink communication, the transmitter UE may not map data/control information to the AGC symbol. The AGC symbol may not be used for communication and sending information other than energy. The AGC symbol may be a last symbol prior to an earliest symbol of a transmission, such that a gap between AGC symbol and signal/channel transmission is minimized and an accurate gain is determined for receiving the following signal/channel. For example, the AGC symbol, as shown in FIG. 19, may be a symbol immediately preceding the first/earliest symbol of a resource used for a transmission via a channel (e.g., PSCCH and/or PSSCH and/or PSFCH transmission).

In an example, the AGC symbol may comprise duplication of resource elements of the next (immediately following) OFDM symbol. In an example, the AGC symbol may comprise any signal, e.g., a pre-defined signal/sequence and/or dummy information. The purpose of the AGC symbol is to allow the receiver UE to perform AGC training and adjust the hardware gain for a most efficient reception of the following signal.

Throughout this disclosure, the “AGC symbol” may be referred to as “duplicated symbol” and/or “duplication” and/or “the symbol used for duplication” and/or “the immediately preceding symbol comprising the duplication of a first symbol”.

In an example, the sidelink transmission may be beam-centric. For example, between peer wireless devices, a transmission of PSCCH, PSSCH, and/or PSFCH may be performed via, through, and/or using a particular beam. A sidelink reference signal (e.g., SL SSB, SL DM-RS, and/or SL CSI-RS) may represent a particular beam for the sidelink transmission.

In sidelink, a wireless device may transmit one or more SL RSs (e.g., perform a beam sweeping) for the beam-centric sidelink transmission. For example, a first wireless device may transmit, e.g., as the beam sweeping, a plurality of sidelink reference signal (SL RSs) (e.g., SL SSBs, SL CSI-RSs, SL positioning RS, and/or SL DM-RS) to a second wireless device. Each of the plurality of SL RSs may be corresponding to (e.g., associated with) a respective beam of the first wireless device. Each of a plurality of beams of the first wireless device may be corresponding to (e.g., associated with) a respective SL RS of the plurality of SL RSs of the first wireless device.

The transmission of one or more SL RS(s) (e.g., beam sweeping) may be for a particular sidelink (e.g., sidelink unicast, sidelink groupcast, and/or sidelink broadcast). For example, the transmission of one or more SL RS(s) (e.g., beam sweeping) may be for a sidelink unicast link between a pair of a source (e.g., a first wireless device identified/indicated by a source identifier) and a destination (e.g., a second wireless device identified/indicated by a destination identifier). The sidelink unicast link may refer to a direct communication link established between the pair of the source and the destination. The sidelink unicast link may be referred to as a PC5 (Proximity Service Communication 5) link, PC5 unicast link, PC5-RRC connection, and/or the like. For example, PC5-RRC connection may refer to a PC5 link over which a RRC layer is setup/established between the source and the destination.

The transmission of one or more SL RS(s) (e.g., beam sweeping) may occur before the sidelink unicast link being established, e.g., as a part of establishment procedure of the sidelink unicast link. The transmission of one or more SL RS(s) may occur during the sidelink unicast link being established, e.g., as a part of establishment procedure of the sidelink unicast link. The transmission of one or more SL RS(s) may occur after the sidelink unicast link being established, e.g., as a part of establishment procedure of the sidelink unicast link.

A first wireless device that transmits the one or more SL RS(s) may be the one that initiates a sidelink unicast link establishment procedure with a second wireless device (e.g., peer UE and/or destination). A first wireless device that transmits the one or more SL RS(s) may be the one that transmits, to a second wireless device (e.g., peer UE and/or destination) a request to establishment a sidelink unicast (e.g., that transmits a direct communication request (DCR) message).

A first wireless device that transmits the one or more SL RS(s) may be the one that receives, from a second wireless device, a request (e.g., a direct communication request (DCR) message) to establish a sidelink unicast. A first wireless device that transmits the one or more SL RS(s) may be the one that transmits, to a second wireless device, a response (e.g., a direct communication request accept (DCA) message) to a request (e.g., DCR) to establish a sidelink unicast.

A first wireless device that transmits the one or more SL RS(s) may be the one that transmits configuration parameters (e.g., scheduling and/or transmit power information) of the one or more SL RS(s) to the second wireless device. A first wireless device that transmits the one or more SL RS(s) may be the one that receives configuration parameters (e.g., scheduling and/or transmit power information) of the one or more SL RS(s) from the second wireless device.

For example, the transmission of one or more SL RSs may be referred to as or may be for beam sweeping. The beam sweeping (e.g., may be referred to as a full beam sweeping) may comprise transmission of all SL RSs of a first wireless device, e.g., for (e.g., initial) beam pairing. The all SL RSs may be SL RSs configured for a sidelink unicast link established for a pair of the first wireless device and the second wireless device. For example, the all SL RSs (e.g., sl-ReferenceSignalList) may be SL RSs indicated by one or more sidelink RRC messages that the first wireless device transmits to or received from the second wireless device to configured for the sidelink unicast link. The beam sweeping (e.g., may be referred to as a partial beam sweeping) may comprise transmission of one or more of all SL RSs of a first wireless device, e.g., for a beam management, radio link monitoring, and/or beam failure detection and/or recovery.

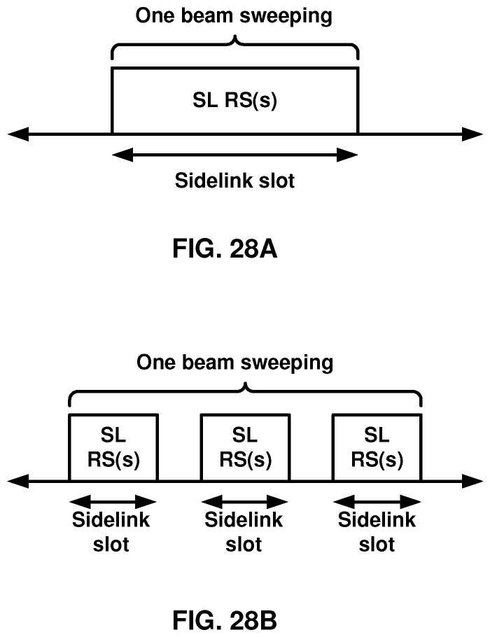

FIG. 28A and FIG. 28B illustrate examples of SL RSs as per an aspect of an example embodiment of the present disclosure. For example, as illustrated in FIG. 28A, a first wireless device may transmit, to a second wireless device, a plurality of SL RSs (e.g., a group/set of SL RSs) within a sidelink slot. For example, as illustrated in FIG. 28B, a first wireless device may transmit, to a second wireless device, a plurality of SL RSs (e.g., a group/set of SL RSs) via (e.g., across) multiple sidelink slots. The first wireless device may transmit one or more SL RSs of the plurality of SL RSs via each of sidelink slots in FIG. 28B.

The plurality of SL RSs in FIG. 28A and/or in FIG. 28B may be associated with a particular set or group (e.g., beam sweeping) of SL RS transmission. For example, each of the plurality of SL RSs is associated with a same set or a same group. For example, the first wireless device determines a first SL RS and a second SL RS are associated with a same set or a same group, e.g. if configuration parameters (e.g., sequence, resource, and/or scheduling information) of the first SL RS and the second SL RS are located in or are referred by a same configuration (e.g., same configuration information element (IE) in a message that the first wireless device transmits to or receives from the second wireless device to configured the first SL RS and the second SL RS.

For example, transmissions of SL RSs in a set or a group forms a (corresponding) beam sweeping. For example, a set or a group (e.g., that is associated with one or more SL RSs or that comprises one or more SL RSs) may be associated with a particular beam sweeping of SL RS transmission. Each set or group (or its respective beam sweeping) may be associated with a particular purpose of SL RS transmission. For example, a particular set or group (or its respective beam sweeping) may be for at least one of a periodic transmission of a plurality of SL RSs, aperiodic transmission of a plurality of SL RSs, and/or semi-persistent transmission of the plurality of SL RS, transmission(s) of a plurality of SL RSs for a (e.g., initial) beam pairing procedure, transmission(s) of a plurality of SL RSs for beam management procedure, transmission(s) of a plurality of SL RSs for a beam failure detection/recovery procedure, and/or any combination thereof. For example, the first wireless device may transmit, to a second wireless device, a message (e.g., sidelink RRC message, sidelink MAC CE and/or SCI) comprising a plurality of configurations (e.g., configuration (sl-CSIRS-ResourceConfig IE or the like). Each of the plurality of configurations may be associated with a respective set (or a group) of a plurality of sets (or groups). Each of the plurality of configurations may comprise a respective configuration identifier (additionally or alternatively, a respective set identifier or a respective group identifier) that identifies and/or indicates a respective set (or a group) of the plurality of sets (or groups). Each of the plurality of configurations may comprise parameters (e.g., sequence, resource, and/or scheduling information) indicating one or more SL RSs associated with a respective set (or a group).

In FIG. 28A and FIG. 28B, the first wireless device may transmit, to a second wireless device, the SL RS(s) with an indication of a set and/or a group associated with the SL RSs. For example, in a sidelink slot in FIG. 28A, the first wireless device may transmit, to the second wireless device, a control information (e.g., SCI, a first stage SCI, and/or a second stage SCI) comprising a field value (e.g., set identifier, group identifier, and/or configuration identifier) indicating the set and/or the group associated with the SL RS(s). For example, the first wireless device multiplexes the control information with the SL RS(s) in the sidelink slot. For example, the first wireless device transmits the control information via a sidelink slot (e.g., sidelink slot in FIG. 28A and/or at least one of sidelink slots in FIG. 28B) where the first wireless device transmits the SL RS(s). The second wireless device may determine that the control information (e.g., comprising the field value) indicates a transmission of the SL RS(s), associated with the set and/or the group (indicated by the field value in the SCI), being in the sidelink slot. In FIG. 28B, for example, in at least one sidelink slot (e.g., the firstly located sidelink slot or all of three sidelink shots) of three shots in FIG. 28B, the first wireless device may transmit, to the second wireless device, a control information (e.g., SCI, a first stage SCI, and/or a second stage SCI) comprising a field value (e.g., set identifier, group identifier, and/or configuration identifier) indicating the set and/or the group associated with the SL RSs. The second wireless device may determine that the control information (comprising the field value) indicates a transmission of the SL RSs, associated with the set and/or the group (indicated by the field value in the SCI), being in the at least one sidelink slot and/or in all three sidelink slots.

In example embodiments of present disclosure, a transmission of a plurality of SL RSs from one wireless device to another wireless device may occur via a plurality symbols in a slot (e.g., FIG. 28A) or via/across multiple slots (e.g., FIG. 28B). Each of the plurality of SL RS may be associated with or be grouped into a same configuration IE (e.g., sl-CSIRS-ResourceConfig IE or the like), a same set, and/or a same group. The same configuration IE (e.g., sl-CSIRS-ResourceConfig IE or the like), the same set, and/or the same group are identified a respective identifier (e.g., configuration id, set id, group id, and/or the like).

A transmission of each of the one or more SL RSs may use a respective beam (e.g., a respective TX spatial filter). For example, a wireless device may determine or prepare one or more beams (e.g., one or more TX spatial filters) for transmitting one or more SL RS transmissions. For a transmission of a first SL RS of the one or more SL RS, the wireless device may determine a respective TX spatial filter and/or a respective beam that are associated with the first SL RS. For example, signal(s) that the first wireless device processes and/or generates for transmitting the first SL RS may be the sequence(s) filtered by a first TX spatial filter (of the one or more TX spatial filters) corresponding to the first SL RS. Each of the TX spatial filters may determine beam pattern(s) (e.g., property and/or characteristic) of a first beam via which the first wireless device transmits a SL RS associated with the first TX spatial filter and/or the first beam. For example, the beam pattern(s) comprise at least one of: of a beamforming gain (or antenna gain), a beamwidth (e.g., half power beamwidth, null-to-null beamwidth, and/or the like), a number of mainlobe(s) and/or sidelobe(s), directivity(-ies) (e.g., azimuth/elevation angle) of mainlobe(s)/sidelobe(s), and/or the like.

A SL RS may be referred to as or indicated by a different terminology. For example, a SL TCI state, a SL SRI, a SL beam (e.g., SL TX beam and/or SL RX beam) may be used to refer to a SL RS. For example, a SL configuration may comprise a first SL TCI state or a first SL SRI field (or container or IE) that comprises, is linked to, or associated with a first SL RS (e.g., SL CSI RS). In this case, the first SL TCI state or the first SL SRI field (or container or IE) may be used as a terminology to indicate the first SL RS. Likewise, in this case, the first SL RS may be used as a terminology to indicate the first SL TCI state or the first SL SRI field (or container or IE).

Each of the plurality of SL RS may be associated with a respective spatial filter of a wireless device. For example, a first wireless device may: determine to use a first TX spatial filter for transmitting, to a second wireless device, a first SL RS of the plurality of SL RSs; determine to use a second TX spatial filter for transmitting, to a second wireless device, a second SL RS of the plurality of SL RSs; and so on. In this case, the first TX spatial filter and the second TX spatial filter are respectively associated with the first SL RS and the second SL RS. For example, if a first SL RS and a second SL RS are associated with a same TX spatial filter, the first wireless device and/or the second wireless device may determine that the first SL RS is quasi-co located with the second SL RS. If a first SL RS and a second SL RS are linked to or associated with a same SL TCI or SL SRI, the first wireless device and/or the second wireless device may determine that the first SL RS is quasi-co located with the second SL RS.

For example, if a first SL RS and a second SL RS are associated with a same TX spatial filter, the first wireless device and/or the second wireless device may determine that the first SL RS is quasi-co located with the second SL RS. If a first SL TCI (or first SL SRI) and a second SL TCI (or second SL SRI) are linked to or associated with a same SL RS, the first wireless device and/or the second wireless device may determine that the first SL TCI is quasi-co located with the second SL TCI.

For example, a SL TCI may be referred to as or be interchangeably used with a SL TCI state. A SL TCI (or a configuration of the SL TCI) may comprise or is associated with a respective SL TCI identifier. The SL TCI identifier may be used to indicate a respective SL TCI. A SL SRI (or a configuration of the SL SRI) may comprise or is associated with a respective SL SRI identifier. The SL SRI identifier may be used to indicate a respective SL SRI. The SL RS identifier may be used to indicate a respective SL RS.

After or in response to a first wireless device transmitting a plurality of SL RSs to a second wireless device, the second wireless device may determine a preferred SL beam or a preferred SL beam pair, e.g., based on comparison between/among measurements (e.g., reference signal received powers) of the plurality of SL RSs. For example, a (e.g., preferred) SL beam or a preferred SL beam pair may be represented by or identified by a respective SL TCI, SL SRI, or SL RS. For example, the second wireless device may determine a measurement quantity (e.g., RSRP or RSRQ) of each of the plurality of SL RSs. The second wireless device may determine or select a preferred SL beam in response to the measurement quantity satisfying one or more conditions (e.g., RSRP value is higher than or equal to a RSRP threshold).

After or in response to a first wireless device transmitting a plurality of SL RSs to a second wireless device, the second wireless device may determine/select its RX spatial filter corresponding to the (e.g., preferred) SL beam. The determined/selected preferred SL beam and the determined/selected RX spatial filter may be referred to as a (e.g., preferred) SL beam pair. The second wireless device may transmit, to the first wireless device, a signal or message (e.g., comprising a report of measurements of SL RS(s), and/or SL CSI report) indicating the selected (e.g., preferred) SL beam and/or a (e.g., preferred) SL beam pair. For example, the signal or message (e.g., comprising a report of measurements of SL RS(s), and/or SL CSI report) may comprise a field (e.g., a value of the field) indicating a SL TCI, SL SRI, or SL RS identifier associated with the selected (e.g., preferred) SL beam and/or a (e.g., preferred) SL beam pair, e.g., as a way to indicate the selected (e.g., preferred) SL beam and/or a (e.g., preferred) SL beam pair.

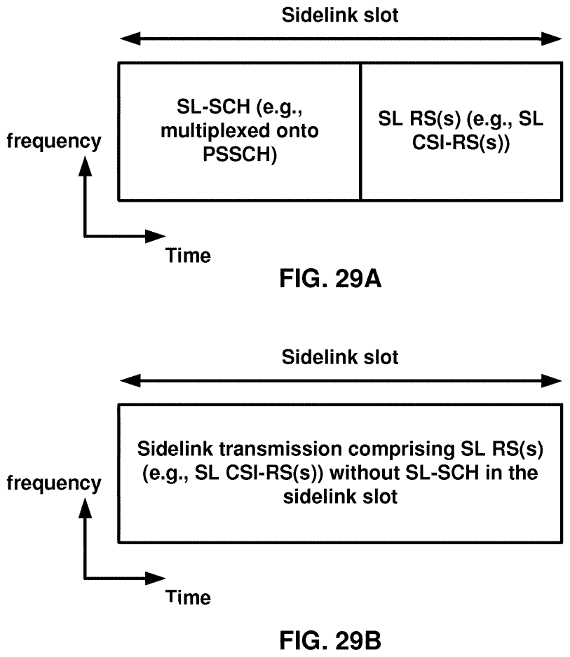

FIG. 29A illustrates an example for SL RS transmission as per an aspect of an embodiment of the present disclosure. A first wireless device may transmit, to a second wireless device, a SL RS (e.g., SL CSI RS), e.g., each of SL RS(s) (e.g., SL CSI-RS(s), with SL data (e.g., SL-SCH, SL MAC SDU and/or MAC CE(s) (e.g., that are multiplexed onto PSSCH)) via a sidelink (e.g., same) slot, as illustrated in FIG. 29A. For example, the first wireless device may transmit a plurality of SL RSs and SL-SCH (and/or SL MAC SDU), e.g., that are multiplexed onto PSSCH in a same sidelink slot. The first wireless device may transmit the SL RS(s) in FIG. 29A or FIG. 29B may be for example embodiment(s) of the present disclosure (e.g., an initial beam pairing procedure, a beam management procedure, and/or a beam failure detection/recovery procedure). The SL RS(s) in FIG. 29A or FIG. 29B may be at least one of the SL RSs in FIG. 28A or any one of SL RS(s) in one of three sidelink slots in FIG. 28B. The sidelink slot in FIG. 29A or FIG. 29B may be a sidelink slot in FIG. 28A or any one of sidelink slots in FIG. 28B.

Referring to FIG. 29A, the SL RS may be multiplexed with PSSCH in a sidelink (e.g., same) slot. As an example multiplexing, one or more PSSCHs may be firstly located in the sidelink slot, followed by one or more SL RS(s) in the sidelink (e.g., same) slot in the time domain. As an example multiplexing, SL RS(s) may be firstly located in the sidelink slot, followed by one or more PSSCHs (e.g., comprising SL-SCH and/or SL MAC SDU) in the sidelink slot in the time domain. As an example multiplexing, one or more PSSCHs (e.g., comprising SL-SCH and/or SL MAC SDU) may be allocated between two SL RSs in the sidelink slot in the time domain. The transmission of SL RS(s) multiplexed with PSSCH (e.g., comprising SL-SCH and/or SL MAC SDU) in a same slot may be referred to as a non-standalone transmission of SL RS(s) or the like. In FIG. 29A, the first wireless device may transmit PSCCH and/or SCI (e.g., first stage SCI and/or second stage SCI) in the sidelink slot via which the first wireless device transmits the SL RS(s) and/or the PSSCH. The PSCCH and/or SCI may comprise one or more fields whose values indicate at least one of: a number of SL RS(s) in the sidelink slot, a starting position (symbol) in a slot of each of the SL RS(s) in the sidelink slot, an ending position (symbol), in the sidelink slot, of each of the SL RS(s) in the sidelink slot, or a frequency resource allocation of each of the SL RS(s) in the sidelink slot.

FIG. 29B illustrates an example for SL RS transmission as per an aspect of an embodiment of the present disclosure. A first wireless device may transmit, to a second wireless device, a SL RS (e.g., SL CSI RS), e.g., each of SL RS(s) (e.g., SL CSI-RS(s), without data (e.g., SL-SCH, SL MAC SDU, and/or PSSCH comprising SL-SCH and/or SL MAC SDU) in a same slot, as illustrated in FIG. 29B. The first wireless device may transmit the SL RS(s) in FIG. 29B may be for a beam sweeping (e.g., an initial beam pairing procedure, a beam management procedure, and/or a beam failure detection/recovery procedure). The SL RS(s) in FIG. 29B may be at least one of the SL RSs in FIG. 28A or any one of SL RS(s) in one of three sidelink slots in FIG. 28B. The sidelink slot in FIG. 29A may be a sidelink slot in FIG. 28A or any one of sidelink slots in FIG. 28B.

Referring to FIG. 29B, the transmission of SL RS(s) without SL data (e.g., from SL-SCH and/or SL MAC SDU) in a sidelink slot may be referred to as a standalone transmission of SL RS(s) or the like. The SL data may comprise SL-SCH (and/or SL MAC SDU) and/or be the one associated with SL-SCH (and/or SL MAC SDU). The SL data may further comprise one or more MAC CEs.

Referring to FIG. 29B, the first wireless device may transmit control information (e.g., PSCCH, SCI, first-stage SCI, and/or second-stage SCI) in the sidelink (e.g., same) slot (or in a standalone transmission) where the first wireless device transmits, as the standalone transmission, the SL RS(s). The control information may comprise one or more fields whose values indicates at least one of: a number of SL RS(s) in the sidelink slot, a starting position (symbol) in a slot of each of the SL RS(s) in the sidelink slot, an ending position (symbol), in the sidelink slot, of each of the SL RS(s) in the sidelink slot, or a frequency resource allocation of each of the SL RS(s) in the sidelink slot.

For example, the transmission of SL RS(s) without SL-SCH (e.g., without PSSCH comprising at least SL-SCH and/or SL MAC SDU) in a sidelink slot may be referred to as a standalone transmission of SL RS(s) or the like. In FIG. 29B, the first wireless device may not transmit SL-SCH (e.g., PSSCH comprising SL-SCH or SL MAC SDU comprising SL-SCH) in the sidelink (e.g., same) slot (or in a standalone transmission) where the first wireless device transmits, as the standalone transmission, the SL RS(s). In FIG. 29B, the first wireless device may transmit one or more MAC CE(s) in the sidelink (e.g., same) slot (or in a standalone transmission) where the first wireless device transmits, as the standalone transmission, the SL RS(s).

For example, the transmission of SL RS(s) without PSSCH (e.g., comprising SL-SCH, SL MAC SDU, and/or MAC CE(s) in a sidelink slot may be referred to as a standalone transmission of SL RS(s) or the like. In FIG. 29B, the first wireless device may not transmit SL-SCH (e.g., PSSCH comprising SL-SCH or SL MAC SDU comprising SL-SCH) in the sidelink (e.g., same) slot (or in a standalone transmission) where the first wireless device transmits, as the standalone transmission, the SL RS(s). In FIG. 29B, the first wireless device may not transmit one or more MAC CE(s) in the sidelink (e.g., same) slot (or in a standalone transmission) where the first wireless device transmits, as the standalone transmission, the SL RS(s).

Referring to FIG. 29B, the standalone transmission of the SL RS(s) may refer to the SL transmission in a slot without any of PSCCH and PSSCH (e.g., SL-SCH, SL MAC SDU, and/or MAC CE). For example, the standalone transmission comprises transmission(s) of the SL RS(s) and/or may not comprise transmission(s) of PSCCH and PSSCH (e.g., SL-SCH, SL MAC SDU, and/or MAC CE).

In an example, a transmission of a SL RS may be a transmission of a sequence of SL RS (e.g., SL CSI-RS). For example, a sequence of SL RS may be denoted by r(m). A first wireless device may generate the sequence r(m) as a formular predefined. For example, the sequency r(m) may be

$$\\ r ( m ) = \frac{1}{\sqrt{2}} ( 1 - 2 c ( 2 m ) ) + j \frac{1}{\sqrt{2}} ( 1 - 2 c ( 2 m + 1 ) ) .$$

c(i) may be a pseudo-random sequence. c(i) may be initialized with

$$\\ {c}_{init} = ( {2}^{10} ( {N}_{symb}^{slot} {n}_{s , f}^{μ} + l + 1 ) ( 2 {n}_{ID} + 1 ) + {n}_{ID} )$$

mod 2³¹ at the start of each OFDM symbol.

$$\\ {n}_{s , f}^{μ}$$

may be the slot number (or index) within a radio frame. l may be the OFDM symbol number (or index) within a slot. In an example, a first wireless device may transmit a SL RS via a symbol with the OFDM symbol number l within the slot. In an example, one or more parameters (e.g., sl-CSI-RS-FirstSymbol), in a message (SL RRC message) that the first wireless device transmits to the second wireless device and/or the second wireless device receives from the first wireless device, may indicate the OFDM symbol number l. A second wireless device may receive the SL RS via the symbol within the slot.

A first wireless device may transmit a plurality of SL RSs (e.g., SL CSI RSs) via a plurality of OFDM symbols within a slot, for example, as illustrated in FIG. 28A, FIG. 28B, FIG. 29A, and/or FIG. 29B. The first wireless device may transmit the plurality of SL RSs with a PSSCH in the slot (e.g., in FIG. 29A) or without a PSSCH in the slot (in FIG. 29B). The plurality of SL RSs and the PSSCH may occupy (or be carried on, or be scheduled in) different OFDM symbols in the slot, e.g., if the first wireless device transmits the plurality of SL RSs and the PSSCH in the same slot. The plurality of OFDM symbols may be allocated to SL RSs. An indication (e.g., a field of a SCI within the slot) may indicate the presence of at least one or more (or all) of the plurality of SL RSs in transmission of the PSSCH in the slot. For example, a 1 bit field in a SCI Format 1-A may inform (or indicate) that the at least one or more (or all) of the plurality of SL RSs is presence (or multiplexed or transmitted) in the SL transmission in the slot.

In an example, a first wireless device may transmit, to the second wireless device, SL RS(s) (or at least one or more of the SL RS(s)). The first wireless device may determine resource(s) for transmitting at least one or more of the SL RS(s). The resources may be (e.g., may span, and/or may be located) in one or more symbols (e.g., OFDM symbols) of a slot. The resource(s) may be (e.g., may span, and/or may be located) within L subchannel(s) (e.g., L≥1) in the slot. The resource(s) may comprise one or more REs in the slot over L subchannel(s). The one or more REs may be the one that the first wireless device determines to map the at least one or more of the SL RS(s) and transmits the at least one or more of the SL RS(s). For example, the one or more REs in one or more symbols in the slot over one or more PRBs (or RBs) within L subchannel(s) as the resources to map the SL RS(s) and/or as the resources via which the first wireless device transmits the SL RS(s).

The at least one or more of the SL RS(s) may be multiplexed with PSCCH and/or PSSCH in a same slot. The at least one or more of the SL RS(s)) may be multiplexed with PSCCH and/or PSSCH in different symbols in the same slot. PSCCH and/or PSSCH may span within the same L subchannel(s) where the at least one or more of the SL RS(s) spans. The frequency of the at least one or more of the SL RS(s)) may span within the same L subchannel(s) where PSCCH and/or PSSCH span.

For example, frequency resource(s) of the at least one or more of the SL RS(s) may be aligned with frequency resources(s) of the PSSCH and/or PSCCH as illustrated in FIG. 29A or FIG. 29B. For example, a highest index of PRB carrying the at least one or more of the SL RS(s)) may be the same as a highest index of PRB carrying the PSCCH and/or PSCCH. For example, a lowest index of PRB carrying the at least one or more of the SL RS(s)) may be the same as a lowest index of PRB carrying the PSCCH and/or PSCCH.

For example, time resource(s) of the at least one or more of the SL RS(s)) may be different (e.g., may be disjoint, may not overlap with) time resource(s) of the PSSCH and/or PSCCH as illustrated in FIG. 29A or FIG. 29B. The time resource(s) of the at least one or more of the SL RS(s) may be in one or more first symbols in the slot. The time resource(s) of the PSSCH and/or PSCCH may be in one or more second symbols in the slot. The one or more first symbols may be different from the one or more second symbols.

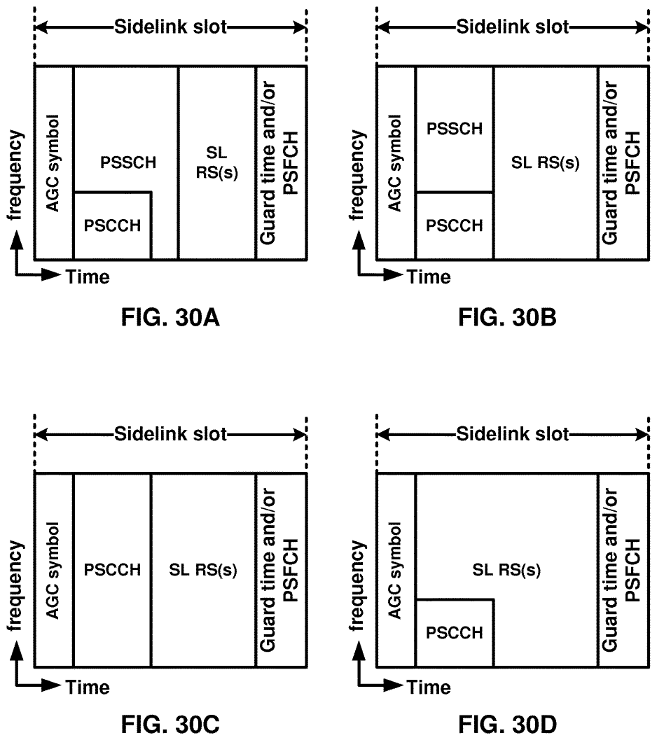

FIG. 30A, FIG. 30B, FIG. 30C, and FIG. 30D illustrate examples of sidelink channels as per an aspect of an embodiment of the present disclosure. FIG. 30A, FIG. 30B, FIG. 30C, and FIG. 30D are the examples of FIG. 29A and/or FIG. 29B.

In FIG. 30A, FIG. 30B, FIG. 30C, and/or FIG. 30D, the radio resource(s) (e.g., time and frequency resource and/or resource assignment/allocation) of PSCCH, PSSCH (e.g., for FIG. 30A and/or FIG. 30B), and/or SL RS(s) do not overlap with each other. For example, the PSCCH is multiplexed in non-overlapping resources with the PSSCH in a same slot as shown in FIG. 30A and/or FIG. 30B and/or is multiplexed in non-overlapping resources with the SL RS(s) in the same slot as shown in FIG. 30A, FIG. 30B, FIG. 30C, and/or FIG. 30D. For example, the PSSCH is multiplexed in non-overlapping resources with the SL RS(s) in the same slot as shown in in FIG. 30A, FIG. 30B. The wireless device may transmit (or may start to transmit) the PSCCH and/or the PSCCH from a same symbol in the slot (e.g., a symbol after or next the AGC symbol or a symbol located secondly in the slot) as shown in FIG. 30A and/or FIG. 30B. The wireless device may transmit (or may start to transmit) the SL RS(s) via one or more symbols. The one or more symbols may be located and/or occur after the last symbol of the PSCCH or PSSCH until the symbol(s) allocated (determined) for guard time and/or PSFCH transmission in the slot.

In FIG. 30A, FIG. 30B, FIG. 30C, and/or FIG. 30D, the number of symbols for transmitting the PSCCH may be (pre-)configured (e.g., per a resource pool as resource pool configuration parameter(s). For example, resource pool configuration parameter(s) that the first wireless device receives may indicate the number of symbols for transmitting the PSCCH. For example, the number of symbols may be 2 or 3 symbols. For example, the number of symbols for transmitting the PSCCH is different depending on whether the first wireless device transmits, e.g., for beam sweeping, the SL RS(s) in the same slot. For example, resource pool configuration parameter(s) may comprise at least two parameters; a first parameter indicating a first number of symbols for transmitting the PSCCH without the SL RS(s) (e.g., that are for beam sweeping or for beam management as illustrated in FIG. 30A, FIG. 30B, FIG. 30C, and/or FIG. 30D) in the same slot; and/or a second parameter indicating a second number of symbols for transmitting the PSCCH with the SL RS(s) (e.g., that are for beam sweeping or for beam management as illustrated in FIG. 30A, FIG. 30B, FIG. 30C, and/or FIG. 30D) in the same slot.

FIG. 30A illustrates an example of sidelink channels as per an aspect of an embodiment of the present disclosure. FIG. 30A is an example of SL RS(s) transmission with PSSCH and PSCCH in the same slot. For example, FIG. 30A may be an example of the non-standalone transmission of the SL RS(s) in FIG. 29A.

In FIG. 30A, in the frequency domain, the PSCCH may occupy a (pre-)configured number of M PRBs (e.g., M≥1). For example, resource pool configuration parameter(s) may indicate M used for a resource pool associated with (e.g., configured by) the resource pool configuration parameter(s). The M PRBs of the PSCCH may start from a predefined or configured PRB (e.g., a lowest PRB in the frequency domain) within sub-channel(s). An example M may be 10, 12, 15, 20 or 25 PRBs. For example, the PSCCH may be allocated, assigned, and/or contained within one sub-channel.

For example, the sub-channel(s) may be occupied by the PSSCH (e.g., associated PSSCH indicated/scheduled by the PSCCH) in the same slot. For example, the M PRBs of the PSCCH may be confined within the sub-channel(s) allocated for the PSSCH in the same slot. For example, the wireless device may determine the PRBs of the SL RS(s) to be aligned with the PRBs of the PSSCH.

For example, the sub-channel(s) may be occupied by the SL RS(s) (e.g., associated SL RS(s) indicated/scheduled by the PSCCH) in the same slot. For example, the M PRBs of the PSCCH may be confined within the sub-channel(s) allocated for the SL RS(s) in the same slot. For example, the SL RS(s) may occupy a (pre-)configured number of N PRBs (e.g., N≥1). For example, resource pool configuration parameter(s) may indicate N used for a resource pool associated with (e.g., configured by) the resource pool configuration parameter(s). For example, configuration parameter(s) of the SL RS(s) may indicate N. For example, the M PRBs of the PSCCH may start from a lowest PRB within the N PRBs and/or the sub-channel(s) assigned and/or allocated for the SL RS(s). For example, the wireless device may determine the PRBs of the PSSCH to be aligned with the PRBs of the SL RS(s).

In FIG. 30A, for example, the lowest index of the PRBs of the SL RS(s) may be same as the lowest index of the PRBs of the PSSCH. For example, the highest index of the PRBs of the SL RS(s) may be same as the highest index of the PRBs of the PSSCH. For example, the lowest index of the PRBs of the SL RS(s) may be same as the lowest index of the PRBs of the PSCCH. For example, the lowest index of the PRBs of the PSCCH may be same as the lowest index of the PRBs of the PSSCH.

In FIG. 30A, the first wireless device may determine the resource allocation of PSSCH (e.g., time domain and/or frequency domain resource allocation) according to one or more example embodiments of the present disclosure. The first wireless device may transmit (e.g., start to transmit) the PSSCH from a predefined or configured symbol (e.g., a symbol located secondly in the slot) in the slot. The number of PSSCH symbols may depend on the number of symbols in a slot, whether PSFCH is in the slot, and/or a number of symbols carrying the SL RS(s). For example, the wireless device may transmit the PSSCH in 2 to 12 consecutive symbols. In the 2 or 3 symbols which carry PSCCH, the PSSCH can be multiplexed in the frequency domain with PSCCH. In the symbols without PSCCH, the PSSCH may span (e.g., all) sub-channel(s) that are assigned/allocated to the PSSCH as shown in FIG. 30A. The symbol after the last PSSCH symbol may be a starting symbol of the transmission of the SL RS(s).

In FIG. 30A, the first wireless device may determine the resource allocation of SL RS(s) (e.g., time domain and/or frequency domain resource allocation) based on the resource allocation of the PSCCH and/or PSSCH in the same slot. For example, the first wireless device may transmit the SL RS(s) from a predefined or configured symbol (e.g., a symbol located after the PSCCH and/or PSSCH in the slot) in the slot. The number of SL RS(s) symbols may depend on the number of symbols in a slot, whether PSFCH is in the slot, and/or a number of symbols carrying the PSCCH and/or PSSCH. For example, the wireless device may transmit the SL RS(s) via the remaining symbol in the slot. The first wireless device may determine the remaining symbol by excluding the AGC symbol and/or one or more symbols allocated for or carrying PSCCH, PSSCH, PSFCH, and/or Guard time from (e.g., all) symbols available in the slot as shown in FIG. 30A.

In FIG. 30A, the first wireless device may determine the resource allocation of PSCCH and/or PSSCH (e.g., time domain and/or frequency domain resource allocation) based on the resource allocation of the SL RS(s) in the same slot. For example, the first wireless device may transmit the SL RS(s) from a predefined or configured symbol (e.g., a symbol located after the PSCCH and/or PSSCH in the slot) in the slot. The number of PSCCH and/or PSSCH symbols may depend on the number of symbols in a slot, whether PSFCH is in the slot, and/or a number of symbols carrying the SL RS(s). For example, the wireless device may transmit the PSCCH and/or PSSCH via the remaining symbol in the slot. The first wireless device may determine the remaining symbol by excluding the AGC symbol and/or one or more symbols allocated for or carrying SL RS(s) and/or Guard time from (e.g., all) symbols available in the slot as shown in FIG. 30A.

FIG. 30B illustrates an example of sidelink channels as per an aspect of an embodiment of the present disclosure. FIG. 30B is an example of SL RS(s) transmission with PSSCH and PSCCH in the same slot. For example, FIG. 30B may be an example of the non-standalone transmission of the SL RS(s) in FIG. 29A.

In FIG. 30B, in the frequency domain, the PSCCH may occupy a (pre-)configured number of M PRBs (e.g., M≥1). For example, resource pool configuration parameter(s) may indicate M used for a resource pool associated with (e.g., configured by) the resource pool configuration parameter(s). The M PRBs of the PSCCH may start from a predefined or configured PRB (e.g., a lowest PRB in the frequency domain) within sub-channel(s). An example M may be 10, 12, 15, 20 or 25 PRBs. For example, the PSCCH may be allocated, assigned, and/or contained within one sub-channel. For example, the sub-channel(s) may be occupied by the SL RS(s) (e.g., associated SL RS(s) indicated/scheduled by the PSCCH) in the same slot. For example, the M PRBs of the PSCCH may be confined within the sub-channel(s) allocated for the SL RS(s) in the same slot. For example, the SL RS(s) may occupy a (pre-)configured number of N PRBs (e.g., N≥1). For example, resource pool configuration parameter(s) may indicate N used for a resource pool associated with (e.g., configured by) the resource pool configuration parameter(s). For example, configuration parameter(s) of the SL RS(s) may indicate N.

In FIG. 30B, the wireless device may determine the PRBs of the PSCCH to be aligned with the PRB(s) of the SL RS(s). For example, the M PRBs of the PSCCH may start from a lowest PRB within the N PRBs and/or the sub-channel(s) assigned and/or allocated for the SL RS(s). For example, the lowest index of the PRBs of the SL RS(s) may be same as the lowest index of the PRBs of the PSCCH.

In FIG. 30B, the wireless device may determine the PRBs of the PSSCH to be aligned with the PRB(s) of the SL RS(s). For example, the highest index of the PRB of the SL RS(s) may be same as the highest index of the PRBs of the PSSCH. For example, the wireless device may determine the number of PRBs allocated for the PSSCH and/or location and/or indices of the PRBs allocated for the PSSCH based on the PRBs allocated for the PSCCH and/or SL RS(s). For example, the number of PRBs of the PSSCH may be (N-M) PRBs.

In FIG. 30B, the lowest PRB index among one or more first PRBs (e.g., N-M PRBs) of the PSSCH may be based on the highest PRB index among one or more second PRBs (e.g., M PRBs) of the PSCCH. For example, the lowest PRB index (e.g., denoted by index X, X≥1) of the PSSCH is a next index of the highest PRB index (e.g., denoted by index X−1) of the PSCCH.

In FIG. 30B, the first wireless device may determine the resource allocation of PSSCH in time domain to be aligned with the PSCCH. For example, the symbol(s) carrying the PSSCH may be the same as the symbols carrying the PSCCH in the same slot. For example, the first wireless device may transmit the PSSCH from a predefined or configured symbol (e.g., a symbol located secondly in the slot) in the slot. The symbol after the last PSSCH symbol and/or after the last PSCCH symbol may be a starting symbol of the transmission of the SL RS(s).

In FIG. 30B, the first wireless device may determine the resource allocation of SL RS(s) (e.g., time domain and/or frequency domain resource allocation) based on the resource allocation of the PSCCH and/or PSSCH in the same slot. For example, the first wireless device may transmit the SL RS(s) from a predefined or configured symbol (e.g., a symbol located after the PSCCH and/or PSSCH in the slot) in the slot. The number of SL RS(s) symbols may depend on the number of symbols in a slot, whether PSFCH is in the slot, and/or a number of symbols carrying the PSCCH and/or PSSCH. For example, the wireless device may transmit the SL RS(s) via the remaining symbol in the slot. The first wireless device may determine the remaining symbol by excluding the AGC symbol and/or one or more symbols allocated for or carrying PSCCH, PSSCH, PSFCH, and/or Guard time from (e.g., all) symbols available in the slot as shown in FIG. 30A.

In FIG. 30B, the first wireless device may determine the resource allocation of PSCCH and/or PSSCH (e.g., time domain and/or frequency domain resource allocation) based on the resource allocation of the SL RS(s) in the same slot. For example, the first wireless device may transmit the SL RS(s) from a predefined or configured symbol (e.g., a symbol located after the PSCCH and/or PSSCH in the slot) in the slot. The number of PSCCH and/or PSSCH symbols may depend on the number of symbols in a slot, whether PSFCH is in the slot, and/or a number of symbols carrying the SL RS(s). For example, the wireless device may transmit the PSCCH and/or PSSCH via the remaining symbol in the slot. The first wireless device may determine the remaining symbol by excluding the AGC symbol and/or one or more symbols allocated for or carrying SL RS(s) and/or Guard time from (e.g., all) symbols available in the slot as shown in FIG. 30B.

FIG. 30C illustrates an example of sidelink channels as per an aspect of an embodiment of the present disclosure. FIG. 30C is an example of SL RS(s) transmission with PSCCH (e.g., and without PSSCH) in the same slot. For example, FIG. 30C may be an example of the non-standalone transmission of the SL RS(s) in FIG. 29A. For example, FIG. 30C may be an example of the standalone transmission of the SL RS(s) in FIG. 29B.

In FIG. 30C, in the frequency domain, the SL RS(s) may occupy a (pre-)configured number of N PRBs (e.g., N≥1). For example, resource pool configuration parameter(s) may indicate N used for a resource pool associated with (e.g., configured by) the resource pool configuration parameter(s). For example, configuration parameter(s) of the SL RS(s) may indicate N. For example, the PSCCH may be allocated, assigned, and/or contained within sub-channel(s) occupied by the SL RS(s) (e.g., associated SL RS(s) indicated/scheduled by the PSCCH) in the same slot. For example, the PSCCH may be confined within the sub-channel(s) allocated for the SL RS(s) in the same slot. For example, the PSCCH and SL RS(s) in the same slot occupy the same sub-channel(s) and/or are allocated to the same PRBs (e.g., N PRBs) in the same slot. For example, the N PRBs may start from a predefined or configured PRB (e.g., a lowest PRB in the frequency domain) within sub-channel(s). An example N may be 10, 12, 15, 20 or 25 PRBs. For example, the PSCCH and the SL RS(s) may occupy one subchannel.

In FIG. 30C, the first wireless device may determine the resource allocation of SL RS(s) (e.g., time domain and/or frequency domain resource allocation) based on the resource allocation of the PSCCH in the same slot. For example, the first wireless device may transmit the SL RS(s) from a predefined or configured symbol (e.g., a symbol located after the PSCCH in the slot) in the slot. The number of SL RS(s) symbols may depend on the number of symbols in a slot, whether PSFCH is in the slot, and/or a number of symbols carrying the PSCCH. For example, the wireless device may transmit the SL RS(s) via the remaining symbol in the slot. The first wireless device may determine the remaining symbol by excluding the AGC symbol and/or one or more symbols allocated for or carrying PSCCH, PSFCH, and/or Guard time from (e.g., all) symbols available in the slot as shown in FIG. 30C.

In FIG. 30C, the first wireless device may determine the resource allocation of PSCCH (e.g., time domain and/or frequency domain resource allocation) based on the resource allocation of the SL RS(s) in the same slot. For example, the first wireless device may transmit the SL RS(s) from a predefined or configured symbol (e.g., a symbol located after the PSCCH in the slot) in the slot. The number of PSCCH symbols may depend on the number of symbols in a slot, whether PSFCH is in the slot, and/or a number of symbols carrying the SL RS(s). For example, the wireless device may transmit the PSCCH via the remaining symbol in the slot. The first wireless device may determine the remaining symbol by excluding the AGC symbol and/or one or more symbols allocated for or carrying SL RS(s) and/or Guard time from (e.g., all) symbols available in the slot as shown in FIG. 30C.

FIG. 30D illustrates an example of sidelink channels as per an aspect of an embodiment of the present disclosure. FIG. 30D is an example of SL RS(s) transmission with PSCCH (e.g., and without PSSCH) in the same slot. For example, FIG. 30D may be an example of the non-standalone transmission of the SL RS(s) in FIG. 29A. For example, FIG. 30C may be an example of the standalone transmission of the SL RS(s) in FIG. 29B.

In FIG. 30D, in the frequency domain, the PSCCH may occupy a (pre-)configured number of M PRBs (e.g., M≥1). For example, resource pool configuration parameter(s) may indicate M used for a resource pool associated with (e.g., configured by) the resource pool configuration parameter(s). The M PRBs of the PSCCH may start from a predefined or configured PRB (e.g., a lowest PRB in the frequency domain) within sub-channel(s). An example M may be 10, 12, 15, 20 or 25 PRBs. For example, the PSCCH may be allocated, assigned, and/or contained within one sub-channel.

For example, the sub-channel(s) may be occupied by the SL RS(s) (e.g., associated SL RS(s) indicated/scheduled by the PSCCH) in the same slot. For example, the M PRBs of the PSCCH may be confined within the sub-channel(s) allocated for the SL RS(s) in the same slot. For example, the SL RS(s) may occupy a (pre-)configured number of N PRBs (e.g., N≥1). For example, resource pool configuration parameter(s) may indicate N used for a resource pool associated with (e.g., configured by) the resource pool configuration parameter(s). For example, configuration parameter(s) of the SL RS(s) may indicate N. For example, the M PRBs of the PSCCH may start from a lowest PRB within the N PRBs and/or the sub-channel(s) assigned and/or allocated for the SL RS(s). For example, the wireless device may determine the PRBs of the PSSCH to be aligned with the PRBs of the SL RS(s).

In FIG. 30D, in the 2 or 3 symbols which carry PSCCH, the SL RS(s) can be multiplexed in the frequency domain with PSCCH. In the symbols without PSCCH, the SL RS(s) may span (e.g., all) sub-channel(s) that are assigned/allocated to the SL RS(s) as shown in FIG. 30D. The symbol after the AGC symbol may be a starting symbol of the transmission of the SL RS(s).

In FIG. 30D, the first wireless device may determine the resource allocation of SL RS(s) (e.g., time domain and/or frequency domain resource allocation) based on the resource allocation of the PSCCH in the same slot. For example, the first wireless device may transmit the SL RS(s) from a predefined or configured symbol (e.g., a symbol located after the PSCCH in the slot) in the slot. The number of SL RS(s) symbols may depend on the number of symbols in a slot, whether PSFCH is in the slot and/or a number of symbols carrying the PSCCH. For example, the wireless device may transmit the SL RS(s) via the remaining symbol in the slot. The first wireless device may determine the remaining symbol by excluding the AGC symbol and/or one or more symbols allocated for or carrying PSCCH, PSFCH, and/or Guard time from (e.g., all) symbols available in the slot as shown in FIG. 30D.

In FIG. 30D, the first wireless device may determine the resource allocation of PSCCH (e.g., time domain and/or frequency domain resource allocation) based on the resource allocation of the SL RS(s) in the same slot. For example, the first wireless device may transmit the SL RS(s) from a predefined or configured symbol (e.g., a symbol located after the PSCCH in the slot) in the slot. The number of PSCCH symbols may depend on the number of symbols in a slot, whether PSFCH is in the slot, and/or a number of symbols carrying the SL RS(s). For example, the wireless device may transmit the PSCCH via the remaining symbol in the slot. The first wireless device may determine the remaining symbol by excluding the AGC symbol and/or one or more symbols allocated for or carrying SL RS(s) and/or Guard time from (e.g., all) symbols available in the slot as shown in FIG. 30D.

The (e.g., initial) beam pairing procedure may comprise a determination of beam pair that is used for a transmission via a sidelink (e.g., unicast link) between two wireless devices, e.g., a first wireless device and a second wireless device. Before beam-formed SL transmission, the first wireless device and the second wireless device may select a preferred TX beam (e.g., TX spatial filter or precoder) of a transmitter wireless device (e.g., the first wireless device and/or the second wireless device) and a preferred RX beam (e.g., RX spatial filter) of a receiver wireless device (e.g., the first wireless device and/or the second wireless device) for the SL transmission between the first wireless device and the second wireless device.

The determined beam pair between the first wireless device and the second wireless device may be represented by a SL RS. The determined beam pair between the first wireless device and the second wireless device may be represented by a SL TCI state (e.g., comprising an indication/index/identifier of the SL RS). For example, the first wireless device and/or the second wireless device determine the SL TCI state (e.g., comprising an indication/index/identifier of the SL RS) as the one to represent the beam pair established/determined for the sidelink communications (e.g., comprising transmission and/or reception) between the first wireless device and the second wireless device. The determined beam pair between the first wireless device and the second wireless device may be represented by a SL SRI (e.g., comprising an indication/index/identifier of the SL RS). For example, the first wireless device and/or the second wireless device determine the SL SRI state (e.g., comprising an indication/index/identifier of the SL RS) as the one to represent the beam pair established/determined for the sidelink communications (e.g., comprising transmission and/or reception) between the first wireless device and the second wireless device.

In the example embodiment(s), the transmitter (e.g., transmitting) wireless device may be (e.g., may refer to) a device that transmits a data to another device via a sidelink, and/or the receiver (e.g., receiving) wireless may be (e.g., refer to) a device that receives a data from another device via a sidelink. A same device may become a transmitter wireless device and a receiver wireless device. For example, a first wireless device may transmit a data to a second wireless device as a transmitter wireless device and receive a data from the second wireless device (or from a third wireless device) as a receiver wireless device. For example, the transmitter wireless device and the receiver wireless device may be respectively the first wireless device and the second wireless device for the SL transmission that the first wireless device transmits to the second wireless device via the sidelink between a first wireless device and a second wireless device. For example, the transmitter wireless device and the receiver wireless device may be respectively the second wireless device and the first wireless device for the SL transmission that the second wireless device transmits to the first wireless device via the sidelink between a first wireless device and a second wireless device.

For example, the (e.g., initial) beam pairing procedure may comprise transmitting, by the first wireless device to the second wireless device, a plurality of SL RSs to select a beam (e.g., represented by one of the plurality of SL RSs) comprising a TX beam used by the first wireless device to transmit a sidelink transmission to the second wireless device and/or a RX beam used by the first wireless device to receive a sidelink transmission from the second wireless device. For example, the beam pairing procedure may comprise receiving, by the second wireless device from the first wireless device, the plurality of SL RSs to select a beam (e.g., represented by one of the plurality of SL RSs) comprising a TX beam used by the second wireless device to transmit a sidelink transmission to the second wireless device and/or a RX beam used by the second wireless device to receive a sidelink transmission from the first wireless device.

For example, the first wireless device may transmit the plurality of SL RSs using different (e.g., one or more) beams or using different (e.g., one or more) TX spatial filters. For example, each of the plurality of SL RSs is associated with a respective beam of the different beams or with a respective TX spatial filter of the different TX spatial filters. For example, each of the different beams is associated with a respective TX spatial filter of the different TX spatial filters. The second wireless device may determine measurement quantity(-ies) measured on the plurality of SL RSs and/or transmit, to the first wireless device, a message (e.g., SL RRC message and/or MAC CE) and/or a signal (e.g., SCI and/or PSFCH) comprising a measurement report (e.g., SL measurement report, SL CSI report). The measurement report may comprise one or more of the measurement quantity(-ies) of the plurality of SL RSs and/or one or more preferred/selected beam (or a SL RS of the plurality of SL RSs). The first wireless device may select or determine, based on the measurement quantity(-ies) and/or the one or more preferred/selected beam, its TX beam (e.g., TX spatial filter) and/or RX beam (e.g., RX spatial filter), that are associated with one of the plurality of SL RSs, for a sidelink communication (e.g., transmitting and/or receiving) with the second wireless device. The second wireless device may select or determine, based on the measurement quantity(-ies) and/or the one or more preferred/selected beam, its TX beam (e.g., TX spatial filter) and/or RX beam (e.g., RX spatial filter), that are associated with one of the plurality of SL RSs, for a sidelink communication (e.g., transmitting and/or receiving) with the first wireless device.

For example, the beam pairing procedure may comprise transmitting, by the first wireless device to the second wireless device, a SL RS via (e.g., across) multiple symbols or slots for the second wireless device to sweep RX beams of the second wireless device to select a beam used by the second wireless device. The selected beam may comprise a TX beam (e.g., TX spatial filter) of the second wireless device to transmit a sidelink transmission to the first wireless device and/or comprise a RX beam (e.g., RX spatial filter) of the second wireless device to receive a sidelink transmission from the first wireless device. For example, the first wireless device may transmit a SL RS using a same beam or using a same TX spatial filter of the first wireless device via (e.g., across) multiple symbols or slots. The SL RS may be associated with (e.g., may correspond to) a preferred TX beam (of the first wireless device) or RX beam (of the first wireless device) that the first wireless device selects for transmitting a sidelink transmission to the second wireless device or for receiving a sidelink transmission from the second wireless device. While the first wireless device transmits the (e.g., same) SL RS via the multiple symbols or multiple slots, the second wireless device may receive the SL RS using different RX beams and/or different RX spatial filter (e.g., may perform a RX beam sweeping) of the second wireless device. For example, the second wireless device may receive the SL RS using a first RX beam via a first time instance (e.g., a first symbol of the multiple symbols or a first slot of the multiple slots), receive the SL RS using a second RX beam via a second time instance (e.g., a second symbol of the multiple symbols or a second slot of the multiple slots), receive the SL RS using a third RX beam via a third time instance (e.g., a third symbol of the multiple symbols or a third slot of the multiple slots), and so on. For example, the second wireless device may determine measurement quantity(-ies) measured on the SL RS per each of RX beams and select one of the RX beams as the one to be used to transmit a sidelink transmission to the first wireless device and/or to receive a sidelink transmission from the first wireless device. The second wireless device may determine a TX beam based on a beam correspondence. For example, the second wireless device may multiple pairs or mapping between one or more TX beams and one or more RX beams. For example, if the second wireless device supports the beam correspondence, the TX beam selected based on the selected RX beam may be a pair of the RX beam in the multiple pairs.

The beam pairing procedure may occur before the first wireless device and the second wireless device establish a unicast link (e.g., before DCR signaling, before DCA signaling, and/or before a unicast link establishment procedure). The beam pairing procedure may occur while the first wireless device and the second wireless device establishing a unicast link (e.g., between DCR and DCA signaling (e.g., including DCR signaling and/or DCA signaling) and/or during a unicast link establishment procedure). The beam pairing procedure may occur after the first wireless device and the second wireless device complete to establish a unicast link (e.g., after DCR signaling, after DCA signaling, and/or after completing a unicast link establishment procedure). The beam pairing procedure may comprise transmitting, by the first wireless device to the second wireless device, SL configuration parameters.

For example, the beam pairing procedure may comprise selecting or determining, by a first wireless device, SL RS(s) (e.g., type of SL RS(s). The selected or determined SL RS(s) may comprise S-SSB, standalone SL RS (e.g., SL CSI-RS), non-standalone SL RS (e.g., SL CSI-RS), PSCCH DM-RS, and/or PSSCH DM-RS. As described in the present disclosure, the standalone SL RS transmission of SL RS(s) may refer to at least no accompanying sidelink data (e.g., SL MAC SDU and/or SL-SCH) transmission(s) in the same slot where the transmission of SL RS(s) occurs. The standalone SL RS transmission may accompany SCI(s), SL MAC CE transmissions, or PSFCH. The SL RS(s) may be the RSs that are sent aperiodically, periodically and/or semi-persistent with activation and deactivation.

For example, the beam pairing procedure may comprise determining, by a second wireless device, a transmit beam (e.g., TX spatial filter) of the wireless device and/or a receive beam (e.g., RX spatial filter) of the second wireless device as a beam pair, e.g., with the RSRP measurement satisfying certain condition(s). For example, the second wireless device may receive (e.g., from the first wireless device and/or a base station) or transmit (e.g., to the first wireless device) a RSRP threshold value for determining the transmit beam of the wireless device and/or a receive beam of the second wireless device. For example, the second wireless device may measure and/or determine a RSRP value (e.g., measurement quantity) of each of at least one of the plurality of SL RSs received from the first wireless device). The second wireless device may determine and/or select a first SL RS of the plurality of SL RSs, e.g., if a first RSRP value of the first SL RS is larger than (e.g., is higher than, exceeds, is above) the RSRP threshold value. For example, if RSRP values of multiple SL RSs of the plurality of SL RSs are larger than (e.g., is higher than, exceeds, is above) the RSRP threshold value, the second wireless device may select the first SL RS from the multiple SL RSs of the plurality of SL RSs. For example, the second wireless device may select the first SL RS randomly from the multiple SL RSs. For example, the second wireless device may select the first SL RS, from the multiple SL RSs if the RSRP value of the first SL RS is the highest RSRP values among the RSRP values. The second wireless device may determine a receive beam (e.g., RX spatial filter), that used for receiving the first SL RS, as a receive beam for the beam pair with the first SL RS for a unicast link with the first wireless device. The second wireless device may determine a transmit beam as the one corresponding to determined receive beam of the second wireless device, e.g., at least if the second wireless device supports a beam correspondence, for the beam pair with the first SL RS for a unicast link with the first wireless device.

For example, the beam pairing procedure may comprise reporting and/or transmitting, by a second wireless device, a sidelink signal (e.g., SCI, PSFCH, SL MAC CE, SL RRC message, DCR, and/or DCA) comprising and/or indicating beam information such as a beam report and/or a beam indication. The beam report and/or the beam indication may comprise at least one or more fields whose values (e.g., identifier of the first SL RS) indicates the first SL RS. The at least one or more fields whose values indicating the first SL RS in the beam report and/or the beam indication received in response to or after transmitting the plurality of SL RSs may indicate: that the second wireless device selects and/or determines the first SL RS; that the second wireless device selects and/or determines a receive beam of the second wireless device used for receiving the first SL RS; that the second wireless device selects and/or determines a beam pair associated with the first SL RS; that the second wireless device informs, notifies, and/or requests to the first wireless device to use a transmit beam (e.g., TX spatial filter) of the first wireless device, that is used for transmitting the first SL RS, when transmitting a SL signal (e.g., PSCCH, PSFCH, and/or PSSCH) to the second wireless device; and/or that the second wireless device informs, notifies, and/or requests to the first wireless device to use a receive beam (e.g., RX spatial filter) of the first wireless device, that is corresponding to the transmit beam (e.g., TX spatial filter) of the wireless device used for transmitting the first SL RS, when receiving a SL signal (e.g., PSCCH, PSFCH, and/or PSSCH) from the second wireless device.

In an example, the sidelink signal (e.g., SCI, PSFCH, SL MAC CE, SL RRC message, DCR, and/or DCA) comprising and/or indicating beam information, transmitted by the second wireless device to the first wireless device, may further comprise one or more second fields. The values of the one or more second fields may indicate measurement quantity (e.g., RSRP value) the first SL RS. The sidelink signal may further comprise one or more third fields whose values indicate at least one of: an identifier (e.g., SL TCI, beam identifier and/or beam pair identifier) that is associated with the first SL RS, a transmit beam (e.g., TX spatial filter) of the first wireless device, a receive beam (e.g., RX spatial filter) of the first wireless device, a transmit beam (e.g., TX spatial filter) of the second wireless device, a receive beam (e.g., RX spatial filter) of the second wireless device. The values of the one or more third fields may indicate the identifier (e.g., the second wireless device assigns, selects, or determines) of a beam pair between the first wireless device and the second wireless device.

For example, the beam indication, in the sidelink signal (e.g., SCI, PSFCH, SL MAC CE, SL RRC message, DCR, and/or DCA) transmitted by the second wireless device to the first wireless device (e.g., for the beam paring procedure), may be referred to as a candidate SL beam (e.g., candidate SL RS and/or candidate SL TCI), a preferred SL beam (e.g., preferred SL RS and/or preferred SL TCI), a selected SL beam (e.g., selected SL RS and/or selected SL TCI), and/or the like.

For example, the beam pairing procedure may comprise determining, by the first wireless device, a transmit beam (e.g., TX spatial filter) of the first wireless device, for a sidelink transmission (e.g., PSCCH, PSFCH, and/or PSSCH) to the second wireless device. For example, the beam pairing procedure may comprise determining, by the first wireless device, a receive beam (e.g., RX spatial filter) of the first wireless device, for a sidelink reception (e.g., PSCCH, PSFCH, and/or PSSCH) from the second wireless device.

The beam management (e.g., maintenance) procedure may comprise transmission(s) (e.g., by a first wireless device) of one or more SL RSs, a transmission(s) (e.g., by a second wireless device and/or to the first wireless device) of measurement report(s) comprising measurement quantity(-ies) of one or more of the one or more SL RSs, and/or determining (e.g., by the first wireless device and/or by the second wireless device) whether to maintain a current TX beam (and/or a current RX beam) or switch from a current TX beam (and/or a current RX beam) a new TX beam. For example, the beam management may comprise sidelink radio link monitoring performed by the second wireless device. For example, the beam management and/or the sidelink radio link monitoring may comprise transmitting, by a first wireless device to a second wireless device, one or more SL RSs using one or more TX beams of the first wireless device. For example, the beam management and/or the sidelink radio link monitoring may comprise receiving, by the second wireless device from the first wireless device, the one or more SL RSs using one or more RX beams of the second wireless device. The beam management and/or the sidelink radio link monitoring may comprise determining, by the second wireless device, measurement quantity(-ies) of one or more of the one or more SL RSs. The beam management and/or the sidelink radio link monitoring may comprise transmitting, by the second wireless device to the first wireless device, sidelink message and/or signal (e.g., SL RRC message, SL MAC CE, and/or SCI) comprising measurement report(s) that comprise measurement quantity(-ies) of one or more of the one or more SL RSs. The beam management and/or the sidelink radio link monitoring may comprise receiving, by the first wireless device from the second wireless device, sidelink message and/or signal (e.g., SL RRC message, SL MAC CE, and/or SCI) comprising measurement report(s) that comprise measurement quantity(-ies) of one or more of the one or more SL RSs. For example, the beam management and/or the sidelink radio link monitoring may comprise determining, by the first wireless device whether to maintain or switch a current TX beam (and/or a current RX beam). For example, the beam management and/or the sidelink radio link monitoring may comprise determining, by the first wireless device whether to maintain or switch a current TX beam (and/or a current RX beam).

For example, the beam management procedure may be for a sidelink radio link monitoring on a unicast link established between the first wireless device and the second wireless device. The first wireless device may transmit a message comprising configuration parameters indicating one or more SL RSs used for the sidelink radio link monitoring. The configuration parameters may comprise one or more parameters indicating a radio resource mapping of each of the one or more SL RSs to respective RE(s), one or more reporting quantities (e.g., L1-RSRP, CQI, RI, PMI, or the like) measured from each of the one or more SL RSs that the second wireless device receives and to be reported to the first wireless device, and/or the resource scheduling information (e.g., whether the SL RSs are periodic, aperiodic, or semi-persistent transmission). The second wireless device may determine measurement quantities according to the configuration parameters and transmit, to the first wireless device, a measurement report comprising one or more measurement quantities. The first wireless device and/or the second wireless device may switch their TX beam and/or RX beam used for the sidelink transmission between them to another TX beam and/or RX beam based on the measurement report.

Each of the one or more SL RSs may be a SL-SSB, a SL CSI-RS, a SL DM-RS, and/or the like. For example, the example embodiment(s) of the present disclosure may describe the beam management and/or the sidelink radio link monitoring in terms of SL CSI-RS as an example of SL RS when the SL RS is SL CSI-RS. The description using the SL CSI-RS in the present disclosure is exchangeable with an SL RS (e.g., SL-SSB and/or SL DM-RS).

A first wireless device (transmitter UE) may transmit a message (e.g., a sidelink RRC message, RRCReconfiguration Sidelink message, DCR, and/or DCA) to a second wireless device (receiver UE). The message may comprise configuration parameters of the one or more SL RSs. The message and/or the configuration parameters may indicate (e.g., configuring or reconfiguring) one or more parameters on sidelink measurement and reporting, indicate (e.g., configuring or reconfiguring) one or more SL RS resources (e.g., one or more SL CSI resources), and/or to indicate (e.g., configuring or reconfiguring) a SL RS (e.g., CSI) reporting latency bound. The first wireless device (transmitter UE) may initiate (trigger, perform, run, and/or apply) a sidelink RRC (re-)configuration procedure with a second wireless device (receiver UE). The first wireless device may transmit the message to a second wireless device (receiver UE), e.g., in response to or after initiating the sidelink RRC (re-)configuration procedure. For example, the sidelink RRC (re-)configuration procedure may be for a particular wireless device (e.g., second wireless device), a particular PC5-RRC connection and/or PC5 link (e.g., established between the first the wireless device and the second wireless device).

The message (e.g., a sidelink RRC message, RRCReconfiguration Sidelink message, DCR, and/or DCA) that the first wireless device transmits to the second wireless device may comprise SL RS configuration(s). The SL RS configuration(s) may comprise SL RS (e.g., SL CSI-RS) configuration parameters. The SL RS configuration parameters may comprise sl-LatencyBoundCSI-Report (e.g., sidelink latency bound of SL RS report). sl-LatencyBoundCSI-Report may indicate the SL RS (e.g., SL CSI-RS) reporting latency bound. The SL RS configuration parameters included in the message may comprise, for SL RS(s) (e.g., SL CSI-RS); transmission (and/or reception), a time resource allocation and/or time resource offset (e.g., sl-CSI-RS-FirstSymbol) indicating a first OFDM symbol in a PRB used for (e.g., a first OFDM symbol in a PRB that carries, if/when sidelink CSI reporting is triggered) transmitting SL RS(s) (e.g., SL CSI-RS); and/or a frequency resource allocation and/or frequency resource offset (e.g., sl-CSI-RS-FreqAllocation) indicating the number of antenna ports and the frequency domain allocation for (e.g., indicating frequency radio resource(s) that carries, if/when CSI reporting is triggered) SL RS(s) (e.g., SL CSI-RS). The time resource offset of the time resource offset indicates the time resource allocation) may start from a reference symbol in a slot where the wireless device receives SCI indicating a SL RS report. For example, the reference symbol may be a first symbol of the slot, a first symbol of PSCCH transmission in the slot, and/or a first symbol of PSSCH transmission in the slot. The frequency resource offset of the frequency resource allocation may start from a reference PRB (or RB or subchannel) in a slot where the wireless device receives the SCI indicating the SL RS report. For example, the reference PRB (or RB) may be a lowest PRB (or RB) of (e.g., carrying) the PSSCH transmission in a frequency domain. For example, the reference subchannel may be a lowest subchannel of (e.g., carrying) the PSSCH transmission in a frequency domain. For example, the reference PRB (or RB) may be a lowest PRB (or RB) of a lowest subchannel of (e.g., carrying) the PSSCH transmission in a frequency domain.

The first wireless device may transmit, to a second wireless device, one or more SL RSs (e.g., a plurality of SL RSs, and/or SL CSI-RSs) in a SL transmission via a SL slot. For example, the SL transmission further comprises at least one of: a first sidelink transmission via the slot and a second sidelink transmission via the slot. The first sidelink transmission may be a PSCCH transmission (e.g., PSCCH) that comprises a first SCI (e.g., first stage SCI as shown in FIG. 19). The second sidelink transmission may be a PSSCH transmission (e.g., PSSCH) that comprises a second SCI (e.g., second stage SCI as shown in FIG. 19) and/or SL-SCH (and/or SL MAC SDU) data (e.g., comprising MAC PDU, MAC SDU(s) and/or MAC CE(s) (e.g., as shown in FIG. 19). The SL transmission may comprise a SCI triggering the SL RS report (e.g., SL CSI report). For example, the SCI is at least one of the first SCI and/or the second SCI. For example, the SCI comprises a field (e.g., ‘CSI request’ field) with a field value (e.g., and/or an indicator) triggering (e.g., indicating a trigger of) a transmission of SL RS(s) (e.g., SL CSI-RS) to the second wireless device and/or triggering, to the second wireless device, a transmission of SL RS report (e.g., from the second wireless device to the first wireless device) indicating measurement result(s) of the SL RS(s) (e.g., SL CSI-RS(s)). The SL transmission (e.g., at least one of the first sidelink transmission or the first sidelink transmission) may be at least one of a unicast transmission, a groupcast transmission or a broadcast transmission.

For example, at least one of the first SCI (e.g., first stage SCI as shown in FIG. 19) and/or the second SCI (e.g., second stage SCI as shown in FIG. 19) may comprise a destination identifier. The destination identifier may be associated with a unicast PC5 link (e.g., ProSe and/or V2X application layer(s)/server(s) send the destination identifier to the first wireless device). The second wireless device may receive the sidelink transmission. The second wireless device may determine that the destination identifier in the sidelink transmission matches a destination identifier of the second wireless device. The second wireless device may determine that the field value of the field in the SCI indicates a trigger of (e.g., triggering) a transmission of the SL RS report (e.g., SL CSI report) from the second wireless device to the first wireless device, e.g., if the destination identifier in the sidelink transmission matches a destination identifier of the second wireless device. The second wireless device may determine to measure the SL RS(s) (e.g., SL CSI-RS) and/or transmit (e.g., may transmit) the SL RS report (comprising measurement result(s) of the SL RS(s) (e.g., SL CSI-RS(s))) to the first wireless device, e.g., if the destination identifier in the sidelink transmission matches a destination identifier of the second wireless device, and/or if the value of the field in the SCI indicates a trigger of (e.g., triggering) the SL RS report.

For example, the beam management procedure may comprise reporting and/or transmitting, by a second wireless device, a sidelink signal (e.g., SCI, PSFCH, SL MAC CE, SL RRC message, DCR, and/or DCA) comprising and/or indicating beam information such as the SL RS report (e.g., SL CSI report). The SL RS report (e.g., SL CSI report) may comprise a beam report and/or a beam indication. For example, the second wireless device may report and/or transmit, to the first wireless device, a sidelink signal after or in response to receiving one or more SL RSs (e.g., a plurality of SL RSs). The beam report and/or the beam indication may comprise at least one or more fields whose values (e.g., identifier of the first SL RS) indicates a first SL RS of a plurality of SL RSs. The at least one or more fields whose values indicating the first SL RS in the beam report and/or the beam indication may indicate: that the second wireless device selects and/or determines the first SL RS; that the second wireless device selects and/or determines a receive beam of the second wireless device used for receiving the first SL RS; that the second wireless device selects and/or determines a beam pair associated with the first SL RS; that the second wireless device informs, notifies, and/or requests to the first wireless device to use a transmit beam (e.g., TX spatial filter) of the first wireless device, that is used for transmitting the first SL RS, when transmitting a SL signal (e.g., PSCCH, PSFCH, and/or PSSCH) to the second wireless device; and/or that the second wireless device informs, notifies, and/or requests to the first wireless device to use a receive beam (e.g., RX spatial filter) of the first wireless device, that is corresponding to the transmit beam (e.g., TX spatial filter) of the wireless device used for transmitting the first SL RS, when receiving a SL signal (e.g., PSCCH, PSFCH, and/or PSSCH) from the second wireless device. For example, the at least one or more fields may be a candidate/preferred beam indication field for beam switching. For example, the at least one or more fields whose values indicating the first SL RS in the beam report and/or the beam indication may indicate to switch from a current beam to a new/preferred/candidate beam that is associated with the first SL RS (e.g., a first SL TCI associated with or indicating the first SL RS).

In an example, the sidelink signal (e.g., SCI, PSFCH, SL MAC CE, SL RRC message, DCR, and/or DCA) comprising and/or indicating beam information such as the beam report and/or the beam indication, transmitted by the second wireless device to the first wireless device, may further comprise one or more second fields. The values of the one or more second fields may indicate measurement quantity (e.g., RSRP value) the first SL RS. The sidelink signal may further comprise one or more third fields whose values indicate at least one of: an identifier (e.g., SL TCI, beam identifier and/or beam pair identifier) that is associated with the first SL RS, a transmit beam (e.g., TX spatial filter) of the first wireless device, a receive beam (e.g., RX spatial filter) of the first wireless device, a transmit beam (e.g., TX spatial filter) of the second wireless device, a receive beam (e.g., RX spatial filter) of the second wireless device. The values of the one or more third fields may indicate the identifier (e.g., the second wireless device assigns, selects, or determines) of a beam pair between the first wireless device and the second wireless device.

For example, the beam indication, in the sidelink signal (e.g., SCI, PSFCH, SL MAC CE, SL RRC message, DCR, and/or DCA) transmitted by the second wireless device to the first wireless device (e.g., for the beam paring procedure), may be referred to as a candidate SL beam (e.g., candidate SL RS and/or candidate SL TCI), a preferred SL beam (e.g., preferred SL RS and/or preferred SL TCI), a selected SL beam (e.g., selected SL RS and/or selected SL TCI), and/or the like.

In an example, the second wireless device may start a timer or a window (e.g., sl-CSI-ReportTimer), e.g., if (e.g., in response to and/or after) the second wireless device receives the SCI comprising the field with the value and/or determines to transmit (e.g., transmits) the SL RS report (e.g., SL CSI report). The first wireless device may start a second timer or a second window (e.g., sl-CSI-ReportTimer), e.g., if (e.g., in response to and/or after) the first wireless device transmits the SL RS(s) (e.g., SL CSI-RS) and/or the SCI indicating the trigger of the SL RS report. The second wireless device may transmit the SL RS report before the timer (and/or the second timer) expires and/or while the timer (and/or the second timer) is running. The SL latency bound may be a value for the timer. For example, the timer may run during a time duration indicated by the SL latency bound.

For example, the SL RS report (e.g., the SL CSI report) may comprise a MAC CE that includes SL CSI. For example, the MAC CE may be a Sidelink CSI Reporting MAC CE is identified by a MAC subheader with LCID (logical channel ID) predefined. A priority of the Sidelink CSI Reporting MAC CE is fixed to a predefined value (e.g., ‘1’ indicating a highest priority). The Sidelink CSI Reporting MAC CE may comprise at least one of CQI, RI, LI, CRI, PMI, L1-RSRP, or L1-SINR. An example format of the Sidelink CSI Reporting MAC CE may comprise at least one of RI and CQI. The RI may be a field indicating a derived value of the Rank Indicator for sidelink CSI reporting from the measurement results of the SL CSI-RS. The length of the RI field may be predefined (e.g., 1 bit). The CQI may be a field indicating a derived value of the Channel Quality Indicator for sidelink CSI reporting from the measurement results of the SL CSI-RS. The length of the CQI field may be predefined (e.g., 4 bits). The R may indicate one or more reserved bits, e.g., that are set to a predefined value (e.g., 0).

For example, the second wireless device may transmit, to the first wireless device, the SL RS report (e.g., SL CSI report) via a sidelink resource. The second wireless device may receive, from a base station, a grant indicating the sidelink resource, e.g., if the second wireless device is configured with a resource allocation mode 1. The second wireless device may determine a grant indicating the sidelink resource and/or select the sidelink resource (e.g., without communicating with a base station), e.g., according to the resource selection procedure of example embodiment(s) of the present disclosure and/or if the second wireless device is configured with a resource allocation mode 2.

For example, the second wireless device (e.g., configured with a resource allocation mode 1) receives, from a base station, a grant (e.g., SL grant (e.g., DCI 3_0)) indicating a sidelink resource that is used for transmission of the SL RS report (e.g., SL CSI report) to the first wireless device and/or that is located (e.g., occurs) within the SL latency bound that starts from a starting time of the timers. The second wireless device may receive, from a base station, the grant in response to or after transmitting a scheduling request to the base station. For example, the second wireless device may transmit, to the base station, a scheduling request to receive the grant (e.g., SL grant), e.g., if the second wireless device does not have an SL grant to transmit the SL RS report. The base station may transmit the grant (e.g., SL grant) to the second wireless device, e.g., in response to and/or after receiving the scheduling request from the second wireless device.

For example, the second wireless device, e.g., configured with a resource allocation mode 2, selects the sidelink resource, e.g., according to the example embodiments in the present disclosure (e.g., FIG. 26). The sidelink resource may be for transmission of the SL RS report to the first wireless device and/or that is located within the SL latency bound that starts from a starting time of the timers.

The second wireless device may transmit to the first wireless device, the SL RS report via the sidelink resource (indicated by the SL grant received from the base station or selected by the second wireless device), e.g., before the timer expires, while the timer is running, and/or within the latency bound that starts from a starting time of the timer. For example, if the timer runs for the time duration indicated by the latency bound, the second wireless device may determine that the timer expires. The second wireless device may cancel the triggered SL RS report (e.g., may cancel a transmission of the SL RS report), e.g., if (e.g., the second wireless device determines that) the timer expires and/or if the second wireless device does not transmitting the SL RS report before/until the timer expires, while the timer is running, and/or within the latency bound that starts from a starting time of the timer.

The SL beam failure detection/recovery procedure may enable beamformed sidelink unicast link to quickly and effectively re-form a broken communication link, e.g., without performing the (e.g., initial) beam pairing procedure that may be time consuming. For example, the SL beam failure detection/recovery procedure may comprise at least one of: determination of one or more SL beam failure instances (BFIs), a SL beam failure detection (BFD), a candidate beam identification, or a SL beam failure recovery (BFR).

A first wireless device may perform and/or trigger a SL beam failure detection and/or a SL beam failure recovery procedure. The SL beam failure detection and/or the SL beam failure recovery may comprise detecting and/or determining a SL beam failure based on one or more measurements (e.g., low RSRP and/or high number of DTXs on PSFCH reception). The SL beam failure detection and/or the SL beam failure recovery may comprise detecting, identifying, and/or determining a candidate beam (e.g., SL beam or SL RS) to which the first wireless device switches to recover the detected SL beam failure.

The SL beam failure detection and/or the SL beam failure recovery may be for one or more particular destinations (e.g., one or more second wireless devices). The SL beam failure detection and/or the SL beam failure recovery may be for (or on) a particular SL beam (e.g., SL TCI, SL RS, and/or SL SRI). For example, a wireless device may detect a SL beam failure on the particular SL beam (e.g., if an RSRP measurement of the particular SL beam is lower than a threshold value) according to the example embodiments of the present disclosure. The SL beam failure detection and/or the SL beam failure recovery may be for one or more particular SL connections (e.g., PC5-RRC connections) with one or more particular destinations (e.g., one or more second wireless devices). For example, a procedure that the first wireless device performs the SL beam failure detection and/or the SL beam failure recovery may be per destination, per PC5-RRC connection, per SL beam, and/or a combination thereof.

For example, a first wireless device may determine (e.g., detect and/or identify) a SL beam failure with (or for) a second wireless device (e.g., second destination) and/or on a second PC5-RRC connection established with the second wireless device. In response to determining the SL beam failure with (or for) the second wireless device and/or on the second PC5-RRC connection, the first wireless device may determine the sidelink beam failure with (or for) a third wireless device (e.g., third destination) and/or on a third PC5-RRC connection established with the third wireless device, e.g., if the first wireless device uses a same beam (e.g., SL RS) for transmission to and/or reception from the second wireless device and the third wireless device. In response to determining the sidelink beam failure with the second wireless device and/or on the second PC5-RRC connection, the first wireless device may not determine the sidelink beam failure with a third wireless device (e.g., third destination) and/or on a third PC5-RRC connection established with the third wireless device, e.g., if the sidelink beam (e.g., SL RS) that the first wireless device uses for transmission to and/or reception from the second wireless device is different from the one that the first wireless device uses for transmission to and/or reception from the third wireless device.

In example embodiment(s) of the present disclosure, a procedure that the first wireless device performs the SL beam failure detection and/or the SL beam failure recovery may be referred to as a SL beam detection procedure, a SL beam recovery procedure, a SL beam detection and/or recovery procedure, and/or the like.

The first wireless device may perform the SL beam detection and/or recovery procedure for a SL communication and/or perform a beam recovery procedure, a beam detection and/or recovery procedure for a DL and/or UL communication with a base station. The first wireless device may perform (e.g., be configured with) both the SL beam detection and/or recovery procedure and the beam detection and/or recovery procedure, e.g., if the first wireless device performs (be configured with) a beam management (e.g., comprising SL beam management for SL and/or beam management for Uu link) on SL, DL and/or UL communications. The first wireless device may perform (e.g., be configured with) either one of the SL beam detection and/or recovery procedure and the beam detection and/or recovery procedure on for SL and/or Uu link (DL and UL), whichever the beam management is configured. The first wireless device may perform (e.g., be configured with) none of the SL beam detection and/or recovery procedure and the beam detection and/or recovery procedure, e.g., if the first wireless device does not perform (is not configured with) a beam management on SL, DL and/or UL communications.

The SL BFD may be based on a measurement quantity of one or more first SL RSs. For example, a first wireless device may transmit, to a second wireless device, a message (e.g., SL RRC reconfiguration message) indicating the one or more first SL RSs, e.g., among a plurality of first SL RSs, as the ones for the SL BFD. The first wireless device may transmit to the second wireless device and/or after transmitting the message, the one or more first SL RSs one or more times. The second wireless device may determine a measurement quantity of the received one or more first SL RSs, e.g., for each time the first wireless device transmits the one or more first SL RSs.

A wireless device may determine a SL beam failure by counting a SL beam failure instance indication, e.g., from the lower layers of the wireless device to the MAC entity of the wireless device. For example, the SL BFD may refer to a determination and/or a trigger that the wireless device determines and/or detects a SL beam failure by counting a SL BFI indication. For example, the wireless device determines and/or detects a SL beam failure, e.g., if a SL BFI counter counting a number of SL BFI indications is equal to or greater than a SL BFD threshold value.

A SL BFI may be an event that a wireless device determines and/or triggers when a measured measurement quantity of one or more SL signals satisfies (e.g., is within a range of) event triggering condition(s) of the event. For example, the event may comprise (e.g., an occurrence of) a SL beam failure. For example, the event triggering condition(s) may comprise condition(s) to trigger, initiate, and/or perform a SL beam failure recovery procedure.

For example, the wireless device may determine and/or trigger the SL BFI (e.g., that SL BFI occurs, and/or that BF occurs), e.g., if a measurement quantity of one or more SL signals is within a range of event triggering condition of the event. For example, a range may comprise an RSRP value below (e.g., less than or smaller than) or equal to an RSRP threshold value. For example, the measurement quantity may be an RSRP of SL RS(s) (e.g., a (e.g., average) value of RSRPs of one or more SL RSs). For example, the wireless device may determine and/or trigger the SL BFI, e.g., if the RSRP of SL RS(s) is below (e.g., less than or smaller than) or equal to an RSRP threshold value (e.g., a BFD threshold value).

For example, the wireless device may determine and/or trigger the SL BFI (e.g., that SL BFI occurs, and/or that BF occurs), e.g., if the wireless device determines an absence of PSFCH reception (e.g., discontinuous transmission (DTX)) via a PSFCH transmission occasion (e.g., in which a peer wireless device of the wireless device transmits (or schedules to transmit) the PSFCH signal to the wireless device) one or more times. For example, a SL signal used by the wireless device for determining the measurement quantity may be a PSFCH signal. For example, a measurement quantity may be absence (e.g., whether to detect absence) of a PSFCH signal. For example, counting the absence of the PSFCH reception or PSFCH signal may comprise counting the absence of the PSFCH reception or PSFCH signal that comprises HARQ-ACK information (e.g., HARQ feedback). For example, counting the absence of the PSFCH reception or PSFCH signal may comprise counting the absence of the PSFCH reception or PSFCH signal that comprises conflict information (e.g., inter-UE coordination scheme 1) that indicates a (e.g., reserved) SL resource conflict.

For SL BFD and/or SL BFR procedures, a first wireless device may transmit at least one SL signal (e.g., comprising one or more SL RSs and/or one or more SL PSFCHs) to a second wireless device (e.g., the first wireless device and the second wireless device establish a sidelink unicast link). The second wireless device may determine BFD, e.g., if the second wireless device determines or detects that a SL BFI occurs or is triggered, e.g., consecutively, for N times (e.g., N≥1) within a time window (e.g., timer, sl-beam FailureDetection Timer). For example, the second wireless device may transmit to or receive from the first wireless device (or a base station) a parameter value indicating N. For example, the second wireless device may transmit to or receive from the first wireless device (or a base station) a parameter value indicating a size of the timer window (e.g., timer value of the timer).

In an example, the second wireless device may determine and/or trigger the BFD (e.g., that BFD occurs), e.g., if an event, that an RSRP of SL RS(s) (e.g., one or more of the one or more SL RSs) is below (e.g., less than or smaller than) or equal to an RSRP threshold value, occurs, e.g., consecutively, for N times (e.g., N≥1) within the time window. In an example, the second wireless device may determine and/or trigger the SL BFI (e.g., that SL BFI occurs, and/or that BF occurs), e.g., if an event, that the second wireless device determines absence of PSFCH reception via a PSFCH transmission occasion (e.g., in which the first wireless device transmits (or schedules to transmit) the PSFCH signal to the second wireless device), occurs, e.g., consecutively, for N times (e.g., N≥1) within the time window. In an example, the first wireless device may determine and/or trigger the SL BFI (e.g., that SL BFI occurs, and/or that BF occurs), e.g., if an event, that the first wireless device determines absence of PSFCH reception via a PSFCH transmission occasion (e.g., in which the second wireless device transmits (or schedules to transmit) the PSFCH signal to the first wireless device), occurs, e.g., consecutively, for N times (e.g., N≥1) within the time window.

A wireless device (e.g., the first wireless device or the second wireless device) that determines the BFD may trigger a SL BFR and/or transmit an indication to a peer wireless device. For example, the first wireless device may trigger a SL BFR and/or transmit an indication to the second wireless device, e.g., if the first wireless device determines the SL BFD according to example embodiments of present disclosure. For example, the second wireless device may trigger a SL BFR and/or transmit an indication to the first wireless device, e.g., if the second wireless device determines the SL BFD according to example embodiments of present disclosure. The indication may be referred to as a SL BFR request (BFRQ). For example, the wireless device may transmit a SCI (e.g., 1st stage SCI and/or 2^{nd} stage SCI) comprising the indication via a PSCCH (e.g., for 1st stage SCI) or a PSSCH (e.g., for 2^{nd} stage SCI). For example, the wireless device may transmit a SL MAC CE comprising the indication via a PSSCH. For example, the wireless device may transmit a beam information comprising and/or indicating the indication via a PSFCH.

The indication (e.g., BFRQ) that the wireless device transmits to the peer wireless device may comprise one or more fields. The one or more fields may comprise a first field whose value indicating the SL BFD. The one or more fields may comprise a second field whose value indicating an identifier of the SL beam or SL beam pair (e.g., SL RS and/or SL TCI indicating the SL beam or SL beam pair) for which (e.g., on which, where) the wireless device detects the SL BFD using the RSRP value(s) of one or more SL RS(s) associated with the SL beam or the SL beam pair. The one or more fields may comprise a second field whose value indicating an identifier of a candidate SL beam or a candidate SL beam pair (e.g., a candidate SL RS and/or SL TCI indicating the candidate SL beam or a candidate SL beam pair) that the wireless device determines or selects as a candidate SL beam to switch using the RSRP value(s) of one or more SL RS(s) associated with the candidate SL beam or the candidate SL beam pair.

The wireless device may perform a candidate SL beam identification procedure to determine a candidate SL beam or a candidate SL beam pair. In the example embodiments, a candidate SL beam or a candidate SL beam pair may be exchangeable with or indicate a candidate SL RS and/or a candidate SL TCI (or SL SRI) comprising/indicating the candidate SL RS, e.g., if the wireless device determines a candidate SL beam or a candidate SL beam pair is associated with an SL RS and/or SL TCI (or SL SRI) comprising/indicating an SL RS. For example, the wireless device determines a candidate SL beam or a candidate SL beam pair being associated with an SL RS and/or SL TCI (or SL SRI) comprising/indicating an SL RS, if the wireless device forms the candidate SL beam or the candidate SL beam pair using an TX antenna filter and/or RX antenna filter used for transmitting or receiving the SL RS and/or SL TCI.

The example description here is when the second wireless device performs the candidate SL beam identification procedure. The same procedure may be applicable to the first wireless device, e.g., by replacing the second wireless device and the first wireless device with the first wireless device and the second wireless device, respectively, for the case that the first wireless device performs the candidate SL beam identification procedure.

For example, the candidate beam identification may comprise: monitoring and/or receiving, by the second wireless device, one or more second SL RSs of a plurality of second SL RSs that the first wireless device transmits; and/or determining a candidate SL beam based on the one or more second SL RSs. For example, the first wireless device may transmit, to the second wireless device, a message (e.g., SL RRC reconfiguration message) indicating the one or more second SL RSs, e.g., among the plurality of second SL RSs, as the ones to monitor for the candidate SL beam identification. For example, the one more second SL RSs may be the plurality of second SL RSs. The second wireless device may determine a measurement quantity (e.g., RSRP) of each of the one or more second SL RSs. The second wireless device may determine a candidate beam (e.g., associated with and/or represented by an SL TCI, an SL SRI, an SL RS, an SL CSI RS) that is associated with a first SL RS of the one or more second SL RSs, e.g., if the measurement quantity (e.g., RSRP value) of the first SL RS of the one or more second SL RSs satisfies one or more second conditions (e.g., is higher than or equal to a RSRP threshold). The second wireless device may transmit a SL signal or SL message (e.g., SCI, MAC CE, PSFCH, and/or RRC message) comprising an identifier of the first SL RS and/or indicating the first SL RS, e.g., as a candidate beam or beam pair that the first wireless device and/or the second wireless device switch to. For example, the identifier of the first SL RS may be an identifier of SL TCI, SL SRI associated with (or linked to) the first SL RS.

The SL BFR procedure may be triggered when SL beam failure is detected and/or candidate SL beam(s) are identified. The SL beam failure recovery may comprise determining the BFD, determining a candidate SL beam(s), transmitting/receiving the SL BFRQ, and/or transmitting/receiving the SL BFR response (BFRR). A wireless device (e.g., the first wireless device and/or the second wireless device) that determines the SL BFD may trigger the SL BFR procedure. A wireless device (e.g., the first wireless device and/or the second wireless device) that transmits the SL BFRQ may trigger the SL BFR procedure. A wireless device (e.g., the first wireless device and/or the second wireless device) that receives the SL BFRQ may trigger the SL BFR procedure.

During the SL BFR procedure (e.g., while a SL BFR timer, sl-beamFailureRecoveryTimer, running), a wireless device may transmit to or receive from a peer wireless device a SL BFRQ. During the SL BFR procedure (e.g., while a SL BFR timer is running), a wireless device may transmit to or receive from a peer wireless device an indication comprising a first identifier of at least one first candidate SL beam. During the SL BFR procedure (e.g., while a SL BFR timer is running), a wireless device may transmit to or receive from a peer wireless device a SL BFRR, as a response to the SL BFRQ. The SL BFRR may comprise at least one field indicating an acknowledgement of the at least one first candidate SL beam as a new SL beam to be used for SL communication with the peer wireless device after the SL BFR procedure successfully completes. The SL BFRR may comprise at least one field indicating a second identifier of at least one second candidate SL beam as a new SL beam to be used for SL communication with the peer wireless device after the SL BFR procedure successfully completes. The first identifier may be the same as the second identifier. The at least one first candidate SL beam may be the same as the at least one second candidate SL beam.

For example, the wireless device may transmit the SL BFRR as a part of a SCI (e.g., 1st stage SCI and/or 2nd stage SCI) via a PSCCH (e.g., for 1st stage SCI) or a PSSCH (e.g., for 2nd stage SCI). For example, field value(s) of one or more fields in the SCI may correspond to, indicate, and/or be the SL BFRR. For example, the wireless device may transmit a SL MAC CE comprising the SL BFRR via a PSSCH. For example, the wireless device may transmit a beam information comprising and/or indicating the SL BFRR via a PSFCH.

A wireless device may start and/or run a SL BFR timer (e.g., sl-beamFailureRecoveryTimer) while the SL BFR procedure is ongoing. The SL BFR timer may indicate a time duration in which the wireless device communicates with a peer wireless device to successfully complete the SL BFR procedure and/or to switch to a new SL beam (e.g., a candidate SL beam). The wireless device may determine that the SL BFR procedure successfully completes, e.g., if the wireless device may transmit or receive a SL BFRR while the SL BFR timer is running and/or before the SL BFR timer expires. For example, the wireless device may start the SL BFR timer in response to triggering the SL BFR procedure and/or in response to determining the SL BFD. For example, the wireless device may start the BFR timer in response to transmitting or receiving a SL BFRQ. For example, the wireless device may stop the SL BFR timer, e.g., if the wireless device may transmit or receive a SL BFRR and/or if the wireless device determines that the SL BFR procedure successfully completes. The wireless device may release a SL unicast link established with the peer wireless device, e.g., if the SL BFR timer expires. The wireless device may determine a SL RLF on the SL unicast link established with the peer wireless device, e.g., if the SL BFR timer expires.

For example, the SL BFD and/or BFR procedure may comprise reporting and/or transmitting, by a second wireless device, a sidelink signal (e.g., SCI, PSFCH, SL MAC CE, SL RRC message, DCR, and/or DCA). For example, the sidelink signal may comprise and/or indicate beam information such as a SL RS report (e.g., SL CSI report). The SL RS report (e.g., SL CSI report) may comprise a beam report and/or a beam indication (e.g., a candidate beam). For example, the sidelink signal (e.g., SCI, PSFCH, SL MAC CE, SL RRC message, DCR, and/or DCA) may comprise and/or indicate beam information such as a BFRQ and/or BFRQ. For example, the second wireless device may transmit, to the first wireless device, the sidelink signal after or in response to receiving one or more SL RSs (e.g., a plurality of SL RSs). The sidelink signal, beam report, and/or the beam indication may comprise at least one or more fields whose values (e.g., identifier of the first SL RS) indicates a first SL RS of a plurality of SL RSs. The at least one or more fields whose values indicating the first SL RS in the sidelink signal, the beam report, and/or the beam indication may indicate: that the second wireless device selects and/or determines the first SL RS; that the second wireless device selects and/or determines a receive beam of the second wireless device used for receiving the first SL RS; that the second wireless device selects and/or determines a beam pair associated with the first SL RS; that the second wireless device informs, notifies, and/or requests to the first wireless device to use a transmit beam (e.g., TX spatial filter) of the first wireless device, that is used for transmitting the first SL RS, when transmitting a SL signal (e.g., PSCCH, PSFCH, and/or PSSCH) to the second wireless device; and/or that the second wireless device informs, notifies, and/or requests to the first wireless device to use a receive beam (e.g., RX spatial filter) of the first wireless device, that is corresponding to the transmit beam (e.g., TX spatial filter) of the wireless device used for transmitting the first SL RS, when receiving a SL signal (e.g., PSCCH, PSFCH, and/or PSSCH) from the second wireless device. For example, the at least one or more fields may be a candidate/preferred beam indication field for beam switching. For example, the at least one or more fields whose values indicating the first SL RS in the sidelink signal, the beam report, and/or the beam indication may indicate to switch from a current beam to a new/preferred/candidate beam that is associated with the first SL RS (e.g., a first SL TCI associated with or indicating the first SL RS).

In an example, the sidelink signal (e.g., SCI, PSFCH, SL MAC CE, SL RRC message, DCR, and/or DCA) comprising and/or indicating beam information, transmitted by the second wireless device to the first wireless device, may further comprise one or more second fields. The values of the one or more second fields may indicate measurement quantity (e.g., RSRP value) the first SL RS. The sidelink signal may further comprise one or more third fields whose values indicate at least one of: an identifier (e.g., SL TCI, beam identifier and/or beam pair identifier) that is associated with the first SL RS, a transmit beam (e.g., TX spatial filter) of the first wireless device, a receive beam (e.g., RX spatial filter) of the first wireless device, a transmit beam (e.g., TX spatial filter) of the second wireless device, a receive beam (e.g., RX spatial filter) of the second wireless device. The values of the one or more third fields may indicate the identifier (e.g., the second wireless device assigns, selects, or determines) of a beam pair between the first wireless device and the second wireless device.

In an example, the sidelink signal (e.g., SCI, PSFCH, SL MAC CE, SL RRC message, DCR, and/or DCA) comprising and/or indicating beam information, transmitted by the second wireless device to the first wireless device, may comprise a BFRQ, a BFRR, an indication of a BFRQ (e.g., the indication indicating the sidelink signal comprising the BFRQ), and/or an indication of a BFRR (e.g., the indication indicating the sidelink signal comprising the BFRR).

For example, the beam indication, in the sidelink signal (e.g., SCI, PSFCH, SL MAC CE, SL RRC message, DCR, and/or DCA) transmitted by the second wireless device to the first wireless device (e.g., for the beam paring procedure), may be referred to as a candidate SL beam (e.g., candidate SL RS and/or candidate SL TCI), a preferred SL beam (e.g., preferred SL RS and/or preferred SL TCI), a selected SL beam (e.g., selected SL RS and/or selected SL TCI), and/or the like.

A wireless device may have one or more scheduled PSFCH transmission, e.g., for HARQ-ACK information and/or conflict information. For example, the wireless device may be with N_{sch,Tx,PSFCH} scheduled PSFCH transmissions, e.g., for HARQ-ACK information and conflict information. The wireless device may be capable of transmitting a maximum of N_{max,PSFCH} PSFCHs. For example, the wireless device may transmit, to a base station and/or a peer wireless device, a sidelink capability information comprising capability parameter(s) indicating that the wireless device is capable of or supporting transmitting a maximum of N_{max,PSFCH} PSFCHs.

For example, in the example embodiment(s) of the present disclosure, N_{sch,Tx,PSPCH} may refer to a (e.g., total) number or quantity of PSFCH transmissions, (each of the PSFCH transmissions may comprise HARQ-ACK information or conflict information) scheduled in a (e.g., same) PSFCH transmission occasion. N_{max,PSFCH} may refer to a (e.g., maximum) number or quantity of PSFCH transmissions that the wireless device transmits simultaneously in a (e.g., same) PSFCH transmission occasion. N_{Tx,PSFCH} may refer to a (e.g., total) number or quantity of simultaneous PSFCH transmissions that the wireless device (e.g., determines to transmit) transmits simultaneously in a (e.g., same) PSFCH transmission occasion. For example, N_{Tx,PSFCH}≤N_{sch,Tx,PSFCH}. For example, N_{Tx,PSFCH}≤N_{max,PSFCH}.

The wireless device may determine a number N_{Tx,PSECH} of simultaneous PSFCH transmissions and a power P_{PSFCH,k}(i) for a PSFCH transmission k, 1≤k≤N_{Tx,PSFCH}, on one or more (e.g., all) resource pools in PSFCH transmission occasion i on active SL BWP b of carrier f as P_{PSFCH,k}(i)=P_{CMAX}−10 log₁₀(N_{Tx,PSFCH}) [dBm], e.g., if the wireless device does not receive, from a base station and/or a peer wireless device, configuration parameter(s) indicating dl-P0-PSFCH. For example, the wireless device may (e.g., autonomously) determines N_{Tx,PSFCH} PSFCH transmissions with ascending order of corresponding (e.g., respective) priority field values as described in the example embodiment(s) of the present disclosure over the PSFCH transmissions with HARQ-ACK information, if any, and then with ascending order of priority value over the PSFCH transmissions with conflict information, if any, such that N_{Tx,PSFCH}≥1 and where PCMAX is determined for the N_{Tx,PSECH} PSFCH transmissions.

The wireless device may determine a number N_{Tx,PSECH} of simultaneous PSFCH transmissions and a power P_{PSFCH,k}(i) for a PSFCH transmission k, 1≤k≤N_{Tx,PSFCH}, on one or more (e.g., all) resource pools in PSFCH transmission occasion i on active SL BWP b of carrier f as P_{PSFCH,k}(i)=min (P_{CMAX}−10 log₁₀(N_{Tx,PSFCH}), P_{PSFCH,one}) [dBm], e.g., if the wireless device receives, from a base station and/or a peer wireless device, configuration parameter(s) indicating dl-P0-PSFCH.

For example, the wireless device may receive, from a base station and/or a peer wireless device, one or more message(s) comprising dl-P0-PSFCH. P_{O,PSECH} in the example embodiment(s) of the present disclosure may be a value of dl-P0-PSFCH, if using the parameter is supported by the wireless device and the parameter is provided. The one or more message(s) may comprise dl-Alpha-PSFCH. For example, α_{PSFCH} in the example embodiment(s) of the present disclosure may be a value of dl-Alpha-PSFCH, if provided; else, the wireless device may determine α_{PFSCH}=1.

In the example embodiment(s) of the present disclosure, PL referred in a PSFCH power control may be a pathloss value that the wireless device determines and/or calculates for the power control used to transmitting a PSFCH.

For example, PL referred in a PSFCH power control may be a pathloss estimate (e.g., downlink pathloss estimate) in dB. For example, PL=PL_{b,f,c}(q_{d}) that the wireless device determines and/or calculates using reference signal (RS) index q_{d} for the active BWP (e.g., active DL BWP) of carrier f of serving cell c. For example, PL=PL_{b,f,c}(q_{d})) when the active SL BWP b is on a serving cell c. For example, the RS resource for PL=PL_{b,f,c}(q_{d})) of the PSFCH power control may be the one that the wireless device uses for determining a power of a PUSCH transmission scheduled by a particular DCI format (e.g., DCI format 0_0) in serving cell c when the wireless device is configured to monitor PDCCH for detection of DCI format 0_0 in serving cell c. For example, the RS resource for PL=PL_{b,f,c}(q_{d})) of the PSFCH power control may be the one corresponding (e.g., respective) to the SS/PBCH block the wireless device uses to obtain a master information block (MIB) when the wireless device is not configured to monitor PDCCH for detection of DCI format 0_0 in serving cell c.

For example, the wireless device may determine that N_{sch,Tx,PSFCH}≤N_{max,PSFCH}. For example, in this case, the wireless device may determine that N_{Tx,PSFCH}=N_{sch,Tx,PSFCH} and/or P_{PSFCH,k}(i)=P_{PSFCH,one} [dBm], e.g., if N_{sch,Tx,PSFCH}≤N_{max,PSFCH} and/or if P_{PSFCH,one}+10 log₁₀(N_{sch,Tx,PSPCH})≤P_{CMAX}. For example, P_{CMAX} is a configured maximum UE output power, e.g., determined for N_{sch,Tx,PSFCH} PSFCH transmissions.

For example, for uplink carrier aggregation, the wireless device may be allowed to set its configured maximum output power P_{CMAX,c} for serving cell c and/or its total configured maximum output power PCMAX. The wireless device may determine P_{CMAX} using one or more power configuration parameters received, by the wireless device from a base station, and/or one or more power configuration parameters transmitted by the wireless device to the base station.

For example, if N_{sch,Tx,PSFCH}≤N_{max,PSFCH} and/or if P_{PSFCH,one}+10 log₁₀(N_{sch,Tx,PSFCH})>PCMAX, the wireless device may select (or determine) N_{Tx,PSFCH} PSFCH transmissions among N_{sch,Tx,PSFCH} PSFSCH transmissions. For example, if N_{sch,Tx,PSFCH}≤N_{max,PSFCH} and/or if P_{PSFCH,one}+10 log₁₀(N_{sch,Tx,PSFCH})>P_{CMAX}, the wireless device may (e.g., autonomously) select and/or determine N_{Tx,PSFCH} PSFCH transmissions first with ascending order of corresponding (e.g., respective) priority field values over the PSFCH transmissions with HARQ-ACK information, if any, and then with ascending order of priority value over the PSFCH transmissions with conflict information, if any, such that

$$\\ {N}_{Tx , PSFCH} \geq max ( 1 , {\sum }_{i = 1}^{K} {M}_{i} ) .$$

For example, the wireless device may determine a first priority field value of a first PSFCH transmission (of N_{Tx,PSECH} PSFCH transmissions and/or N_{sch,Tx,PSFCH} PSFCH transmissions) as a priority field value in an SCI (e.g., comprising 1st stage SCI and/or 2nd stage SCI) that the wireless device receives and/or that comprises a field, ‘HARQ feedback enabled/disabled indicator, set to enabled (e.g., associated with the first PSFCH transmission) to schedule and/or transmit the first PSFCH transmission by the wireless device. For example, Mᵢ, for 1≤i≥8, is a number of PSFCHs with priority value i for PSFCH with HARQ-ACK information and Mᵢ, for i>8, is a number of PSFCHs with priority value i−8 for PSFCH with conflict information and K is defined as: the largest value satisfying

$$\\ {P}_{PSFCH , one} + 10 {log}_{10} ( max ( 1 , {\sum }_{i = 1}^{K} {M}_{i} ) ) \leq {P}_{CMAX} ,$$

e.g., where P_{CMAX} is determined for transmission of all PSFCHs in

$$\\ {\sum }_{i = 1}^{K} {M}_{i} ,$$

if any; zero, otherwise. In this case, e.g., if N_{sch,Tx,PSFCH}≤N_{max,PSFCH} and/or if P_{PSFCH,one}+10 log₁₀(N_{sch,Tx,PSFCH})>P_{CMAX}, the wireless device may determine P_{PSFCH,k}(i)=min(P_{CMAX}−10 log₁₀(N_{Tx,PSFCH}), P_{PSFCH,one}) [dBm]. For example, P_{CMAX} is determined for the N_{Tx,PSFCH} PSFCH transmissions.

For example, a wireless device may (e.g., autonomously) select and/or determine N_{max,PSFCH} PSFCH transmissions with ascending order of corresponding (e.g., respective) priority field values, e.g., if the wireless device may determine that N_{sch,Tx,PSFCH}>N_{max,PSFCH}.

For example, if N_{sch,Tx,PSFCH}>N_{max,PSFCH}; and/or if P_{PSFCH,one}+10 log₁₀(N_{max,PSFCH})≤P_{CMAX}, the wireless device may determine N_{Tx,PSFCH}=N_{max,PSPCH} and P_{PSFCH,k}(i)=P_{PSFCH,one} [dBm]. For example, P_{CMAX} is determined for the N_{max,PSFCH} PSFCH transmissions.

For example, if N_{sch,Tx,PSFCH}>N_{max,PSFCH}; and/or if P_{PSFCH,one}+10 log₁₀(N_{max,PSFCH})>P_{CMAX}, the wireless device may (e.g., autonomously) determine and/or select N_{Tx,PSFCH} PSFCH transmissions in ascending order of corresponding (e.g., respective) priority field values over the PSFCH transmissions with HARQ-ACK information, if any, and then with ascending order of priority value over the PSFCH transmissions with conflict information, if any, such that

$$\\ {N}_{Tx , PSFCH} \geq max ( 1 , {\sum }_{i = 1}^{K} {M}_{i} ) .$$

For example, Mi, 1≤i≤8, is a number of PSFCHs with priority value i for PSFCH with HARQ-ACK information and Mi, i>8, is a number of PSFCHs with priority value i−8 for PSFCH with conflict information and K is defined as: the largest value satisfying

$$\\ {P}_{PSFCH , one} + 10 {log}_{10} ( max ( 1 , {\sum }_{i = 1}^{K} {M}_{i} ) ) \leq {P}_{CMAX}$$

where P_{CMAX} is determined for transmission of all PSFCHs in

$$\\ {\sum }_{i = 1}^{K} {M}_{i} ,$$

if any; zero, otherwise. In this case, P_{PSFCH,k}(i)=min(P_{CMAX}−10 log₁₀(N_{Tx,PSFCH}), P_{PSFCH,one}) [dBm]. For example, P_{CMAX} is determined for the N_{Tx,PSFCH} simultaneous PSFCH transmissions.

In an example, for resource pools configured with PSFCH resources overlapping in time, the wireless device may either expect not to be provided with dl-P0-PSFCH or dl-Alpha-PSFCH in any of the resource pools, or expects to be provided with the same values of dl-P0-PSFCH and the same values of di-Alpha-PSFCH for all the resource pools.

A wireless device may determine a power P_{PSFCH,k}(i) for a PSFCH transmission, e.g., in response to and/or after determining a prioritization of PSFCH transmission and/or reception.

For example, a wireless device determines an index of a PSFCH resource for a PSFCH transmission with HARQ-ACK information in response to a PSSCH reception or with conflict information corresponding to a reserved resource as

$$\\ ( {P}_{ID} + {M}_{ID} ) mod {R}_{PRB , CS}^{PSFCH} .$$

For example, P_{ID} is a physical layer source ID provided by SCI format 2-A/2-B/2-C scheduling the PSSCH reception, or by SCI format 2-A/2-B/2-C with corresponding (e.g., respective) SCI format 1-A reserving the resource from another UE to be provided with the conflict information. For example, for HARQ-ACK information, MID is the identity of the UE receiving the PSSCH as indicated by higher layers if the wireless device detects a SCI format 2-A with Cast type indicator field value of “01”; otherwise, MID is zero. For example, for conflict information, MID is zero.

As described in the example embodiment(s) of the present disclosure, a wireless device may receive or detect a conflict information via the PSFCH resource indexed with

$$\\ ( {P}_{ID} + {M}_{ID} ) mod {R}_{PRB , CS}^{PSFCH}$$

in a PSFCH occasion (e.g., M_{ID} is zero). For example, for PSFCH reception with conflict information, a priority value for the PSFCH is equal to the priority value determined by the corresponding (e.g., respective) SCI format 1-A for the conflicting resource. For example, the wireless device may determine, for PSFCH reception, a priority value for the PSFCH is equal to the priority value determined by the SCI (e.g., corresponding (e.g., respective) SCI format 1-A) that the wireless device transmits and indicates the reserved resource.

In the example embodiment(s) of the present disclosure, a wireless device that schedules to transmit and/or transmit (or schedules to receive and/or receives) a PSFCH signal via a PSFCH transmission occasion may determine a priority value of the transmission of the PSFCH signal via the PSFCH transmission occasion. For example, a first wireless device may schedule to transmit and/or may transmit, to one or more second wireless devices, one or more first PSFCH signals via a PSFCH occasion (e.g., simultaneous PSFCH transmissions vis the PSFCH occasion). The first wireless device may schedule to receive and/or may receive, from one or more third wireless device, one or more second PSFCH signals via the PSFCH occasion. If the first wireless device are not capable of simultaneous PSFCH transmissions and PSFCH receptions via the PSFCH occasion (e.g., does not support full-duplex and/or supports half-duplex), the first wireless device may determine whether to perform the transmissions of the one or more first PSFCH signals or to perform the reception of the one or more second PSFCH signals via the PSFCH occasion. The first wireless device may determine, whether to perform the transmissions or to perform the reception via the PSFCH occasion, based on a priority value of each of the one or more first PSFCH signals and the one or more second PSFCH signals.

For example, the PSFCH signal may comprise HARQ-ACK information (e.g., referred to as HARQ feedback information). For example, the PSFCH signal may comprise conflict information (e.g., referred to as inter-UE coordination information).

For example, for a PSFCH transmission with HARQ-ACK information, a priority value for the PSFCH comprising the HARQ-ACK information may be equal to the priority value indicated by an SCI (e.g., comprising 1st stage SCI and/or 2nd stage SCI) associated with the PSFCH. For example, the wireless device determines that an SCI (e.g., comprising 1st stage SCI and/or 2nd stage SCI) is associated with the PSFCH (or the SCI is associated with PSSCH), e.g., if the wireless device receives the SCI; if the SCI comprises scheduling information (e.g., time/frequency resource assignment) of the PSSCH (e.g., SL-SCH and/or the 2nd stage SCI); if the SCI (e.g., in the 1st stage SCI) comprises a priority value; and/or if the SCI (e.g., in the 2nd stage SCI) comprises a field, HARQ feedback enabled/disabled indicator, set to enabled for the wireless device to schedule to transmit and/or enabled to transmit the PSFCH comprising the HARQ-ACK information. In this case, the priority of the PSSCH is the same as the priority value indicated by the SCI. In this case, the priority of the PSFCH is the same as the priority value indicated by the SCI.

For example, for a PSFCH reception with HARQ-ACK information, a priority value for the PSFCH comprising the HARQ-ACK information may be equal to the priority value indicated by an SCI (e.g., comprising 1st stage SCI and/or 2nd stage SCI) associated with the PSFCH. For example, the wireless device determines that an SCI (e.g., comprising 1st stage SCI and/or 2nd stage SCI) is associated with the PSFCH (or the SCI is associated with PSSCH), e.g., if the wireless device transmits the SCI; if the SCI comprises scheduling information (e.g., time/frequency resource assignment) of the PSSCH (e.g., SL-SCH and/or the 2nd stage SCI); if the SCI (e.g., in the 1st stage SCI) comprises a priority value; and/or if the SCI (e.g., in the 2nd stage SCI) comprises a field, HARQ feedback enabled/disabled indicator, set to enabled for the wireless device to schedule to transmit and/or enabled to transmit, by a peer wireless device to the wireless device, the PSFCH comprising the HARQ-ACK information. In this case, the priority of the PSSCH is the same as the priority value indicated by the SCI. In this case, the priority of the PSFCH is the same as the priority value indicated by the SCI.

As described in the example embodiment(s) of the present disclosure, a wireless device may transmit conflict information in a PSFCH, e.g., if the wireless device receives or detect a first SCI (e.g., first SCI format 1-A) that includes a first priority value, p_1; if the first SCI indicates a first reserved resource for PSSCH transmission from a second wireless device; if the wireless device receives or detects a second SCI (e.g., second SCI format 1-A) that includes a second priority value, p_2<p_1; if the second SCI indicates a second reserved resource for PSSCH transmission from a third wireless device; and/or if the wireless device determines that the first reserved resource and second reserved resource overlap in time and frequency.

For example, for PSFCH transmission with conflict information, a priority value for the PSFCH is equal to the smallest priority value determined by the corresponding (e.g., respective) SCI(s) (e.g., SCI format(s) 1-A) for the conflicting resource(s). For example, the corresponding (e.g., respective) SCI(s) may comprise a first SCI and the second SCI (e.g., first SCI format 1-A and second SCI format 1-A): that the wireless device receives and/or detects; that includes a first priority value and the second priority value, respectively; that indicate the first reserved resource and the second reserved resource, respectively.

In an example, if a wireless device transmits (e.g., schedules to transmit and/or has) N_{sch,Tx,PSFCH} PSFCHs and receive N_{sch,Rx,PSFCH} PSFCHs and/or if transmissions of the N_{sch,Tx,PSFCH} PSFCHs overlap in time with receptions of the N_{sch,Rx,PSFCH} PSFCHs, the wireless device may transmit or receive (e.g., only) a set of PSFCHs corresponding to the smallest priority field value, as determined by a first set of SCI format 1-A and/or a second set of SCI format 1-A that are respectively associated with PSFCHs with HARQ-ACK information from the N_{sch,Tx,PSFCH} PSFCHs and PSFCHs with HARQ-ACK information from the N_{sch,Rx,PSFCH} PSFCHs when one or more of the PSFCHs provide HARQ-ACK information. For example, if none of the N_{sch,Tx,PSFCH} PSFCHs and none of the N_{sch,Rx,PSFCH} PSFCHs provide HARQ-ACK information, the UE transmits or receives only a set of PSFCHs corresponding to the smallest priority value of the first set of PSFCHs and the second set of PSFCHs that are respectively associated with the N_{sch,Tx,PSFCH} PSFCHs and the N_{sch,Rx,PSFCH} PSFCHs when the PSFCHs provide conflict information.

In an example, if a wireless device transmits (e.g., schedules to transmit and/or has) N_{sch,Tx,PSFCH} PSFCHs in a PSFCH transmission occasion, the wireless device may first transmits PSFCHs with HARQ-ACK information from N_{Tx,PSFCH} PSFCHs corresponding to the smallest priority field values from the N_{Tx,PSFCH} priority field values, if any. Subsequently, the wireless device may transmit remaining PSFCHs with conflict information corresponding to the smallest remaining priority field values from the N_{Tx,PSECH} priority field values, if any.

In an example, if a wireless device indicates, to a base station and/or peer wireless device(s), a capability to receive N_{Rx,PSECH} PSFCHs in a PSFCH reception occasion, the wireless device may first receive PSFCHs with HARQ-ACK information, if any, and subsequently may receive PSFCHs with conflict information, if any.

A first wireless device may have simultaneous PSFCH transmission and reception that are scheduled via a same PSFCH occasion. The simultaneous PSFCH transmission and reception may refer to the transmission(s), of one or more first PSFCHs (e.g., that a first wireless device schedules to transmit), that are overlap in time with reception(s) of one or more second PSFCHs (e.g., that the first wireless device schedules to receive). For example, simultaneous PSFCH transmission and reception may comprise or refer to a case in which the first wireless device has, schedules and/or transmits transmission(s) of one or more first PSFCHs (e.g., N_{sch,Tx,PSFCH} PSFCHs) scheduled via a PSFCH occasion where the first wireless device has, schedules and/or receives reception(s) of one or more second PSFCHs.

For example, the first wireless device have, schedule, and/or transmit transmission(s) of one or more first PSFCHs (e.g., N_{sch,Tx,PSFCH} PSFCHs) scheduled via a PSFCH occasion. Each of the one or more first PSFCHs may carry, be with, and/or comprise at least one of HARQ-ACK information, conflict information, and/or beam information, e.g., that are from the first wireless device to a particular destination (e.g., a second wireless device assigned with a particular destination identifier). The first wireless device may have, schedule, and/or receive reception(s) of one or more second PSFCHs (e.g., N_{sch,Rx,PSFCH} PSFCHs) scheduled via the PSFCH occasion (e.g., where the first wireless device have, schedule, and/or transmit the transmission(s) of the one or more first PSFCHs (e.g., N_{sch,Tx,PSFCH} PSFCHs). Each of the one or more second PSFCHs may carry, be with, and/or comprise at least one of HARQ-ACK information, conflict information, and/or beam information, e.g., that are from a particular source (e.g., a second wireless device assigned with a particular source identifier) to the first wireless device.

For example, the beam information of PSFCH (e.g., that is at least one of the one or more first PSFCHs and/or the one or more second PSFCHs) may be or comprise a sidelink signal. The sidelink signal may be the one that the first wireless device schedules to transmit (or transmits), via the PSFCH occasion, as or for PSFCH transmission. The sidelink signal may be the one that the first wireless device may schedule to receive (or receives), via the PSFCH occasion as or for PSFCH reception. For example, the transmission or the reception of the beam information may be for (e.g., as a part of) a SL beam pairing procedure, a SL beam management procedure, and/or a SL BFD and/or BFR procedure. For example, the sidelink signal may be PSFCH. For example, the sidelink signal may carry, comprise, and/or indicate beam information described in the example embodiment(s) of the present disclosure. For example, the beam information may comprise at least one of: at least one candidate SL beam (e.g., at least one candidate SL RS, and/or at least one candidate SL TCI), at least one SL beam report, at least one BFRQ, and/or at least one BRRR.

The PSFCH occasion may be a radio resource in time, frequency, and/or spatial (e.g., antenna port) domains. A wireless device may transmit a PSFCH via the PSFCH occasion. A wireless device may receive a PSFCH via the PSFCH. The same PSFCH occasion may be referred to as different terminologies, e.g., based on whether a wireless device performs, via the PSFCH occasion, PSFCH transmission or PSFCH reception. For example, if the first wireless device transmits the one or more first PSFCHs via the PSFCH occasion, the PSFCH occasion may be referred to as a PSFCH transmission occasion. If the first wireless device receives the one or more second PSFCHs via the PSFCH occasion, the PSFCH occasion may be referred to as a PSFCH reception occasion.

The first wireless device may not be capable of or may not support simultaneous transmission and reception via a same radio resource. For example, the first wireless device may determine whether to perform the transmission(s) (e.g., for transmitting at least one of the one or more first PSFCHs) via the PSFCH occasion or to perform the reception(s) (e.g., for receiving at least one of the one or more second PSFCHs) via the PSFCH occasion, e.g., if the transmission(s) of the one or more first PSFCHs overlap in time with reception(s) of the one or more second PSFCHs, if the first wireless device is capable of (e.g., supports) a half-duplex operation (e.g., if the first wireless device performs either transmission or reception at a same time), and/or if the first wireless device is not capable of (e.g., does not supports) a full-duplex operation (e.g., if the first wireless device performs simultaneous transmission and reception at a same time).

In an example, if the first wireless device may determine to perform the transmission(s) (e.g., for transmitting at least one of the one or more first PSFCHs) via the PSFCH occasion, the first wireless device does not (e.g., cannot) receive (e.g., does not perform the reception(s) of, skips to receive, and/or cancels to receive) the one or more second PSFCHs (e.g., any of the one or more second PSFCHs) via the PSFCH occasion. In an example, if the first wireless device may determine to perform the reception(s) (e.g., for receiving at least one of the one or more second PSFCHs) via the PSFCH occasion, the first wireless device does not (e.g., cannot) transmit (e.g., does not perform the transmission(s) of, skips to transmit, and/or cancels to transmit) the one or more first PSFCHs (e.g., any of the one or more first PSFCHs) via the PSFCH occasion.

In existing technologies, there is no prioritization rule, e.g., for the simultaneous PSFCH transmission and reception, to determine (and/or select) whether to perform the transmission(s) (e.g., for transmitting at least one of the one or more first PSFCHs) via the PSFCH occasion or to perform the reception(s) (e.g., for receiving at least one of the one or more second PSFCHs) via the PSFCH occasion, e.g., when at least one of the one or more first PSFCHs and the one or more second PSFCHs comprises a PSFCH comprising beam information.

The implementation of the existing technologies may result in inefficient use of sidelink radio resource and/or improper link management of a sidelink.

In an example, a first wireless device may transmit (e.g., may schedule to transmit) N_{sch,Tx,PSFCH} PSFCHs and may receive (e.g., may schedule to receive) N_{sch,Rx,PSFCH} PSFCHs. The transmissions of the N_{sch,Tx,PSFCH} PSFCHs may overlap in time with receptions of the N_{sch,Rx,PSFCH} PSFCHs. In an example, in this case, the first wireless device determines whether to perform the transmission(s) (e.g., for transmitting at least one of N_{sch,Tx,PSFCH} PSFCHs) via the PSFCH occasion or to perform the reception(s) (e.g., for receiving at least one of N_{sch,Rx,PSFCH} PSFCHs) via the PSFCH occasion. For example, the first wireless device determines whether to perform the transmission(s) or to perform the reception(s), e.g., if the transmission(s) of the one or more first PSFCHs overlap in time with reception(s) of the one or more second PSFCHs, if the first wireless device is capable of (e.g., supports) a half-duplex operation (e.g., if the first wireless device performs either transmission or reception at a same time), and/or if the first wireless device is not capable of (e.g., does not supports) a full-duplex operation (e.g., if the first wireless device performs simultaneous transmission and reception at a same time). For example, the first wireless device may either perform the transmission(s) via the PSFCH occasion or perform the reception(s) via the PSFCH occasion.

In existing technologies, the determination of whether to perform the transmission(s) via the PSFCH occasion or perform the reception(s) via the PSFCH occasion is based on one or more priority values corresponding to or associated with HARQ-ACK information or conflict information that are carried by one or more PSFCHs of N_{sch,Tx,PSFCH} PSFCHs and/or N_{sch,Rx,PSFCH} PSFCHs. In existing technologies, the first wireless device transmits or receives only a set of PSFCHs corresponding to the smallest priority field value, as determined by a first set of SCI format 1-A and/or a second set of SCI format 1-A that are respectively associated with PSFCHs with HARQ-ACK information from the N_{sch,Tx,PSFCH} PSFCHs and PSFCHs with HARQ-ACK information from the N_{sch,Rx,PSFCH} PSFCHs when one or more of the PSFCHs provide HARQ-ACK information. In existing technologies, for example, if none of the N_{sch,Tx,PSFCH} PSFCHs and none of the N_{sch,Rx,PSFCH} PSFCHs provide HARQ-ACK information, the first wireless device transmits or receives only a set of PSFCHs corresponding to the smallest priority value of the first set of PSFCHs and the second set of PSFCHs that are respectively associated with the N_{sch,Tx,PSFCH} PSFCHs and the N_{sch,Rx,PSFCH} PSFCHs when the PSFCHs provide conflict information.

A problem arises when at least one PSFCH of N_{sch,Tx,PSFCH} PSFCHs and the N_{sch,Rx,PSFCH} PSFCHs comprises beam information. For example, the beam information may contain information urgent/important related to sidelink link management and/or sidelink link recovery. For example, the beam information may comprise and/or indicate BFRQ and/or BFRR of the SL BFD and/or BFR procedure.

According to the existing technologies, the first wireless device may determine to transmit, via the PSFCH occasion, a set of (e.g., at least one of) PSFCHs among N_{sch,Tx,PSFCH} PSFCHs and/or not to receive, via the PSFCH occasion, a set of (e.g., all of) PSFCHs among N_{sch,Rx,PSFCH} PSFCHs, e.g., if N_{sch,Tx,PSFCH} PSFCHs comprises such a first PSFCH that comprises HARQ-ACK information associated with (or corresponding to) a smallest priority field value among one or more PSFCHS, of N_{sch,Tx,PSFCH} PSFCHs and N_{sch,Rx,PSFCH} PSFCHs, that have HARQ-ACK information. In this case, if N_{sch,Rx,PSFCH} PSFCHs comprise a PSFCH carrying and/or comprising beam information that indicates and/or comprises urgent/important information related to sidelink link management and/or sidelink link recovery that are associated with a particular wireless device (assigned with a destination identifier or source identifier), the first wireless device and/or the particular wireless device may not perform a proper sidelink link management and/or proper sidelink link recovery in time. This results in a radio link failure on a sidelink established with the particular destination.

According to the existing technologies, the first wireless device may determine to receive, via the PSFCH occasion, a set of (e.g., at least one of) PSFCHs among N_{sch,Rx,PSFCH} PSFCHs and/or not to transmit, via the PSFCH occasion, a set of (e.g., all of) PSFCHs among N_{sch,Tx,PSFCH} PSFCHs, e.g., if N_{sch,Rx,PSFCH} PSFCHs comprises such a second PSFCH that comprises HARQ-ACK information associated with (or corresponding to) a smallest priority field value among one or more PSFCHs, of N_{sch,Tx,PSFCH} PSFCHs and N_{sch,Rx,PSFCH} PSFCHs, that have HARQ-ACK information. In this case, if N_{sch,Tx,PSFCH} PSFCHs comprise a PSFCH carrying and/or comprising beam information that indicates and/or comprises urgent/important information related to sidelink link management and/or sidelink link recovery that are associated with a particular wireless device (assigned with a destination identifier or source identifier), the first wireless device and/or the particular wireless device may not perform a proper sidelink link management and/or proper sidelink link recovery in time. This results in a radio link failure on a sidelink established with the particular destination.

The existing technologies result in selecting and/or determining a sidelink communication mode (e.g., whether to perform the transmission(s) or the reception via a PSFCH occasion) not based on all information (e.g., comprising beam information) in N_{sch,Tx,PSFCH} PSFCHs and N_{sch,Rx,PSFCH} PSFCHs but based on partial information (e.g., HARQ-ACK information and/or conflict information only) in N_{sch,Tx,PSFCH} PSFCHs and N_{sch,Rx,PSFCH} PSFCHs. The existing technologies prevent the first wireless to properly perform sidelink beam operation (e.g., SL initial beam pairing procedure, SL beam management, and/or SL BFD/BFR procedure) in time.

Embodiments of the present disclosure are related to an approach for selecting and/or determining a sidelink communication mode (e.g., whether to perform the transmission(s) or the reception via a PSFCH occasion) based on beam information in N_{sch,Tx,PSFCH} PSFCHs and N_{sch,Rx,PSFCH} PSFCHs, e.g., not based on partial information (e.g., HARQ-ACK information and/or conflict information only) in N_{sch,Tx,PSFCH} PSFCHs and N_{sch,Rx,PSFCH} PSFCHs. For example, embodiments of the present disclosure are related to the first wireless device that determines whether to perform the transmission(s) of at least one of one or more first PSFCHs (e.g., N_{sch,Tx,PSPCH} PSFCHs) or to perform the reception(s) of at least one of one or more second PSFCHs (e.g., N_{sch,Rx,PSFCH} PSFCHs), e.g., if at least one of the one or more first PSFCHs and the one or more second PSFCHs comprises beam information, if the transmission(s) of the one or more first PSFCHs overlap in time with reception(s) of the one or more second PSFCHs, if the first wireless device is capable of (e.g., supports) a half-duplex operation (e.g., if the first wireless device performs either transmission or reception at a same time), and/or if the first wireless device is not capable of (e.g., does not supports) a full-duplex operation (e.g., if the first wireless device performs simultaneous transmission and reception at a same time). These and other features of the present disclosure are described further below.

In the present disclosure, a sidelink communication mode may comprise a sidelink transmission and/or sidelink reception. For example, if a wireless device does not support or is not capable of simultaneous transmission and reception via a sidelink radio resource, the wireless device may determine in which communication mode (e.g., either sidelink transmission or sidelink reception) the wireless device perform a sidelink communication via the sidelink radio resource. For example, in the present disclosure, selecting or determining either sidelink transmission or sidelink reception may refer to selecting or determining a communication mode, e.g., when the sidelink transmission overlaps in time with the sidelink reception.

In an example embodiment, a wireless device may determine a priority of PSFCH (or PSFCH transmission) comprising beam information. The priority of the PSFCH comprising the beam information may be predefined (e.g., as a highest priority) with a respective priority value (e.g., the smaller priority value indicates the higher priority). For example, the respective priority may be one of the priority values (e.g., one of integer numbers) within a priority range. For example, the priority range may be from 1 to 8. For example, a smallest priority value (e.g., priority value=1) indicates the highest priority, and a largest priority value (e.g., priority value=8) indicates the lowest priority. The priority of the PSFCH comprising the beam information may be based on (e.g., be equal to) a priority of sidelink transmission (e.g., SL RS transmission(s), PSSCH, SCI, MAC CE, DCR, DCA, and/or the like) that triggers or initiates the transmission of PSFCH or the reception of PSFCH. For example, a message (e.g., RRC message, MAC CE, and/or SCI) that triggers, initiates, schedule, and/or indicate the transmission of PSFCH or the reception of PSFCH comprise a priority field value indicating a priority value and/or a priority of the PSFCH. For example, the priority of the PSFCH comprising the beam information may be same as a priority of sidelink transmission (e.g., SL RS transmission(s), PSSCH, SCI, MAC CE, or the like) that triggers or initiates the transmission of the PSFCH.

In an example embodiment, a first wireless device may select and/or determine, using beam information of PSFCH, a sidelink communication mode (e.g., whether to perform the transmission(s) or the reception via a PSFCH occasion), e.g., if the first wireless device schedules or has simultaneous PSFCH transmission(s) and PSFCH reception(s) via a same PSFCH occasion. In an example embodiment, after or in response to selecting the sidelink communication mode, the first wireless device may either perform transmission(s) of at least one of one or more first PSFCHs scheduled via a PSFCH occasion or perform reception(s) of at least one of one or more second PSFCHs scheduled via the PSFCH occasion. The first wireless device may not perform, via the PSFCH occasion, both of the transmission(s) and the reception(s). The example embodiment of the present disclosure provide a proper communication mode (e.g., either transmission(s) or reception(s) that the first wireless device performs via the PSFCH occasion.

The first wireless device may determine and/or select which PSFCH(s) the first wireless device transmits via the PSFCH, e.g., if and/or after the first wireless device determines and/or selects to perform the transmission(s) of at least one of one or more first PSFCHs via the PSFCH occasion. For example, the first wireless device may determine or select which PSFCH(s) the first wireless device receives via the PSFCH, e.g., if and/or after the first wireless device determines and/or selects to perform the reception(s) of at least one of one or more second PSFCHs via the PSFCH occasion.

For example, the first wireless device may, to determine whether to perform the transmission(s) or the reception(s) via the PSFCH occasion, use priority value(s) associated with one or more first PSFCH(s) (e.g., scheduled to transmit via the PSFCH occasion) and one or more second PSFCH(s) (e.g., scheduled to receive via the PSFCH occasion). Once (e.g., or if) the first wireless device determines the sidelink communication mode, the first wireless device may, to select PSFCH(s) for which the first wireless device performs the determined sidelink communication mode via the PSFCH occasion, use priority value(s) associated with one or more PSFCH(s) corresponding to the determined sidelink communication mode. For example, if the first wireless device determines to perform the transmission(s) of at least one PSFCH of the one or more first PSFCH(s), the first wireless device may select, among the one or more first PSFCHs, the at least one PSFCH using priority values associated with the one or more first PSFCHs (e.g., and not using priority values associated with the one or more second PSFCHs). For example, if the first wireless device determines to perform the reception(s) of at least one PSFCH of the one or more second PSFCHs, the first wireless device may select, among the one or more second PSFCHs, the at least one PSFCH using priority values associated with the one or more second PSFCHs (e.g., and not using priority values associated with the one or more first PSFCHs).

Example embodiment(s) may provide one or more ways that the first wireless device selects and/or determines a communication mode with at least one information of HARQ-ACK information, conflict information and/or beam information. For example, example embodiment(s) may provide priorities among PSFCHs scheduled to transmit and/or receive via a PSFCH occasion. The priorities may comprise PSFCH group (or type) priorities.

For example, each of the PSFCHs may comprise at least one of HARQ-ACK information, conflict information and/or beam information. For example, each of the PSFCHs may be scheduled to transmit or receive via the PSFCH occasion. For example, the priorities may comprise PSFCH group (or type) priorities among a first PSFCH group comprising one or more PSFCHs comprising beam information, a second PSFCH group comprising one or more PSFCHs comprising HARQ-ACK information, and/or a third PSFCH group comprising one or more PSFCHs comprising conflict information.

For example, each of the PSFCHs may comprise beam information. For example, the priorities may comprise PSFCH group (or type) priorities among a first PSFCH group comprising one or more PSFCHs comprising beam information associated with SL initial beam pairing procedure, a second PSFCH group comprising one or more PSFCHs comprising beam information associated with SL beam management procedure, and/or a third PSFCH group comprising one or more PSFCHs comprising beam information associated with the SL BFD/BFR procedure.

For example, each of the PSFCHs may comprise beam information. For example, the priorities may comprise PSFCH group (or type) priorities among a first PSFCH group comprising one or more PSFCHs comprising beam information associated with periodic SL RS transmission(s) and/or reception, a second PSFCH group comprising one or more PSFCHs comprising beam information associated with aperiodic SL RS transmission(s) and/or reception, and/or a third PSFCH group comprising one or more PSFCHs comprising beam information associated with the semi-persistent SL RS transmission(s) and/or reception.

In example embodiment(s), the first wireless device may compare priority values within a same PSFCH group. The first wireless device may not compare priority values across different PSFCH groups. The first wireless device may determine a sidelink communication mode to perform via the PSFCH occasion as same as the sidelink communication mode of PSFCH having or associated with a smallest priority value among one or more PSFCHs withing the same PSFCH group. For example, if a PSFCH, having or associated with a smallest priority value among one or more PSFCHs withing the same PSFCH group, is the one that the first wireless device schedules to transmit via the PSFCH occasion, the first wireless device determine to perform transmission(s) via the PSFCH occasion. For example, if a PSFCH, having or associated with a smallest priority value among one or more PSFCHs withing the same PSFCH group, is the one that the first wireless device schedules to receive via the PSFCH occasion, the first wireless device determines to perform reception(s) via the PSFCH occasion.

For example, the first wireless device may compare priority values of one or more PSFCHs within a first PSFCH group having a highest group priority among multiple PSFCH groups. If a PSFCH associated with or having a smallest priority value among the one or more PSFCHs in the first PSFCH group and the PSFCH is the one that the first wireless device schedules to transmit via the PSFCH occasion, the first wireless device may determine to perform transmission(s) via the PSFCH occasion and not to perform reception(s) via the PSFCH occasion. If a PSFCH associated with or having a smallest priority value among the one or more PSFCHs in the first PSFCH group and the PSFCH is the one that the first wireless device schedules to receive via the PSFCH occasion, the first wireless device may determine not to perform transmission(s) via the PSFCH occasion and to perform reception(s) via the PSFCH occasion. If no PSFCH corresponding to the first PSFCH group has been scheduled to transmit or receive via the PSFCH occasion or if none of PSFCHs scheduled to transmit or receive via the PSFCH occasion are belonging to the first PSFCH group, the first wireless device may compare priority values of one or more PSFCHs within a second PSFCH group having a second highest group priority among multiple PSFCH groups. For example, if a PSFCH associated with or having a smallest priority value among the one or more PSFCHs in the second PSFCH group and the PSFCH is the one that the first wireless device schedules to transmit via the PSFCH occasion, the first wireless device may determine to perform transmission(s) via the PSFCH occasion and not to perform reception(s) via the PSFCH occasion. For example, if a PSFCH associated with or having a smallest priority value among the one or more PSFCHs in the second PSFCH group and the PSFCH is the one that the first wireless device schedules to receive via the PSFCH occasion, the first wireless device may determine not to perform transmission(s) via the PSFCH occasion and to perform reception(s) via the PSFCH occasion. If no PSFCH corresponding to the first PSFCH group and to the second PSFCH group has been scheduled to transmit or receive via the PSFCH occasion or if none of PSFCHs scheduled to transmit or receive via the PSFCH occasion are belonging to the first PSFCH group and/or the second PSFCH group, the first wireless device may compare priority values of one or more PSFCHs within a third PSFCH group having a third highest group priority among multiple PSFCH groups for determining the sidelink communication mode via the PSFCH occasion, and so on.

Example embodiments of the present disclosure provide enhancement for properly determining a sidelink communication mode (e.g., whether to perform sidelink transmission or sidelink reception) using beam information of a PSFCH when the PSFCH and the other PSFCH(s) are scheduled to transmit and/or receive in a same PSFCH occasion. Example embodiments of the present disclosure result in efficient use of sidelink radio resource and/or proper link management of a sidelink.

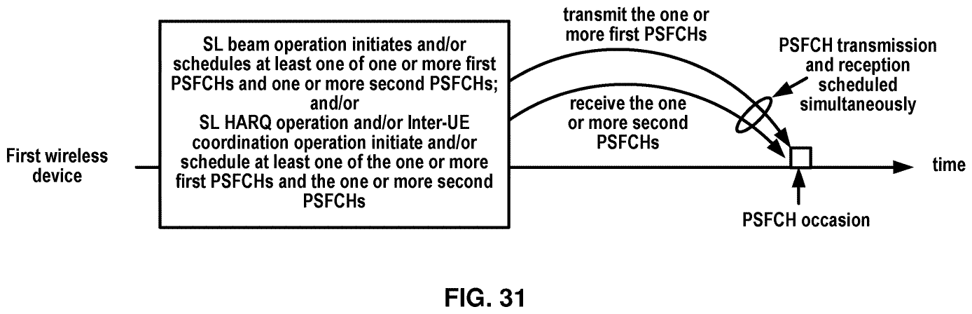

FIG. 31 illustrates an example of simultaneous PSFCH transmission and receptions per an aspect of an embodiment of the present disclosure. A first wireless device may communicate with one or more second wireless devices. The first wireless device may establish a PC5-RRC connection with at least one of the one or more second wireless devices. The first wireless device may establish a PC5-RRC connection with each of the one or more second wireless devices. The first wireless device may have PSFCH transmission and reception scheduled simultaneously via a PSFCH occasion.

Referring to FIG. 31, the first wireless device may perform SL beam operation(s) with at least one of one or more second wireless devices. The SL beam operation(s) may comprise (e.g., any) transmission(s) and/or (e.g., any) reception(s) in a (e.g., initial) beam paring procedure described in the example embodiment(s) of the present disclosure. The SL beam operation(s) may comprise (e.g., any) transmission(s) and/or (e.g., any) reception(s) in a beam management (e.g., maintenance) procedure described in the example embodiment(s) of the present disclosure. The SL beam operation(s) may comprise (e.g., any) transmission(s) and/or (e.g., any) reception(s) in a SL beam failure detection and/or recovery procedure described in the example embodiment(s) of the present disclosure. For example, while the first wireless device performs the SL beam operation(s), the SL beam operation(s) may initiate or trigger the first wireless device to (e.g., schedule to) transmit one or more first PSFCHs via a PSFCH occasion. For example, while the first wireless device performs the SL beam operation(s), the SL beam operation(s) may initiate or trigger the first wireless device to (e.g., schedule to) receive one or more second PSFCHs via the PSFCH occasion.

Referring to FIG. 31, at least one of the one or more first PSFCHs may comprise beam information described in the example embodiment(s) of the present disclosure. At least one of the one or more second PSFCHs may comprise beam information described in the example embodiment(s) of the present disclosure. For example, the beam information comprises a SL beam report, a SL beam indication, SL RS report, a BFRR, a BFRQ, and/or the like. Each of the one or more first PSFCHs and the one or more second PSFCHs may be for a respective wireless device of the one or more second wireless devices. For example, the first wireless device may (schedule to) transmit a PSFCH of the one or more first PSFCHs to a respective wireless device of the one or more second wireless devices. The respective wireless device of the one or more second wireless devices may be the one that the first wireless device performs the SL beam operation. For example, the first wireless device may (schedule to) receive a PSFCH of the one or more second PSFCHs from a respective wireless device of the one or more second wireless devices. The respective wireless device of the one or more second wireless devices may be the one that the first wireless device performs the SL beam operation.

Referring to FIG. 31, the first wireless device may perform SL HARQ operation and/or inter-UE coordination operation with at least one of the one or more second wireless devices. For example, the first wireless device may (e.g., schedule to) transmit or receive HARQ-ACK information via the PSFCH occasion. For example, the first wireless device may (e.g., schedule to) transmit or receive conflict information via the PSFCH occasion. For example, the SL HARQ operation and/or the inter-UE coordination operation (e.g., with/for at least one of the one or more second wireless devices) may trigger or initiate the first wireless device to (e.g., schedule to) transmit or receive at least one PSFCH, of the one or more first PSFCHs and the one or more second PSFCHs, that comprises HARQ-ACK information and/or conflict information.

Referring to FIG. 31, a first wireless device may have multiple PSFCHs that the first wireless device initiates and/or schedules to transmit and/or receive in a (e.g., same) PSFCH occasion (e.g., PSFCH occasion i). The multiple PSFCHs may comprise at least one of: a PSFCH comprising beam information, a PSFCH comprising HARQ-ACK information, and/or a PSFCH comprising conflict information. The first wireless device may have a limited capability in a number of simultaneous PSFCH transmission that the first wireless device performs via the PSFCH occasion (e.g., PSFCH transmission occasion). For example, the first wireless device may transmit, to a base station (e.g., cell or network) and/or a second wireless device, a control message (e.g., UE capability information, RRC message, MAC CE, UCI, and/or SCI) comprising and/or indicating N_{Max,PSFCH,Tx} (e.g., UE capability parameter). For example, N_{Max,PSFCH,Tx} indicates a maximum number of PSFCHs that the first wireless device simultaneously transmits via a PSFCH occasion. The first wireless device may have a limited capability in a number of simultaneous PSFCH reception that the first wireless device performs via a PSFCH occasion (e.g., PSFCH reception occasion). For example, the first wireless device may transmit, to a base station (e.g., cell or network) and/or a second wireless device, a control message (e.g., UE capability information, RRC message, MAC CE, UCI, and/or SCI) comprising and/or indicating N_{Max,PSFCH,Rx} (e.g., UE capability parameter). For example, N_{Max,PSFCH,Rx} indicates a maximum number of PSFCHs that the first wireless device simultaneously receives via a PSFCH occasion. N_{Max,PSFCH,Tx} may be equal to N_{Max,PSFCH,Rx}. N_{Max,PSFCH,Tx} may be different from N_{Max,PSFCH,Rx}. N_{Max,PSFCH,Tx} and N_{Max,PSFCH,Rx} may be separate two UE capability parameters of the first wireless device. A single UE capability parameter (e.g., N_{Max,PSFCH}) of the first wireless device may indicate N_{Max,PSFCH,Tx} and N_{Max,PSFCH,Rx} (e.g., N_{Max,PSFCH}=N_{Max,PSFCH},Tx and/or N_{Max,PSFCH}=N_{Max,PSFCH,Rx}).

Referring to FIG. 31, according to example embodiment(s) of the present disclosure, a first wireless device may select and/or transmit, among the one or more first PSFCHs (e.g., N_{sch,Tx,PSFCH} PSFCHs) scheduled in the PSFCH occasion, N_{Tx,PSFCH} (e.g., at least one) PSFCH(s) via the PSFCH occasion such that N_{Tx,PSFCH}≤N_{Max,PSFCH,Tx} Or N_{Tx,PSFCH}≤N_{Max,PSFCH}, e.g., if the first wireless device determine to perform transmission, between the transmission and reception, via the PSFCH occasion. For example, a first wireless device may select and/or receive, among the one or more second PSFCHs (e.g., N_{sch,Rx,PSFCH} PSFCHs) scheduled in the PSFCH occasion, N_{Rx,PSFCH} (e.g., at least one) PSFCH(s) via the PSFCH occasion such that N_{Rx,PSFCH}≤N_{Max,PSFCH,Rx} Or N_{Rx,PSFCH}≤N_{Max,PSFCH}, e.g., if the first wireless device determine to perform reception, between transmission and reception, via the PSFCH occasion.

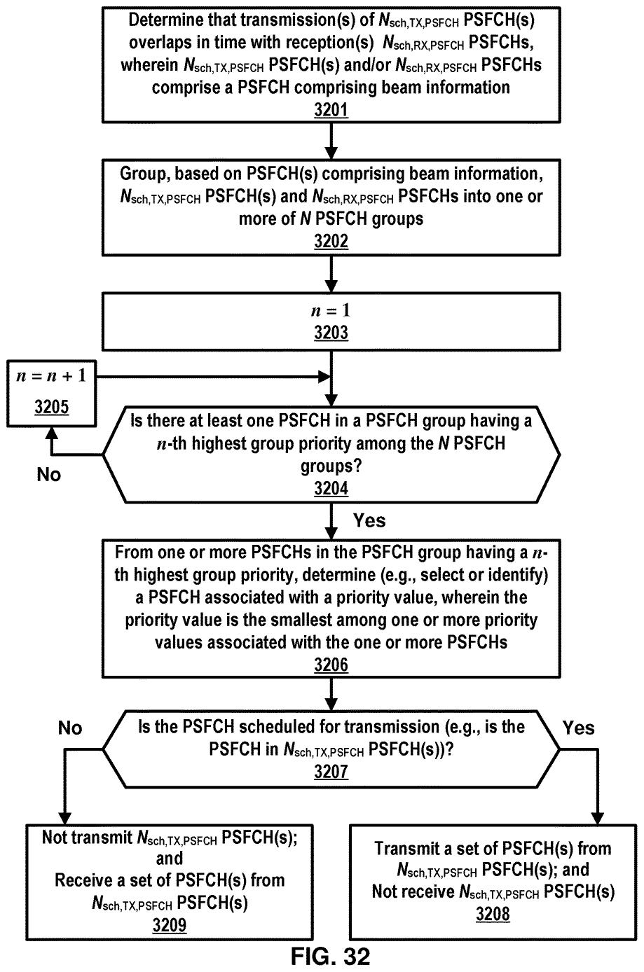

FIG. 32 illustrates an example of simultaneous PSFCH transmission and receptions per an aspect of an embodiment of the present disclosure. FIG. 32 may refer to FIG. 31.

Referring to FIG. 32, a first wireless device may schedule to transmit N_{sch,TX,PSFCH} PSFCHs via a PSFCH occasion and/or may schedule to receive N_{sch,RX,PSFCH} PSFCHs via the PSFCH occasion (e.g., at 3201 in FIG. 32). The transmission of the N_{sch,TX,PSFCH} PSFCHs may overlap in time with reception of N_{sch,RX,PSFCH} PSFCHs (e.g., at 3201 in FIG. 32). The first wireless device may not be capable of PSFCHs) and reception (e.g., receiving at transmission (e.g., transmitting at least one of N_{sch,TX,PSFCH} least one of N_{sch,TX,PSFCH} PSFCHs) simultaneously via the PSFCH occasion. The first wireless device may determine a sidelink communication mode in the PSFCH occasion. For example, the first wireless device determine whether to perform the transmission (e.g., transmitting at least one of N_{sch,TX,PSFCH} PSFCHs) or to perform the reception (e.g., receiving at least one of N_{sch,TX,PSFCH} PSFCHs) via the PSFCH occasion. The first wireless device may have a group prioritization rule (e.g., a group priority order) to determine the sidelink communication mode.

Referring to FIG. 32, a first wireless device may determine a group prioritization rule (e.g., a group priority order) between PSFCH groups in determining whether to perform transmission or reception via a PSFCH occasion (e.g., at 3202 in FIG. 32). At least one PSFCH group of the PSFCH groups may comprise a PSFCH comprising beam information. For example, the group prioritization rule to determining whether to perform transmission or reception via a PSFCH occasion may be a group-based prioritization, e.g., when at least one PSFCH comprising beam information is scheduled to transmit and/or receive via the PSFCH occasion where (e.g., via which) a PSFCH comprising HARQ-ACK information or conflict information is scheduled to transmit or receive.

Referring to FIG. 32, the first wireless device may group N_{sch,TX,PSFCH} PSFCHs and N_{sch,RX,PSFCH} PSFCHs into one or more of N (e.g., N≥1) PSFCH groups (e.g., at 3202 in FIG. 32). N PSFCH groups may be predefined, e.g., in a system specification, and/or may be hard-coded into the first wireless device. N PSFCH groups may be configurable, e.g., the first wireless device may receive one or more configuration parameters indicating N PSFCH groups. The first wireless device may determine that each of N_{sch,TX,PSFCH} PSFCHs and N_{sch,RX,PSFCH} PSFCHs belongs to which PSFCH groups of N PSFCH groups. For example, each of N_{sch,TX,PSFCH} PSFCHs and N_{sch,RX,PSFCH} PSFCHs that is grouped into one of the multiple PSFCH groups may be a PSFCH that the first wireless device (e.g., schedules to transmit or receive) transmits or receive via the PSFCH occasion. For example, if none of N_{sch,TX,PSFCH} PSFCHs and N_{sch,RX,PSFCH} PSFCHs belongs to a PSFCH group of N PSFCH groups, the corresponding PSFCH group may be a empty set or group.

Referring to FIG. 32, for example, N PSFCH groups comprise at least one PSFCH group (e.g., denoted by a x-th PSFCH group, x≤N) that comprises (e.g., only comprises) first PSFCH(s). At least one of the first PSFCH(s) may comprise beam information. Each of the first PSFCH(s) may comprise with beam information. For example, N PSFCH groups comprises at least one PSFCH group (e.g., denoted by a y-th PSFCH group, y≤N) that comprises (e.g., only comprises) second PSFCH(s). At least one of the second PSFCH(s) may comprise HARQ-ACK information. Each of the second PSFCH(s) may comprise with HARQ-ACK information. For example, N PSFCH groups comprises at least one PSFCH group (e.g., denoted by a z-th PSFCH group, z≤N) that comprises (e.g., only comprises) third PSFCH(s). At least one of the third PSFCH(s) may comprise conflict information. Each of the third PSFCH(s) may comprise with conflict information. For example, the group priority order of NPSFCH groups among x-th PSFCH group, y-th PSFCH group, and z-th PSFCH group may be preconfigured (e.g., predefined) in a system specification and/or configurable (e.g., the first wireless device receives, from a base station and/or a second wireless device, the priority order).

Referring to FIG. 32, at least one of first PSFCH(s) in the at least one PSFCH group (e.g., denoted by a x-th PSFCH group, x≤N) may provide and/or comprise beam information that comprises at least one of: a beam report, a beam indication, a SL RS report, a BFRR, and/or a BFRQ (that are described in the example embodiment(s)) to be transmitted and/or received as a part of SL beam operation (e.g., a SL (initial) beam pairing procedure, a SL beam management (maintenance) procedure, and/or a SL beam failure detection and/or recovery procedure) as described in the example embodiment(s). For example, at least one of first PSFCH(s) in the at least one PSFCH group (e.g., denoted by a x-th PSFCH group, x≤N) may provide and/or comprise beam information corresponding to, associated with, initiated/triggered based on at least one of: periodic SL RS(s), a periodic SL RS(s), and/or a semi-persistent SL RS(s) as described in the example embodiment(s). For example, the group priority order (e.g., a prioritization order) in FIG. 32 may be applicable for a PSFCH comprising a particular first beam information (e.g., comprising at least one of a beam report, a beam indication, a SL RS report, a BFRR, and/or a BFRQ).

Referring to FIG. 32, for example, the first wireless device may determine a group priority order (e.g., a prioritization order) between/among N PSFCH groups in ascending order and/or descending order. For example, the group priority order may be predefined, e.g., in a system specification and/or may be hard-coded in the first wireless device. For example, the group priority order may be configurable. For example, the first wireless device may receive one or more messages (e.g., SIB and/or RRC message) comprising configuration parameter(s) indicating the group priority order. Each of N PSFCH groups may be associated with a respective group priority order. The group priority order of N PSFCH groups may be for determining a sidelink communication mode (e.g., whether to perform transmission or reception) when transmission of PSFCH(s) overlaps in time with reception of PSFCH(s) in a same PSFCH occasion.

Referring to FIG. 32, the present disclosure may denote by n-th PSFCH group, a PSFCH group has a n-th highest group priority among N PSFCH groups. For example, 1≤n≤N. For example, N may be a total number of N PSFCH groups the first wireless device may determine a group priority order between N PSFCH groups. For example, a 1-st PSFCH group has a highest group priority among N PSFCH groups, a 2-nd PSFCH group has a second highest group priority among N PSFCH groups, and so on.

An example group priority order (e.g., descending order) of PSFCH groups among x-th PSFCH group and y-th PSFCH group may comprise x-th PSFCH group having a higher priority than y-th PSFCH group (e.g., x<y).

An example group priority order (e.g., descending order) of PSFCH groups among x-th PSFCH group and y-th PSFCH group may comprise x-th PSFCH group having a lower priority than y-th PSFCH group (e.g., x>y).

An example group priority order (e.g., descending order) of PSFCH groups among y-th PSFCH group and z-th PSFCH group may comprise y-th PSFCH group having a higher priority than z-th PSFCH group (e.g., y<z).

An example group priority order (e.g., descending order) of PSFCH groups among y-th PSFCH group and z-th PSFCH group may comprise y-th PSFCH group having a lower priority than z-th PSFCH group (e.g., y>z).

An example group priority order (e.g., descending order) of PSFCH groups among x-th PSFCH group and z-th PSFCH group may comprise x-th PSFCH group having a higher priority than z-th PSFCH group (e.g., x<z).

An example group priority order (e.g., descending order) of PSFCH groups among x-th PSFCH group and z-th PSFCH group may comprise x-th PSFCH group having a lower priority than z-th PSFCH group (e.g., x>z).

An example group priority order (e.g., descending order) of PSFCH groups among x-th PSFCH group and y-th PSFCH group may comprise x-th PSFCH group having a same priority than y-th PSFCH group (e.g., x=y).

An example group priority order (e.g., descending order) of PSFCH groups among x-th PSFCH group and z-th PSFCH group may comprise y-th PSFCH group having a same priority than z-th PSFCH group (e.g., x=z).

An example group priority order (e.g., descending order) of PSFCH groups among y-th PSFCH group and z-th PSFCH group may comprise y-th PSFCH group having a same priority than z-th PSFCH group (e.g., y=z).

An example group priority order (e.g., descending order) of PSFCH groups among y-th PSFCH group and z-th PSFCH group may be y-th PSFCH group and z-th PSFCH group (e.g., y>z). For example, y-th PSFCH group has a lower priority than z-th PSFCH group.

An example group priority order (e.g., descending order) of PSFCH groups among x-th PSFCH group and z-th PSFCH group may be x-th PSFCH group and z-th PSFCH group (e.g., x<z). For example, x-th PSFCH group has a higher priority than z-th PSFCH group.

An example group priority order (e.g., descending order) of PSFCH groups among x-th PSFCH group and z-th PSFCH group may be x-th PSFCH group and z-th PSFCH group (e.g., x>z). For example, x-th PSFCH group has a lower priority than z-th PSFCH group.

An example group priority order of PSFCH groups may comprise between PSFCH beam groups. For example, PSFCH beam groups comprise a first PSFCH beam group comprising at least one PSFCH comprising beam information associated with, initiated by, and/or triggered by a SL initial beam paring procedure. For example, PSFCH beam groups comprise a second PSFCH beam group comprising at least one PSFCH comprising beam information associated with, initiated by, and/or triggered by a SL beam management procedure. For example, PSFCH beam groups comprise a third PSFCH beam group comprising at least one PSFCH comprising beam information associated with, initiated by, and/or triggered by a SL BFD and/or BFR procedure.

An example group priority order (e.g., descending order) of PSFCH groups among the first PSFCH beam group and the second PSFCH beam group may comprise a priority of the first PSFCH beam group being higher than a priority of the second PSFCH beam group.

An example group priority order (e.g., descending order) of PSFCH groups among the first PSFCH beam group and the third PSFCH beam group may comprise a priority of the first PSFCH beam group being higher than a priority of the third PSFCH beam group.

An example group priority order (e.g., descending order) of PSFCH groups among the first PSFCH beam group and the second PSFCH beam group may comprise a priority of the first PSFCH beam group being lower than a priority of the second PSFCH beam group.

An example group priority order (e.g., descending order) of PSFCH groups among the first PSFCH beam group and the third PSFCH beam group may comprise a priority of the first PSFCH beam group being lower than a priority of the third PSFCH beam group.

An example group priority order (e.g., descending order) of PSFCH groups among the third PSFCH beam group and the second PSFCH beam group may comprise a priority of the third PSFCH beam group being higher than a priority of the second PSFCH beam group.

An example group priority order (e.g., descending order) of PSFCH groups among the third PSFCH beam group and the second PSFCH beam group may comprise a priority of the third PSFCH beam group being lower than a priority of the second PSFCH beam group.

An example group priority order (e.g., descending order) of PSFCH groups among the first PSFCH beam group and the second PSFCH beam group may comprise a priority of the first PSFCH beam group being equal to or same as a priority of the second PSFCH beam group.

An example group priority order (e.g., descending order) of PSFCH groups among the first PSFCH beam group and the third PSFCH beam group may comprise a priority of the first PSFCH beam group being equal to or same as a priority of the third PSFCH beam group.

An example group priority order (e.g., descending order) of PSFCH groups among the second PSFCH beam group and the third PSFCH beam group may comprise a priority of the second PSFCH beam group being equal to or same as a priority of the third PSFCH beam group.

An example group priority order of PSFCH groups may comprise between PSFCH beam groups. For example, PSFCH beam groups comprise a fourth PSFCH beam group comprising at least one PSFCH comprising beam information associated with, initiated by, and/or triggered by aperiodic SL RS(s). For example, PSFCH beam groups comprise a fifth PSFCH beam group comprising at least one PSFCH comprising beam information associated with, initiated by, and/or triggered by periodic SL RS(s). For example, PSFCH beam groups comprise a sixth PSFCH beam group comprising at least one PSFCH comprising beam information associated with, initiated by, and/or triggered by semi-persistent SL RS(s).

An example group priority order (e.g., descending order) of PSFCH groups among the fourth PSFCH beam group and the fifth PSFCH beam group may comprise a priority of the fourth PSFCH beam group being higher than a priority of the fifth PSFCH beam group.

An example group priority order (e.g., descending order) of PSFCH groups among the fourth PSFCH beam group and the sixth PSFCH beam group may comprise a priority of the fourth PSFCH beam group being higher than a priority of the sixth PSFCH beam group.

An example group priority order (e.g., descending order) of PSFCH groups among the fourth PSFCH beam group and the fifth PSFCH beam group may comprise a priority of the fourth PSFCH beam group being lower than a priority of the fifth PSFCH beam group.

An example group priority order (e.g., descending order) of PSFCH groups among the fourth PSFCH beam group and the sixth PSFCH beam group may comprise a priority of the fourth PSFCH beam group being lower than a priority of the sixth PSFCH beam group.

An example group priority order (e.g., descending order) of PSFCH groups among the sixth PSFCH beam group and the fifth PSFCH beam group may comprise a priority of the sixth PSFCH beam group being higher than a priority of the fifth PSFCH beam group.

An example group priority order (e.g., descending order) of PSFCH groups among the sixth PSFCH beam group and the fifth PSFCH beam group may comprise a priority of the sixth PSFCH beam group being lower than a priority of the fifth PSFCH beam group.

An example group priority order (e.g., descending order) of PSFCH groups among the fourth PSFCH beam group and the fifth PSFCH beam group may comprise a priority of the fourth PSFCH beam group being equal to or same as a priority of the fifth PSFCH beam group.

An example group priority order (e.g., descending order) of PSFCH groups among the fourth PSFCH beam group and the sixth PSFCH beam group may comprise a priority of the fourth PSFCH beam group being equal to or same as a priority of the sixth PSFCH beam group.

An example group priority order (e.g., descending order) of PSFCH groups among the fifth PSFCH beam group and the third PSFCH beam group may comprise a priority of the fifth PSFCH beam group being equal to or same as a priority of the third PSFCH beam group.

Referring to FIG. 32, the first wireless device may check whether at least one PSFCH of N_{sch,TX,PSFCH} PSFCHs and N_{sch,RX,PSFCH} PSFCHs is in a PSFCH group of N PSFCH groups in a descending order (or an ascending order) of the group priority of N PSFCH groups (e.g., at 3203, 3204, and/or 3205 in FIG. 32). In an example, the first wireless device may check whether each of PSFCH group of the N PSFCH groups is empty descending order (or ascending order) of the group priority of N PSFCH groups. For example, the first wireless device may check whether at least one PSFCH of N_{sch,TX,PSFCH} PSFCHs and N_{sch,RX,PSFCH} PSFCHs is in a n-th PSFCH group of N PSFCH groups. The n-th PSFCH group may be a PSFCH group that has a n-th highest group priority among the N PSFCH groups (e.g., 1≤n≤N). If none of N_{sch,TX,PSFCH} PSFCHs and N_{sch,RX,PSFCH} PSFCHs in the n-th PSFCH group (e.g., at 3204 with ‘No’ in FIG. 32), the first wireless device may check whether at least one PSFCH of N_{sch,TX,PSFCH} PSFCHs and N_{sch,RX,PSFCH} PSFCHs is in a (n+1)-th PSFCH group of N PSFCH groups (e.g., at 3204 in FIG. 32 with updated n (e.g., n=n+1) through 3205 in FIG. 32).

Referring to FIG. 32, if the first wireless device may determine that at least one PSFCH is in a PSFCH group having a n-th highest group priority among the N PSFCH groups (e.g., at 3204 with ‘Yes’ in FIG. 32), the first wireless device may determine whether to perform transmission or reception via a PSFCH occasion based on priority value(s) associated with one or more PSFCHs in the PSFCH group having a n-th highest group priority (e.g., at 3206 in FIG. 32).

Referring to FIG. 32, the first wireless device may determine (e.g., select or identify) a particular PSFCH, associated with a priority value, from the one or more PSFCHs in the PSFCH group having a n-th highest group priority (e.g., at 3206 in FIG. 32). The priority value of the particular PSFCH may be the smallest among one or more priority values associated with the one or more PSFCHs in the PSFCH group having a n-th highest group priority.

Referring to FIG. 32, the first wireless device may determine, check, and/or identify whether the particular PSFCH is one of N_{sch,TX,PSFCH} PSFCHs or is one of N_{sch,RX,PSFCH} PSFCHs (e.g., at 3207 in FIG. 32). For example, the first wireless device may determine, check, and/or identify whether the first wireless device schedules the particular PSFCH as a transmission or a reception via the PSFCH occasion.

For example, the first wireless device may determine to perform, via the PSFCH occasion, transmission, e.g., if the particular PSFCH is one of N_{sch,TX,PSFCH} PSFCHs and/or if the first wireless device schedules the particular PSFCH as a transmission via the PSFCH occasion (e.g., at 3207 with ‘Yes’ in FIG. 32 and/or at 3208 in FIG. 32). For example, the first wireless device may determine to perform, via the PSFCH occasion, reception, e.g., if the particular PSFCH is one of N_{sch,RX,PSFCH} PSFCHs and/or if the first wireless device schedules the particular PSFCH as a reception via the PSFCH occasion (e.g., at 3207 with ‘No’ in FIG. 32 and/or at 3209 in FIG. 32). For example, the first wireless device may determine a sidelink communication mode performed for N_{sch,TX,PSFCH} PSFCHs or N_{sch,RX,PSFCH} PSFCHs via the PSFCH occasion as the same as a sidelink communication mode of the particular PSFCH associated with a priority value that is the smallest among one or more priority values associated with the one or more PSFCHs in the PSFCH group having a n-th highest group priority.

Referring to FIG. 32, if the first wireless device may determine to perform transmission via the PSFCH occasion, the first wireless device may transmit one or more (e.g., a set of) PSFCHs of N_{sch,TX,PSFCH} PSFCHs via the PSFCH occasion. The first wireless device may select the one or more PSFCHs of N_{sch,TX,PSFCH} PSFCHs as the ones that the first wireless device transmits via the PSFCH occasion.

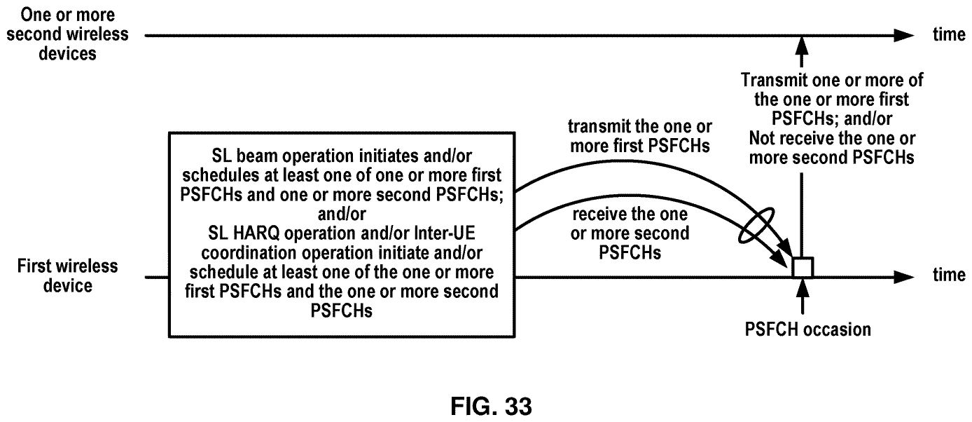

FIG. 33 illustrates an example of PSFCH transmission per an aspect of an embodiment of the present disclosure. FIG. 33 refers to FIG. 32. For example, FIG. 33 shows the first wireless device performs transmission, e.g., if the first wireless device may determine to perform transmission via the PSFCH occasion (e.g., at 3208 in FIG. 32).

Referring to FIG. 33, if the first wireless device may determine to perform transmission via the PSFCH occasion, the first wireless device may select the one or more PSFCH based on priority values associated with N_{sch,TX,PSFCH} PSFCHs and/or based on a PSFCH transmission group priority order. The PSFCH transmission group priority order may be a priority order defined to determine or select the one or more PSFCH from N_{sch,TX,PSFCH} PSFCHs, e.g., after or in response to the first wireless device determining, using the group priority of N PSFCH groups, the sidelink communication mode via the PSFCH occasion.

Referring to FIG. 33, for example, the first wireless device groups N_{sch,TX,PSFCH} PSFCHs into K₁ PSFCH transmission groups, e.g., K₁≥1. For example, each of the one or more PSFCH transmission groups is associated with a respective PSFCH transmission group priority of K₁ PSFCH transmission groups. The present disclosure denotes a PSFCH transmission group having a k-th PSFCH transmission group priority among K₁ PSFCH transmission groups by a k-th PSFCH transmission group, 1≤k≤K₁. The first wireless device may select one or more PSFCH(s), from a k-th (e.g., 1st with k=1) PSFCH transmission group having a k-th (e.g., a highest with k=1) PSFCH transmission group priority. For example, the first wireless device selects the one or more PSFCH(s) selected from a k-th (e.g., 1st with k=1) PSFCH transmission group such that the total quantity of selected PSFCH(s) from a k-th (e.g., 1st with k=1) PSFCH transmission group and from any of l-th PSFCH transmission group (e.g., l is any positive integer number smaller than k) is equal to or smaller than N_{Max,PSFCH,Tx}. The first wireless device may transmit, via the PSFCH occasion, the one or more PSFCH(s) selected from a k-th (e.g., 1st with k=1) PSFCH transmission group. If the total quantity of selected PSFCH(s) from a k-th (e.g., 1st with k=1) PSFCH transmission group and from any of l-th PSFCH transmission group (e.g., l is a positive integer number smaller than k) is equal to (e.g., and/or larger than) N_{Max,PSFCH}, Tx, the first wireless device may stop selecting PSFCH from N_{sch,TX,PSFCH} PSFCHs and/or transmit one or more PSFCHs selected from a k-th (e.g., 1st with k=1) PSFCH transmission group and from any of l-th PSFCH transmission group (e.g., l is a positive integer number smaller than k). If the total quantity of selected PSFCH(s) from a k-th (e.g., 1st with k=1) PSFCH transmission group and from any of l-th PSFCH transmission group (e.g., l is a positive integer number smaller than k) is smaller than N_{Max,PSFCH},Tx, the first wireless device may subsequently perform the same PSFCH selection for a (k+1)-th PSFCH transmission group as the first wireless device performs a PSFCH selection for a k-th (e.g., 1st with k=1) PSFCH transmission group. If a k-th (e.g., 1st with k=1) PSFCH transmission group does not comprise any PSFCHs, the first wireless device may subsequently perform the same PSFCH selection for a (k+1)-th PSFCH transmission group as the first wireless device performs a PSFCH selection for a k-th (e.g., 1st with k=1) PSFCH transmission group. For example, if the total quantity of selected PSFCH(s) from a k-th (e.g., 1st with k=1) PSFCH transmission group and from any of l-th PSFCH transmission group (e.g., l is a positive integer number smaller than k) is smaller than N_{Max,PSFCH,Tx}, the first wireless device may subsequently select one or more PSFCH(s), from a (k+1)-th PSFCH transmission group having a (k+1)-th PSFCH transmission group priority. For example, the first wireless device selects the one or more PSFCH(s) selected from a (k+1)-th PSFCH transmission group such that the total quantity of selected PSFCH(s) from a (k+1)-th PSFCH transmission group and from any of l-th PSFCH transmission group (e.g., l is any positive integer number smaller than k+1) is equal to or smaller than N_{Max,PSFCH,Tx}.

If the total quantity of selected PSFCH(s) from a (k+1)-th PSFCH transmission group and from any of l-th PSFCH transmission group (e.g., l is a positive integer number smaller than k+1) is equal to (e.g., and/or larger than) N_{Max,PSFCH,Tx}, the first wireless device may stop selecting PSFCH from N_{sch,TX,PSFCH} PSFCHs and/or transmit one or more PSFCHs selected from a (k+1)-th PSFCH transmission group and from any of l-th PSFCH transmission group (e.g., l is a positive integer number smaller than k+1). If the total quantity of selected PSFCH(s) from a (k+1)-th PSFCH transmission group and from any of l-th PSFCH transmission group (e.g., l is a positive integer number smaller than k+1) is smaller than N_{Max,PSFCH,Tx}, the first wireless device may subsequently perform the same PSFCH selection for a (k+2)-th PSFCH transmission as the first wireless device performs a PSFCH selection for a k-th (and/or (k+1)-th) PSFCH transmission group. If a (k+1)-th PSFCH transmission group does not comprise any PSFCHs, the first wireless device may subsequently perform the same PSFCH selection for a (k+2)-th PSFCH transmission group as the first wireless device performs a PSFCH selection for a k-th (and/or (k+1)-th) PSFCH transmission group. The first wireless device may subsequently repeat the same PSFCH selection for a (k+1)-th PSFCH transmission group, e.g., k<i≥K₁, e.g., until the total quantity of PSFCH(s) selected from a k-th PSFCH transmission group and from any of l-th PSFCH transmission group (e.g., l is a positive integer number smaller than k+1) is equal to or larger than N_{Max,PSFCH,Tx} and/or until k becomes K₁.

Referring to FIG. 33, for example, K₁ PSFCH transmission groups comprise at least one PSFCH transmission group (e.g., denoted by a x₁-th PSFCH transmission group, x₁≤K₁) that comprises (e.g., only comprises) first PSFCH(s). At least one of the first PSFCH(s) may comprise beam information. Each of the first PSFCH(s) may comprise with beam information. For example, K₁ PSFCH transmission groups comprises at least one PSFCH transmission group that comprises (e.g., only comprises) second PSFCH(s). At least one of the second PSFCH(s) (e.g., denoted by a y₁-th PSFCH transmission group, y₁≤K₁) may comprise HARQ-ACK information. Each of the second PSFCH(s) may comprise with HARQ-ACK information. For example, K₁ PSFCH transmission group comprises at least one PSFCH transmission group (e.g., denoted by a z₁-th PSFCH transmission group, z₁≤K₁) that comprises (e.g., only comprises) third PSFCH(s). At least one of the third PSFCH(s) may comprise conflict information. Each of the third PSFCH(s) may comprise with conflict information. For example, the priority order of K₁ PSFCH transmission groups among x₁-th PSFCH transmission group, y₁-th PSFCH transmission group, and z₁-th PSFCH transmission group may be preconfigured (e.g., predefined) in a system specification and/or configurable (e.g., the first wireless device receives, from a base station and/or a second wireless device, the priority order).

An example priority order (e.g., descending order) of PSFCH transmission groups among x₁-th PSFCH transmission group and y₁-th PSFCH transmission group may be x₁-th PSFCH transmission group and y₁-th PSFCH transmission group (e.g., x₁<y₁). For example, x₁-th PSFCH transmission group has a higher priority than y₁-th PSFCH transmission group.

An example priority order (e.g., descending order) of PSFCH transmission groups among x₁-th PSFCH transmission group and y₁-th PSFCH transmission group may be x₁-th PSFCH transmission group and y₁-th PSFCH transmission group (e.g., x₁>y₁). For example, x₁-th PSFCH transmission group has a lower priority than y₁-th PSFCH transmission group.

An example priority order (e.g., descending order) of PSFCH transmission groups among y₁-th PSFCH transmission group and z₁-th PSFCH transmission group may be y₁-th PSFCH transmission group and z₁-th PSFCH transmission group (e.g., y₁<z₁). For example, y₁-th PSFCH transmission group has a higher priority than z₁-th PSFCH transmission group.

An example priority order (e.g., descending order) of PSFCH transmission groups among y₁-th PSFCH transmission group and z₁-th PSFCH transmission group may be y₁-th PSFCH transmission group and z₁-th PSFCH transmission group (e.g., y₁>z₁). For example, y₁-th PSFCH transmission group has a lower priority than z₁-th PSFCH transmission group.

An example priority order (e.g., descending order) of PSFCH transmission groups among x₁-th PSFCH transmission group and z₁-th PSFCH transmission group may be x₁-th PSFCH transmission group and z₁-th PSFCH transmission group (e.g., x₁<z₁). For example, x₁-th PSFCH transmission group has a higher priority than z₁-th PSFCH transmission group.

An example priority order (e.g., descending order) of PSFCH transmission groups among x₁-th PSFCH transmission group and z₁-th PSFCH transmission group may be x₁-th PSFCH transmission group and z₁-th PSFCH transmission group (e.g., x₁>z₁). For example, x₁-th PSFCH transmission group has a lower priority than z₁-th PSFCH transmission group.

An example PSFCH transmission group priority order of PSFCH transmission groups may comprise between PSFCH transmission beam groups. For example, PSFCH transmission beam groups comprise a first PSFCH transmission beam group comprising at least one PSFCH comprising beam information associated with, initiated by, and/or triggered by a SL initial beam paring procedure. For example, PSFCH transmission beam groups comprise a second PSFCH transmission beam group comprising at least one PSFCH comprising beam information associated with, initiated by, and/or triggered by a SL beam management procedure. For example, PSFCH transmission beam groups comprise a third PSFCH transmission beam group comprising at least one PSFCH comprising beam information associated with, initiated by, and/or triggered by a SL BFD and/or BFR procedure.

An example PSFCH transmission group priority order (e.g., descending order) of PSFCH transmission groups among the first PSFCH transmission beam group and the second PSFCH transmission beam group may comprise a priority of the first PSFCH transmission beam group being higher than a priority of the second PSFCH transmission beam group.

An example PSFCH transmission group priority order (e.g., descending order) of PSFCH transmission groups among the first PSFCH transmission beam group and the third PSFCH transmission beam group may comprise a priority of the first PSFCH transmission beam group being higher than a priority of the third PSFCH transmission beam group.

An example PSFCH transmission group priority order (e.g., descending order) of PSFCH transmission groups among the first PSFCH transmission beam group and the second PSFCH transmission beam group may comprise a priority of the first PSFCH transmission beam group being lower than a priority of the second PSFCH transmission beam group.

An example PSFCH transmission group priority order (e.g., descending order) of PSFCH transmission groups among the first PSFCH transmission beam group and the third PSFCH transmission beam group may comprise a priority of the first PSFCH transmission beam group being lower than a priority of the third PSFCH transmission beam group.

An example PSFCH transmission group priority order (e.g., descending order) of PSFCH transmission groups among the third PSFCH transmission beam group and the second PSFCH transmission beam group may comprise a priority of the third PSFCH transmission beam group being higher than a priority of the second PSFCH transmission beam group.

An example PSFCH transmission group priority order (e.g., descending order) of PSFCH transmission groups among the third PSFCH transmission beam group and the second PSFCH transmission beam group may comprise a priority of the third PSFCH transmission beam group being lower than a priority of the second PSFCH transmission beam group.

An example PSFCH transmission group priority order (e.g., descending order) of PSFCH transmission groups among the first PSFCH transmission beam group and the second PSFCH beam group may comprise a priority of the first PSFCH transmission beam group being equal to or same as a priority of the second PSFCH transmission beam group.

An example PSFCH transmission group priority order (e.g., descending order) of PSFCH transmission groups among the first PSFCH transmission beam group and the third PSFCH beam group may comprise a priority of the first PSFCH transmission beam group being equal to or same as a priority of the third PSFCH transmission beam group.

An example PSFCH transmission group priority order (e.g., descending order) of PSFCH transmission groups among the second PSFCH transmission beam group and the third PSFCH transmission beam group may comprise a priority of the second PSFCH transmission beam group being equal to or same as a priority of the third PSFCH transmission beam group.

An example PSFCH transmission group priority order of PSFCH transmission groups may comprise between PSFCH transmission beam groups. For example, PSFCH transmission beam groups comprise a fourth PSFCH transmission beam group comprising at least one PSFCH comprising beam information associated with, initiated by, and/or triggered by aperiodic SL RS(s). For example, PSFCH transmission beam groups comprise a fifth PSFCH transmission beam group comprising at least one PSFCH comprising beam information associated with, initiated by, and/or triggered by periodic SL RS(s). For example, PSFCH transmission beam groups comprise a sixth PSFCH transmission beam group comprising at least one PSFCH comprising beam information associated with, initiated by, and/or triggered by semi-persistent SL RS(s).

An example PSFCH transmission group priority order (e.g., descending order) of PSFCH transmission groups among the fourth PSFCH transmission beam group and the fifth PSFCH transmission beam group may comprise a priority of the fourth PSFCH transmission beam group being higher than a priority of the fifth PSFCH transmission beam group.

An example PSFCH transmission group priority order (e.g., descending order) of PSFCH transmission groups among the fourth PSFCH transmission beam group and the sixth PSFCH transmission beam group may comprise a priority of the fourth PSFCH transmission beam group being higher than a priority of the sixth PSFCH transmission beam group.

An example PSFCH transmission group priority order (e.g., descending order) of PSFCH transmission groups among the fourth PSFCH transmission beam group and the fifth PSFCH transmission beam group may comprise a priority of the fourth PSFCH transmission beam group being lower than a priority of the fifth PSFCH transmission beam group.

An example PSFCH transmission group priority order (e.g., descending order) of PSFCH transmission groups among the fourth PSFCH transmission beam group and the sixth PSFCH transmission beam group may comprise a priority of the fourth PSFCH transmission beam group being lower than a priority of the sixth PSFCH transmission beam group.

An example PSFCH transmission group priority order (e.g., descending order) of PSFCH transmission groups among the sixth PSFCH transmission beam group and the fifth PSFCH transmission beam group may comprise a priority of the sixth PSFCH transmission beam group being higher than a priority of the fifth PSFCH transmission beam group.

An example PSFCH transmission group priority order (e.g., descending order) of PSFCH transmission groups among the sixth PSFCH transmission beam group and the fifth PSFCH transmission beam group may comprise a priority of the sixth PSFCH transmission beam group being lower than a priority of the fifth PSFCH transmission beam group.

An example PSFCH transmission group priority order (e.g., descending order) of PSFCH transmission groups among the fourth PSFCH transmission beam group and the fifth PSFCH transmission beam group may comprise a priority of the fourth PSFCH transmission beam group being equal to or same as a priority of the fifth PSFCH transmission beam group.

An example PSFCH transmission group priority order (e.g., descending order) of PSFCH transmission groups among the fourth PSFCH transmission beam group and the sixth PSFCH transmission beam group may comprise a priority of the fourth PSFCH transmission beam group being equal to or same as a priority of the sixth PSFCH transmission beam group.

An example PSFCH transmission group priority order (e.g., descending order) of PSFCH transmission groups among the fifth PSFCH transmission beam group and the third PSFCH transmission beam group may comprise a priority of the fifth PSFCH transmission beam group being equal to or same as a priority of the third PSFCH transmission beam group.

Referring to FIG. 32, if the first wireless device may determine to perform reception via the PSFCH occasion, the first wireless device may receive one or more (e.g., a set of) PSFCHs of N_{sch,RX,PSFCH} PSFCHs via the PSFCH occasion. The first wireless device may select the one or more PSFCHs of N_{sch,RX,PSFCH} PSFCHs as the ones that the first wireless device receives via the PSFCH occasion.

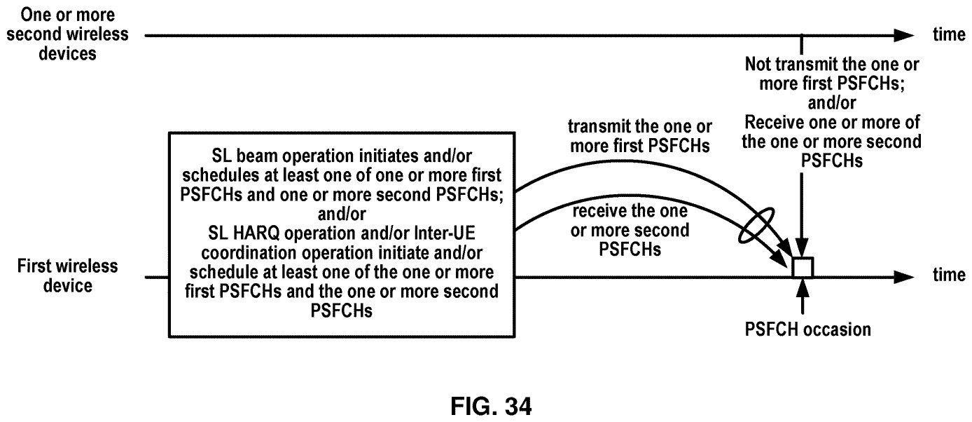

FIG. 34 illustrates an example of PSFCH receptions per an aspect of an embodiment of the present disclosure. FIG. 34 refers to FIG. 32 and/or FIG. 33. For example, FIG. 34 shows the first wireless device performs reception, e.g., if the first wireless device may determine to perform reception via the PSFCH occasion (e.g., at 3209 in FIG. 32).

Referring to FIG. 34, if the first wireless device may determine to perform reception via the PSFCH occasion, the first wireless device may select the one or more PSFCH based on priority values associated with N_{sch,RX,PSFCH} PSFCHs and/or based on a PSFCH reception group priority order. The PSFCH reception group priority order may be a priority order defined to determine or select the one or more PSFCH from N_{sch,RX,PSFCH} PSFCHs, e.g., after or in response to the first wireless device determining, using the group priority of N PSFCH groups, the sidelink communication mode via the PSFCH occasion.

Referring to FIG. 34, for example, the first wireless device groups N_{sch,RX,PSFCH} PSFCHs into K₂ PSFCH reception groups, e.g., K₂≥1. For example, each of the one or more PSFCH reception groups is associated with a respective PSFCH reception group priority of K₂ PSFCH reception groups. The present disclosure denotes a PSFCH reception group having a k-th PSFCH reception group priority among K₂ PSFCH reception groups by a k-th PSFCH reception group, 1≤k≤K₂. The first wireless device may select one or more PSFCH(s), from a k-th (e.g., 1st with k=1) PSFCH reception group having a k-th (e.g., a highest with k=1) PSFCH reception group priority. For example, the first wireless device selects the one or more PSFCH(s) selected from a k-th (e.g., 1st with k=1) PSFCH reception group such that the total quantity of selected PSFCH(s) from a k-th (e.g., 1st with k=1) PSFCH reception group and from any of l-th PSFCH reception group (e.g., l is any positive integer number smaller than k) is equal to or smaller than N_{Max,PSFCH,Rx}. The first wireless device may receive, via the PSFCH occasion, the one or more PSFCH(s) selected from a k-th (e.g., 1st with k=1) PSFCH reception group. If the total quantity of selected PSFCH(s) from a k-th (e.g., 1st with k=1) PSFCH reception group and from any of l-th PSFCH reception group (e.g., l is a positive integer number smaller than k) is equal to (e.g., and/or larger than) N_{Max,PSFCH,Rx}, the first wireless device may stop selecting PSFCH from N_{sch,RX,PSFCH} PSFCHs and/or receive one or more PSFCHs selected from a k-th (e.g., 1st with k=1) PSFCH reception group and from any of l-th PSFCH reception group (e.g., l is a positive integer number smaller than k). If the total quantity of selected PSFCH(s) from a k-th (e.g., 1st with k=1) PSFCH reception group and from any of l-th PSFCH reception group (e.g., l is a positive integer number smaller than k) is smaller than N_{Max,PSFCH,Rx}, the first wireless device may subsequently perform the same PSFCH selection for a (k+1)-th PSFCH reception group as the first wireless device performs a PSFCH selection for a k-th (e.g., 1st with k=1) PSFCH reception group. If a k-th (e.g., 1st with k=1) PSFCH reception group does not comprise any PSFCHs, the first wireless device may subsequently perform the same PSFCH selection for a (k+1)-th PSFCH reception group as the first wireless device performs a PSFCH selection for a k-th (e.g., 1st with k=1) PSFCH reception group. For example, if the total quantity of selected PSFCH(s) from a k-th (e.g., 1st with k=1) PSFCH reception group and from any of l-th PSFCH reception group (e.g., l is a positive integer number smaller than k) is smaller than N_{Max,PSFCH,Rx}, the first wireless device may subsequently select one or more PSFCH(s), from a (k+1)-th PSFCH reception group having a (k+1)-th PSFCH reception group priority. For example, the first wireless device selects the one or more PSFCH(s) selected from a (k+1)-th PSFCH reception group such that the total quantity of selected PSFCH(s) from a (k+1)-th PSFCH reception group and from any of l-th PSFCH reception group (e.g., l is any positive integer number smaller than k+1) is equal to or smaller than N_{Max,PSFCH,Rx}.

If the total quantity of selected PSFCH(s) from a (k+1)-th PSFCH reception group and from any of I-th PSFCH reception group (e.g., l is a positive integer number smaller than k+1) is equal to (e.g., and/or larger than) N_{Max,PSFCH,Rx}, the first wireless device may stop selecting PSFCH from N_{sch,RX,PSFCH} PSFCHs and/or receive one or more PSFCHs selected from a (k+1)-th PSFCH reception group and from any of l-th PSFCH reception group (e.g., l is a positive integer number smaller than k+1). If the total quantity of selected PSFCH(s) from a (k+1)-th PSFCH reception group and from any of l-th PSFCH reception group (e.g., l is a positive integer number smaller than k+1) is smaller than N_{Max,PSFCH,Rx}, the first wireless device may subsequently perform the same PSFCH selection for a (k+2)-th PSFCH reception group as the first wireless device performed a PSFCH selection for a k-th (and/or (k+1)-th) PSFCH reception group. If a (k+1)-th PSFCH reception group does not comprise any PSFCHs, the first wireless device may subsequently perform the same PSFCH selection for a (k+2)-th PSFCH reception group as the first wireless device performed a PSFCH selection for a k-th (and/or (k+1)-th) PSFCH reception group. The first wireless device may subsequently repeat the same PSFCH selection for a (k+i)-th PSFCH reception group, e.g., k<i≤K₁, e.g., until the total quantity of PSFCH(s) selected from a k-th PSFCH reception group and from any of l-th PSFCH reception group (e.g., l is a positive integer number smaller than k+1) is equal to or larger than N_{Max,PSFCH,Rx} and/or until k becomes K₂.

Referring to FIG. 34, for example, K₂ PSFCH reception groups comprise at least one PSFCH reception group (e.g., denoted by a x₂-th PSFCH reception group, x₂≤K₂) that comprises (e.g., only comprises) first PSFCH(s). At least one of the first PSFCH(s) may comprise beam information. Each of the first PSFCH(s) may comprise with beam information. For example, K₂ PSFCH reception groups comprises at least one PSFCH reception group (e.g., denoted by a y₂-th PSFCH reception group, y₂≤K₂) that comprises (e.g., only comprises) second PSFCH(s). At least one of the second PSFCH(s) may comprise HARQ-ACK information. Each of the second PSFCH(s) may comprise with HARQ-ACK information. For example, K₂ PSFCH reception group comprises at least one PSFCH reception group (e.g., denoted by a z₂-th PSFCH reception group, z₂≤K₂) that comprises (e.g., only comprises) third PSFCH(s). At least one of the third PSFCH(s) may comprise conflict information. Each of the third PSFCH(s) may comprise with conflict information.

An example priority order (e.g., descending order) of PSFCH reception groups among x₂-th PSFCH reception group and y₂-th PSFCH reception group may be x₂-th PSFCH reception group and y₂-th PSFCH reception group (e.g., x₂<y₂). For example, x₂-th PSFCH reception group has a higher priority than y₂-th PSFCH reception group.

An example priority order (e.g., descending order) of PSFCH reception groups among x₂-th PSFCH reception group and y₂-th PSFCH reception group may be x₂-th PSFCH reception group and y₂-th PSFCH reception group (e.g., x₂>y₂). For example, x₂-th PSFCH reception group has a lower priority than y₂-th PSFCH reception group.

An example priority order (e.g., descending order) of PSFCH reception groups among y₂-th PSFCH reception group and z₂-th PSFCH reception group may be y₂-th PSFCH reception group and z₂-th PSFCH reception group (e.g., y₂<z₂). For example, y₂-th PSFCH reception group has a higher priority than z₂-th PSFCH reception group.

An example priority order (e.g., descending order) of PSFCH reception groups among y₂-th PSFCH reception group and z₂-th PSFCH reception group may be y₂-th PSFCH reception group and z₁-th PSFCH reception group (e.g., y₂>z₂). For example, y₂-th PSFCH reception group has a lower priority than z₂-th PSFCH reception group.

An example priority order (e.g., descending order) of PSFCH reception groups among x₂-th PSFCH reception group and z₂-th PSFCH reception group may be x₂-th PSFCH reception group and z₂-th PSFCH reception group (e.g., x₂<z₂). For example, x₂-th PSFCH reception group has a higher priority than z₂-th PSFCH reception group.

An example priority order (e.g., descending order) of PSFCH reception groups among x₂-th PSFCH reception group and z₂-th PSFCH reception group may be x₂-th PSFCH reception group and z₂-th PSFCH reception group (e.g., x₂>z₂). For example, x₂-th PSFCH reception group has a lower priority than z₂-th PSFCH reception group.

For example, PSFCH reception groups may be same as PSFCH transmission groups. For example, K₁=K₂. For example, a priority order of PSFCH reception groups may be same as the priority order of PSFCH transmission groups.

An example PSFCH reception group priority order of PSFCH reception groups may comprise between PSFCH reception beam groups. For example, PSFCH reception beam groups comprise a first PSFCH reception beam group comprising at least one PSFCH comprising beam information associated with, initiated by, and/or triggered by a SL initial beam paring procedure. For example, PSFCH reception beam groups comprise a second PSFCH reception beam group comprising at least one PSFCH comprising beam information associated with, initiated by, and/or triggered by a SL beam management procedure. For example, PSFCH reception beam groups comprise a third PSFCH reception beam group comprising at least one PSFCH comprising beam information associated with, initiated by, and/or triggered by a SL BFD and/or BFR procedure.

An example PSFCH reception group priority order (e.g., descending order) of PSFCH reception groups among the first PSFCH reception beam group and the second PSFCH reception beam group may comprise a priority of the first PSFCH reception beam group being higher than a priority of the second PSFCH reception beam group.

An example PSFCH reception group priority order (e.g., descending order) of PSFCH reception groups among the first PSFCH reception beam group and the third PSFCH reception beam group may comprise a priority of the first PSFCH reception beam group being higher than a priority of the third PSFCH reception beam group.

An example PSFCH reception group priority order (e.g., descending order) of PSFCH reception groups among the first PSFCH reception beam group and the second PSFCH reception beam group may comprise a priority of the first PSFCH reception beam group being lower than a priority of the second PSFCH reception beam group.

An example PSFCH reception group priority order (e.g., descending order) of PSFCH reception groups among the first PSFCH reception beam group and the third PSFCH reception beam group may comprise a priority of the first PSFCH reception beam group being lower than a priority of the third PSFCH reception beam group.

An example PSFCH reception group priority order (e.g., descending order) of PSFCH reception groups among the third PSFCH reception beam group and the second PSFCH reception beam group may comprise a priority of the third PSFCH reception beam group being higher than a priority of the second PSFCH reception beam group.

An example PSFCH reception group priority order (e.g., descending order) of PSFCH reception groups among the third PSFCH reception beam group and the second PSFCH reception beam group may comprise a priority of the third PSFCH reception beam group being lower than a priority of the second PSFCH reception beam group.

An example PSFCH reception group priority order (e.g., descending order) of PSFCH reception groups among the first PSFCH reception beam group and the second PSFCH beam group may comprise a priority of the first PSFCH reception beam group being equal to or same as a priority of the second PSFCH reception beam group.

An example PSFCH reception group priority order (e.g., descending order) of PSFCH reception groups among the first PSFCH reception beam group and the third PSFCH beam group may comprise a priority of the first PSFCH reception beam group being equal to or same as a priority of the third PSFCH reception beam group.

An example PSFCH reception group priority order (e.g., descending order) of PSFCH reception groups among the second PSFCH reception beam group and the third PSFCH reception beam group may comprise a priority of the second PSFCH reception beam group being equal to or same as a priority of the third PSFCH reception beam group.

An example PSFCH reception group priority order of PSFCH reception groups may comprise between PSFCH reception beam groups. For example, PSFCH reception beam groups comprise a fourth PSFCH reception beam group comprising at least one PSFCH comprising beam information associated with, initiated by, and/or triggered by aperiodic SL RS(s). For example, PSFCH reception beam groups comprise a fifth PSFCH reception beam group comprising at least one PSFCH comprising beam information associated with, initiated by, and/or triggered by periodic SL RS(s). For example, PSFCH reception beam groups comprise a sixth PSFCH reception beam group comprising at least one PSFCH comprising beam information associated with, initiated by, and/or triggered by semi-persistent SL RS(s).

An example PSFCH reception group priority order (e.g., descending order) of PSFCH reception groups among the fourth PSFCH reception beam group and the fifth PSFCH reception beam group may comprise a priority of the fourth PSFCH reception beam group being higher than a priority of the fifth PSFCH reception beam group.

An example PSFCH reception group priority order (e.g., descending order) of PSFCH reception groups among the fourth PSFCH reception beam group and the sixth PSFCH reception beam group may comprise a priority of the fourth PSFCH reception beam group being higher than a priority of the sixth PSFCH reception beam group.

An example PSFCH reception group priority order (e.g., descending order) of PSFCH reception groups among the fourth PSFCH reception beam group and the fifth PSFCH reception beam group may comprise a priority of the fourth PSFCH reception beam group being lower than a priority of the fifth PSFCH reception beam group.

An example PSFCH reception group priority order (e.g., descending order) of PSFCH reception groups among the fourth PSFCH reception beam group and the sixth PSFCH reception beam group may comprise a priority of the fourth PSFCH reception beam group being lower than a priority of the sixth PSFCH reception beam group.

An example PSFCH reception group priority order (e.g., descending order) of PSFCH reception groups among the sixth PSFCH reception beam group and the fifth PSFCH reception beam group may comprise a priority of the sixth PSFCH reception beam group being higher than a priority of the fifth PSFCH reception beam group.

An example PSFCH reception group priority order (e.g., descending order) of PSFCH reception groups among the sixth PSFCH reception beam group and the fifth PSFCH reception beam group may comprise a priority of the sixth PSFCH reception beam group being lower than a priority of the fifth PSFCH reception beam group.

An example PSFCH reception group priority order (e.g., descending order) of PSFCH reception groups among the fourth PSFCH reception beam group and the fifth PSFCH reception beam group may comprise a priority of the fourth PSFCH reception beam group being equal to or same as a priority of the fifth PSFCH reception beam group.

An example PSFCH reception group priority order (e.g., descending order) of PSFCH reception groups among the fourth PSFCH reception beam group and the sixth PSFCH reception beam group may comprise a priority of the fourth PSFCH reception beam group being equal to or same as a priority of the sixth PSFCH reception beam group.

An example PSFCH reception group priority order (e.g., descending order) of PSFCH reception groups among the fifth PSFCH reception beam group and the third PSFCH reception beam group may comprise a priority of the fifth PSFCH reception beam group being equal to or same as a priority of the third PSFCH reception beam group.

Referring to FIGS. 31-34, if a first wireless device transmits (e.g., schedule to transmit) N_{sch,Tx,PSFCH} PSFCHs and receive (e.g., schedule to receive) N_{sch,Rx,PSFCH} PSFCHs and/or if transmissions of the N_{sch,Tx,PSFCH} PSFCHs overlap in time with receptions of the N_{sch,Rx,PSFCH} PSFCHS, the first wireless device may transmit or receive (e.g., either transmit or receive) a set of PSFCHs corresponding to (e.g., associated with) the smallest priority value (e.g., smallest priority field value) of the first set of PSFCHs and the second set of PSFCHs. For example, the first set of PSFCHs and the second set of PSFCHs are respectively associated with PSFCHs comprising (e.g., provide and/or with) beam information from the N_{sch,Tx,PSFCH} PSFCHs and the PSFCHs comprising (e.g., provide and/or with) beam information from the N_{sch,Rx,PSFCH} PSFCHs, e.g., when one or more of the PSFCHs comprising (e.g., provide and/or with) beam information. If none of the N_{sch,Tx,PSFCH} PSFCHs and none of the N_{sch,Rx,PSFCH} PSFCHs comprise (e.g., provide and/or are with) beam information, the first wireless device may transmit or receive (e.g., either transmit or receive) a set of PSFCHs corresponding to (e.g., associated with) the smallest priority field value, as determined by a first set of SCI format 1-A and/or a second set of SCI format 1-A that are respectively associated with PSFCHs comprising (e.g., provide and/or with) HARQ-ACK information from the N_{sch,Tx,PSFCH} PSFCHs and PSFCHs comprising (e.g., provide and/or with) HARQ-ACK information from the N_{sch,Rx,PSFCH} PSFCHs, e.g., when one or more of the PSFCHs comprising (e.g., provide and/or with) HARQ-ACK information. If none of the N_{sch,Tx,PSFCH} PSFCHs and none of the N_{sch,Rx,PSFCH} PSFCHs comprise (e.g., provide and/or are with) beam information and/or HARQ-ACK information, the first wireless device may transmit or receive (e.g., either transmit or receive) a set of PSFCHs corresponding to (e.g., associated with) the smallest priority value of the first set of PSFCHs and the second set of PSFCHs that are respectively associated with the N_{sch,Tx,PSFCH} PSFCHs and the N_{sch,Rx,PSFCH} PSFCHs, e.g., when the PSFCHs comprising (e.g., provide and/or with) conflict information.

Referring to FIGS. 31-34, if a first wireless device transmits (e.g., schedule to transmit) N_{sch,Tx,PSFCH} PSFCHs and receive (e.g., schedule to receive) N_{sch,Rx,PSFCH} PSFCHs and/or if transmissions of the N_{sch,Tx,PSFCH} PSFCHs overlap in time with receptions of the N_{sch,Rx,PSFCH} PSFCHs, the first wireless device may transmit or receive (e.g., either transmit or receive) a set of PSFCHs corresponding to (e.g., associated with) the smallest priority field value, as determined by a first set of SCI format 1-A and/or a second set of SCI format 1-A that are respectively associated with PSFCHs comprising (e.g., provide and/or with) HARQ-ACK information from the N_{sch,Tx,PSFCH} PSFCHs and PSFCHs comprising (e.g., provide and/or with) HARQ-ACK information from the N_{sch,Rx,PSFCH} PSFCHs, e.g., when one or more of the PSFCHs comprising (e.g., provide and/or with) HARQ-ACK information. If none of the N_{sch,Tx,PSFCH} PSFCHs and none of the N_{sch,Rx,PSFCH} PSFCHs comprise (e.g., provide and/or are with) HARQ-ACK information, the first wireless device may transmit or receive (e.g., either transmit or receive) a set of PSFCHs corresponding to (e.g., associated with) the smallest priority value (e.g., smallest priority field value) of the first set of PSFCHs and the second set of PSFCHs that are respectively associated with PSFCHs comprising (e.g., provide and/or with) beam information from the N_{sch,Tx,PSFCH} PSFCHs and the PSFCHs comprising (e.g., provide and/or with) beam information from the N_{sch,Rx,PSFCH} PSFCHs, e.g., when one or more of the PSFCHs comprising (e.g., provide and/or with) beam information. If none of the N_{sch,Tx,PSFCH} PSFCHs and none of the N_{sch,Rx,PSFCH} PSFCHs comprise (e.g., provide and/or are with) beam information and/or HARQ-ACK information, the first wireless device may transmit or receive (e.g., either transmit or receive) a set of PSFCHs corresponding to (e.g., associated with) the smallest priority value of the first set of PSFCHs and the second set of PSFCHs that are respectively associated with the N_{sch,Tx,PSFCH} PSFCHs and the N_{sch,Rx,PSFCH} PSFCHs, e.g., when the PSFCHs comprising (e.g., provide and/or with) conflict information.

Referring to FIGS. 31-34, if a first wireless device transmits (e.g., schedule to transmit) N_{sch,Tx,PSFCH} PSFCHs and receive (e.g., schedule to receive) N_{sch,Rx,PSFCH} PSFCHs and/or if transmissions of the N_{sch,Tx,PSFCH} PSFCHs overlap in time with receptions of the N_{sch,Rx,PSFCH} PSFCHs, the first wireless device may transmit or receive (e.g., either transmit or receive) a set of PSFCHs corresponding to (e.g., associated with) the smallest priority field value, as determined by a first set of SCI format 1-A and/or a second set of SCI format 1-A that are respectively associated with PSFCHs comprising (e.g., provide and/or with) HARQ-ACK information from the N_{sch,Tx,PSFCH} PSFCHs and PSFCHs comprising (e.g., provide and/or with) HARQ-ACK information from the N_{sch,Rx,PSFCH} PSFCHs, e.g., when one or more of the PSFCHs comprising (e.g., provide and/or with) HARQ-ACK information. If none of the N_{sch,Tx,PSFCH} PSFCHs and none of the N_{sch,Rx,PSFCH} PSFCHs comprise (e.g., provide and/or are with) HARQ-ACK information, the first wireless device may transmit or receive (e.g., either transmit or receive) a set of PSFCHs corresponding to (e.g., associated with) the smallest priority value of the first set of PSFCHs and the second set of PSFCHs that are respectively associated with the N_{sch,Tx,PSFCH} PSFCHs and the N_{sch,Rx,PSFCH} PSFCHs, e.g., when the PSFCHs comprising (e.g., provide and/or with) conflict information. If none of the N_{sch,Tx,PSFCH} PSFCHs and none of the N_{sch,Rx,PSFCH} PSFCHs comprise (e.g., provide and/or are with) conflict information and/or HARQ-ACK information, the first wireless device may transmit or receive (e.g., either transmit or receive) a set of PSFCHs corresponding to (e.g., associated with) the smallest priority value (e.g., smallest priority field value) of the first set of PSFCHs and the second set of PSFCHs that are respectively associated with PSFCHs comprising (e.g., provide and/or with) beam PSFCHs and the PSFCHs comprising (e.g., provide and/or with) beam information from the N_{sch,Tx,PSFCH} information from the N_{sch,Rx,PSFCH} PSFCHs, e.g., when one or more of the PSFCHs comprise (e.g., provide and/or are with) beam information.

Referring from FIG. 31 to FIG. 35, example embodiment(s) of present disclosure provide one or more PSFCH grouping examples with a prioritization rule and/or a priority order for selecting one or more PSFCHs for simultaneous PSFCH transmission and reception in a same PSFCH occasion. In particular, the one or more PSFCH grouping examples in the example embodiment(s) are for the case that one or more PSFCH comprising beam information is scheduled in the same PSFCH occasion.

Referring from FIG. 31 to FIG. 35, each of the one or more PSFCH grouping examples in the example embodiment(s) may specify and/or indicate (e.g., and/or may include one or more parameters specifying and/or indicating) which PSFCH is belonging to which PSFCH group of multiple PSFCH groups and/or which of PSFCH groups has (or is associated with) what group priority order comparing with other PSFCH groups in the multiple PSFCH groups. The one or more PSFCH grouping examples and/or respective group priority order in the example embodiment(s) may be predefined in a specification for system implementation (e.g., for 3GPP, xG network/device (x may be an integer number representing a system generation, e.g., 5G, 6G, etc), Wi-fi, Bluetooth, and/or like). The one or more PSFCH grouping examples and/or respective group priority order in the example embodiment(s) may be implemented as configurable feature/option/function/parameters/configurations. For example, a first wireless device may receive, from a base station and/or a second wireless device, a message indicating at least one PSFCH grouping of the one or more PSFCH grouping examples and/or a respective group priority order between PSFCH groups in the at least one PSFCH grouping.

In the example embodiment(s) of the present disclosure, a priority value of a transmission (e.g., of a PSSCH, PSCCH, SL SSB, PSFCH) may be an indication indicating a priority (e.g., a priority level) of the transmission. In the example embodiment(s) of the present disclosure, a priority value of a reception (e.g., of a PSSCH, PSCCH, SL SSB, PSFCH) may be an indication indicating a priority (e.g., a priority level) of the reception. There may be a mapping between a particular priority value and a respective priority. The mapping may be predefined and/or preconfigured. The mapping may be configurable using (e.g., receiving and/or transmitting) a message (e.g., SIB, RRC message, MAC CE, and/or SCI/DCI/UCI). A priority value (e.g., a priority respective to the priority value) of a particular transmission and/or reception may be predefined. A wireless device may receive from and/or transmit to, a base station and/or another wireless device, a message and/or a signal (e.g., SIB, RRC message, MAC CE, SCI, DCI, and/or UCI) indicating a priority value (e.g., a priority respective to the priority value) of a particular transmission and/or of a particular reception.

In the example embodiment(s), the wireless device may determine a priority and/or a priority value is associated with a particular transmission, e.g., if the priority and/or the priority value of the particular transmission is predefined and/or if the wireless device receives from and/or transmits to, a base station and/or another wireless device, a message and/or a signal (e.g., SIB, RRC message, MAC CE, SCI, DCI, and/or UCI) indicating the priority and/or the priority value of the particular transmission.

In the example embodiment(s), the wireless device may determine a priority and/or a priority value is associated with a particular reception, e.g., if the priority and/or the priority value of the particular reception is predefined and/or if the wireless device receives from and/or transmits to, a base station and/or another wireless device, a message and/or a signal (e.g., SIB, RRC message, MAC CE, SCI, DCI, and/or UCI) indicating the priority and/or the priority value of the particular reception.

In the example embodiment(s), a priority value may be an integer value ranged from 1 to 8. The range (e.g., from 1 to 8) may be an example and may be different in different system implementation(s). In the example embodiment(s), a smaller priority value may indicate a higher priority. For example, the priority order of priorities may be (e.g., follow, depend, be the same as, and/or be based on) an ascending order of the priority values (e.g., and/or an inverse order of the priority values). For example, the priority values with a value ‘1’ and with a value ‘8’ indicate the highest priority and the lowest priority, respectively. In some implementation(s), the priority order of priorities may be a descending order of the priority values (e.g., and/or a same order of the priority values).

In the example embodiment(s) of the present disclosure, beam information may be referred to as sidelink beam information. Beam information may refer to any information that a wireless device generates, schedules to receive, schedules to transmit, receives, and/or transmits as a part of SL beam operation and/or during any of SL beam operation procedure (e.g., comprising a (e.g., initial) beam pairing procedure, beam management (e.g., maintenance) procedure, and/or SL beam failure detection/recovery procedure).

In the example embodiment(s) of the present disclosure, a wireless device determines that beam information is associated with the (e.g., initial) beam pairing procedure, e.g., if the beam information comprises any information (e.g., a beam report and/or a beam indication described in the example embodiment(s)) to be transmitted and/or received as a part of the (e.g., initial) beam pairing procedure as described in the example embodiment(s) of the present disclosure. For example, if the wireless device initiates, triggers, and/or determines the transmission and/or reception of the beam information as a part of the (e.g., initial) beam pairing procedure, the wireless device may determine that beam information is associated with the (e.g., initial) beam pairing procedure.

In the example embodiment(s) of the present disclosure, a wireless device determines that beam information is associated with the beam management (e.g., maintenance) procedure, e.g., if the beam information comprises any information (e.g., a SL RS report, a beam report and/or a beam indication described in the example embodiment(s) to be transmitted and/or received as a part of the beam management (e.g., maintenance) procedure as described in the example embodiment(s) of the present disclosure. For example, if the wireless device initiates, triggers, and/or determines the transmission and/or reception of the beam information as a part of the beam management (e.g., maintenance) procedure, the wireless device may determine that beam information is associated with the beam management (e.g., maintenance) procedure.

In the example embodiment(s) of the present disclosure, a wireless device determines that beam information is associated with the SL beam failure detection and/or recovery procedure, e.g., if the beam information comprises any information (e.g., a BFRR, BFRQ, a beam report and/or a beam indication described in the example embodiment(s) to be transmitted and/or received as a part of the SL beam failure detection and/or recovery procedure as described in the example embodiment(s) of the present disclosure. For example, if the wireless device initiates, triggers, and/or determines the transmission and/or reception of the beam information as a part of the SL beam failure detection and/or recovery procedure, the wireless device may determine that beam information is associated with the SL beam failure detection and/or recovery procedure.

In the example embodiment(s) of the present disclosure, a wireless device may determine a priority (and/or a priority value of the priority) of a PSFCH comprising (e.g., with and/or carrying) beam information. The priority (and/or a priority value of the priority) of the PSFCH comprising (e.g., with and/or carrying) beam information may be predefined. For example, the priority (and/or a priority value of the priority) of the PSFCH comprising (e.g., with and/or carrying) beam information may be predefined as a highest priority (e.g., and/or a priority value is 1 indicating the highest priority). For example, the priority (and/or a priority value of the priority) of the PSFCH comprising (e.g., with and/or carrying) beam information may be predefined as a lowest priority (e.g., and/or a priority value is 8 indicating the highest priority). For example, the priority (and/or a priority value of the priority) of the PSFCH comprising (e.g., with and/or carrying) beam information may be indicated by a priority field value in a SCI (e.g., that the wireless device transmits and/or receives) that indicates, requests, triggers, initiates, and/or schedules a transmission or reception of the PSFCH comprising beam information. For example, the priority (and/or a priority value of the priority) of the PSFCH comprising (e.g., with and/or carrying) beam information may be indicated by an upper layer(s) (e.g., MAC layer, RRC layer, and/or any layer above the RRC layer such as application layer). For example, the upper layer(s) may indicate the priority (and/or a priority value of the priority) of the PSFCH comprising (e.g., with and/or carrying) beam information. For example, the wireless device (e.g., the upper layer(s) of the wireless device) transmits and/or receives a control message/information (e.g., that may indicate, request, trigger, initiate, and/or schedule a transmission or reception of the PSFCH comprising beam information). The control message/information may comprises an indication and/or a field indicating the priority (and/or a priority value of the priority) of the PSFCH. For example, the control message/information may comprise at least one of MAC CE, SIB, SL RRC message, and/or RRC message.

In the example embodiment(s) of the present disclosure, conflict information may be referred to as sidelink conflict information. Conflict information (e.g., transmitted as a PSFCH via a PSFCH transmission occasion) may comprise information about resources to a peer UE, which the peer UE then uses for resource (re) selection. A wireless device that support inter-UE coordination (IUC) (e.g., IUC scheme) and/or is in resource allocation Mode 2 may transmit and/or receive the conflict information. For example, conflict information (e.g., may be referred to as IUC information) sent from a UE to a peer UE may be the presence of expected/potential resource conflict on the resources indicated by the peer UE's SCI. For example, a UE determines the expected/potential resource conflict within the resources indicated by a peer UE's SCI as either resources reserved by other UEs and identified by the UE as fully/partially overlapping with the resources indicated by the peer UE's SCI, or as slots where the UE is the intended receiver of the peer UE and does not expect to perform SL reception on those slots due to half-duplex operation. For example, the peer UE uses the conflicting resources to determine the resources to be reselected and exclude the conflicting resources from the reselected resources. A first priority (and/or a first priority value respective to the first priority) of PSFCH comprising (e.g., with and/or carrying) conflict information may be the same as a second priority (and/or a second priority value, respective to the second priority) indicated by a priority field value in a SCI (e.g., a peer UE's SCI and/or other UEs' SCI) that indicates, reserves, and/or schedules a sidelink transmission/reception via the resources, e.g., where the UE determines the expected/potential resource conflict. For example, in this case, the UE determines: that the second priority (and/or its respective priority value) is associated with the PSFCH (and/or with a PSFCH transmission of the PSFCH or PSFCH reception of the PSFCH); and/or that a corresponding priority field value of the PSFCH (and/or with a PSFCH transmission of the PSFCH is the priority field value indicating the second priority (and/or the second priority value).

Example embodiment(s) of the present disclosure provide a prioritization rule and/or priority order, of PSFCH groups, PSFCH transmission groups, and/or PSFCH reception groups, for determining and/or selecting a sidelink communication mode when transmission(s) of PSFCH(s) overlap in time with reception of PSFCH(s). Example embodiments of the present disclosure provide enhancement for a wireless device to properly determine the sidelink communication mode, when, the wireless device does not support simultaneous transmission and reception (e.g., full duplex). Example embodiment(s) provide a plurality of priority orders for determining a sidelink communication mode and/or selecting PSFCHs to transmit or receive. Depending on implementation and/or system design, a first wireless device may determine a sidelink communication mode and/or select PSFCHs to transmit or receive using any combination of the plurality of priority orders. Example embodiments of the present disclosure result in efficient use of sidelink radio resource and/or proper link management of a sidelink.

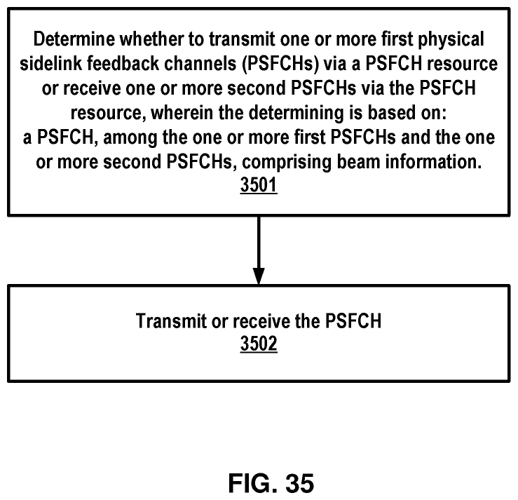

FIG. 35 illustrates an example flowchart of simultaneous PSFCH transmission and reception as per an aspect of an embodiment of the present disclosure. At 3501, a first wireless device may determine whether to transmit one or more first physical sidelink feedback channels (PSFCHs) (e.g., at least one of N_{sch,Tx,PSFCH} PSFCH(s) via a PSFCH resource (e.g., PSFCH occasion) or receive one or more second PSFCHs (e.g., at least one of N_{sch,Rx,PSFCH} PSFCH(s) via the PSFCH resource. For example, the determining whether to transmit or receive is based on a PSFCH, among the one or more first PSFCHs and the one or more second PSFCHs, comprising beam information. At 3502, the first wireless device may transmit or receive the PSFCH.

Referring to FIG. 35, the first wireless device may transmit, via the PSFCH resource, a first PSFCH (e.g., a set of PSFCHs and/or PSFCH group that comprising PSFCH comprising beam information) of the one or more first PSFCHs. For example, the transmitting is based on at least one of: the first PSFCH comprising beam information; the first PSFCH having a smallest priority value, among priority values of one or more first PSFCHs and the one or more second PSFCHs (e.g., among priority values of PSFCH(s) in a PSFCH group having PSFCH(s) comprising beam information); and/or the first PSFCH being from the one or more first PSFCHs.

Referring to FIG. 35, the first wireless device may not receive (e.g., cancel to receive], via the PSFCH resource, a second PSFCH (e.g., all PSFCHs) of the one or more second PSFCHs. For example, the not receiving may is at least one of: the first PSFCH comprising beam information; the first PSFCH having a smallest priority value, among priority values of one or more first PSFCHs and the one or more second PSFCHs; and/or the first PSFCH being from the one or more first PSFCHs.

Referring to FIG. 35, for example, the PSFCH is a first PSFCH, of the one or more first PSFCHs, that has a highest priority among the one or more first PSFCHs (e.g., among a PSFCH group having PSFCH(s) comprising beam information). For example, the PSFCH is a first PSFCH, of the one or more first PSFCHs, that has a smallest priority value (e.g., a smallest priority field value) among the one or more first PSFCHs (e.g., among a PSFCH group having PSFCH(s) comprising beam information).

Referring to FIG. 35, for example, the first wireless device transmit, via the PSFCH resource, a set of PSFCHs based on at least one of: the set of PSFCHs corresponding to a smallest priority value associated with (e.g., among) a first set of PSFCHs comprising and a second set of PSFCHs; the one or more first PSFCHs comprising PSFCH(s) in the first set of PSFCHs; at least first PSFCH (e.g., all PSFCHs), of the first set of PSFCHs, comprising beam information; the one or more second PSFCHs comprising PSFCH(s) in the second set of PSFCHs; the second set of PSFCHs comprising at least one second PSFCH comprising beam information; and/or none of the one or more second PSFCH comprising at least one PSFCH comprising beam information.

Referring to FIG. 35, for example, the first wireless device not receive (e.g., cancels to receive), via the PSFCH resource, at least one (e.g., or all PSFCHs) of the one or more second PSFCHs based on at least one of: a set of PSFCHs corresponding to a smallest priority value associated with (e.g., among) a first set of PSFCHs comprising and a second set of PSFCHs; the one or more first PSFCHs comprising PSFCH(s) in the first set of PSFCHs; at least first PSFCH (e.g., all PSFCHs), of the first set of PSFCHs, comprising beam information; the one or more second PSFCHs comprising PSFCH(s) in the second set of PSFCHs; the second set of PSFCHs comprising at least one second PSFCH comprising beam information; and/or none of the one or more second PSFCH comprising at least one PSFCH comprising beam information.

Referring to FIG. 35, for example, the first wireless device transmit one or more PSFCHs, of the one or more first PSFCHs, comprising HARQ information via the PSFCH resource. For example, the first wireless device transmit one or more PSFCHs, of the one or more first PSFCHs, comprising conflict information via the PSFCH resource.

Referring to FIG. 35, the first wireless device may not transmit (e.g., cancel to transmit), via the PSFCH resource, the one or more first PSFCHs. For example, the not transmitting is based on at least one of: a second PSFCH comprising beam information; the second PSFCH having a smallest priority value, among priority values of one or more first PSFCHs and the one or more second PSFCHs (e.g., among a PSFCH groups comprising PSFCH(s) comprising beam information); or the second PSFCH being from the one or more second PSFCHs.

Referring to FIG. 35, the first wireless device may receive, via the PSFCH resource, a second PSFCH (e.g., a set of PSFCHs) of the one or more second PSFCHs. For example, the receiving is based on at least one of: the second PSFCH comprising beam information; the second PSFCH having a smallest priority value, among priority values of one or more first PSFCHs and the one or more second PSFCHs; or the second PSFCH being from the one or more second PSFCHs.

Referring to FIG. 35, the PSFCH may comprise a second PSFCH, of the one or more second PSFCHs, that has a highest priority among the one or more second PSFCHs.

Referring to FIG. 35, the PSFCH may comprise a second PSFCH, of the one or more second PSFCHs, that has a smallest priority [field] value among the one or more second PSFCHs.

Referring to FIG. 35, the first wireless device may not transmitting, via the PSFCH resource, one or more first PSFCHs based on at least one of: a set of PSFCHs corresponding to a smallest priority value associated with (e.g., among) a first set of PSFCHs comprising and a second set of PSFCHs; the one or more first PSFCHs comprising PSFCH(s) in the first set of PSFCHs; the one or more second PSFCHs comprising PSFCH(s) in the second set of PSFCHs; at least second PSFCH (e.g., all PSFCHs), of the second set of PSFCHs, comprising beam information; the first set of PSFCHs comprising at least one first PSFCH comprising beam information; and/or none of the one or more first PSFCHs comprising at least one PSFCH comprising beam information.

Referring to FIG. 35, the first wireless device may receive, via the PSFCH resource, a set of PSFCH of the one or more second PSFCHs based on at least one of: the set of PSFCHs corresponding to a smallest priority value associated with (e.g., among) a first set of PSFCHs comprising and a second set of PSFCHs; the one or more first PSFCHs comprising PSFCH(s) in the first set of PSFCHs; the one or more second PSFCHs comprising PSFCH(s) in the second set of PSFCHs; at least second PSFCH (e.g., all PSFCHs), of the second set of PSFCHs, comprising beam information; the first set of PSFCHs comprising at least one first PSFCH comprising beam information; and/or none of the one or more first PSFCHs comprising at least one PSFCH comprising beam information.

Referring to FIG. 35, the first wireless device may receive one or more PSFCHs, of the one or more second PSFCHs, comprising HARQ information via the PSFCH resource, the first wireless device may receive one or more PSFCHs, of the one or more second PSFCHs, comprising conflict information via the PSFCH resource.

Clause 1. A method comprising: receiving, by a first wireless device, a message indicating a plurality of physical sidelink feedback channel (PSFCH) resources; determining whether to: transmit one or more first PSFCHs via a PSFCH resource of the plurality of PSFCH resources; or receive one or more second PSFCHs via the PSFCH resource, wherein the determining is based on a PSFCH, among the one or more first PSFCHs and the one or more second PSFCHs, comprising beam information; and transmitting or receiving, based on the determining, the PSFCH via the PSFCH resource.

Clause 2. A method comprising: determining, by a first wireless device, whether to: transmit one or more first sidelink feedbacks via a sidelink resource; or receive one or more second sidelink feedbacks via the sidelink resource, wherein the determining is based on a sidelink feedback, among the one or more first sidelink feedbacks and the one or more second sidelink feedbacks, comprising beam information; and based on the determining, transmitting or receiving, via the sidelink resource, at least one of the one or more first sidelink feedbacks or the one or more second sidelink feedbacks.

Clause 3. The method of clause 2, wherein the one or more first sidelink feedbacks comprise one or more first physical sidelink feedback channels (PSFCHs).

Clause 4. The method of any one of clauses 2-3, wherein the one or more second sidelink feedbacks comprise one or more second PSFCHs.

Clause 5. The method of any one of clauses 2-4, further comprising receiving, by a first wireless device, one or more messages indicating a plurality of sidelink resources, wherein the plurality of sidelink resources comprise: a plurality of PSFCH resources; or the sidelink resource.

Clause 6. The method of clause 5, wherein the at least one of the one or more first sidelink feedbacks or the one or more second sidelink feedbacks comprises the sidelink feedback comprising beam information.

Clause 7. The method of any one of clauses 2-6, wherein the sidelink resource comprises a PSFCH resource.

Clause 8. The method of any one of clauses 2-7, wherein the at least one of the one or more first sidelink feedbacks or the one or more second sidelink feedbacks comprises a first sidelink feedback, of the one or more first sidelink feedbacks, that has a highest priority among the one or more first sidelink feedbacks.

Clause 9. The method of any one of clauses 2-8, wherein the at least one of the one or more first sidelink feedbacks or the one or more second sidelink feedbacks comprises a first sidelink feedback, of the one or more first sidelink feedbacks, that has a smallest priority value among the one or more first sidelink feedbacks.

Clause 10. The method of any one of clauses 2-9, wherein the at least one of the one or more first sidelink feedbacks or the one or more second sidelink feedbacks comprises a second sidelink feedback, of the one or more second sidelink feedbacks, that has a highest priority among the one or more second sidelink feedbacks.

Clause 11. The method of any one of clauses 2-10, wherein the at least one of the one or more first sidelink feedbacks or the one or more second sidelink feedbacks comprises a second sidelink feedback, of the one or more second sidelink feedbacks, that has a smallest priority value among the one or more second sidelink feedbacks.

Clause 12. The method of any one of clauses 2-11, wherein the transmitting or the receiving the at least one of the one or more first sidelink feedbacks or the one or more second sidelink feedbacks comprises transmitting, via the sidelink resource, a first sidelink feedback of the one or more first sidelink feedbacks.

Clause 13. The method of clause 12, wherein the transmitting the first sidelink feedback is based on at least one of: the first sidelink feedback comprising beam information; the first sidelink feedback having a smallest priority value, among priority values of the one or more first sidelink feedbacks and the one or more second sidelink feedbacks; or the one or more first sidelink feedbacks comprising the first sidelink feedback.

Clause 14. The method of any one of clauses 2-13, wherein the transmitting or the receiving the at least one of the one or more first sidelink feedbacks or the one or more second sidelink feedbacks comprises not receiving, via the sidelink resource, the one or more second sidelink feedbacks.

Clause 15. The method of clause 14, wherein not receiving the one or more second sidelink feedback is based on at least one of: the first sidelink feedback comprising beam information; the first sidelink feedback having a smallest priority value, among priority values of the one or more first sidelink feedbacks and the one or more second sidelink feedbacks; or the one or more first sidelink feedbacks comprising the first sidelink feedback.

Clause 16. The method of any one of clauses 2-15, further comprising transmitting, via the sidelink resource, a set of sidelink feedbacks based on at least one of: the set of sidelink feedbacks corresponding to a smallest priority value associated with a first set of sidelink feedbacks and a second set of sidelink feedbacks; the set of sidelink feedbacks comprising the first sidelink feedback that has a smallest priority value among priority values of a plurality sidelink feedbacks in a first set of sidelink feedbacks and a second set of sidelink feedbacks; the one or more first sidelink feedbacks comprising one or more sidelink feedbacks in the first set of sidelink feedbacks; the one or more second sidelink feedbacks comprising one or more sidelink feedbacks in the second set of sidelink feedbacks; at least one first sidelink feedback, of the first set of sidelink feedbacks, comprising beam information; at least one second sidelink feedback, of the second set of sidelink feedbacks, comprising beam information; the first set of sidelink feedbacks comprising at least one first sidelink feedback comprising beam information; or none of the one or more second sidelink feedback comprising the beam information.

Clause 17. The method of any one of clauses 2-16, further comprising not receiving, via the sidelink resource, the one or more second sidelink feedbacks based on at least one of: a set of sidelink feedbacks corresponding to a smallest priority value associated with a first set of sidelink feedbacks and a second set of sidelink feedbacks; the set of sidelink feedbacks comprising a first sidelink feedback that has a smallest priority value among priority values of a plurality sidelink feedbacks in a first set of sidelink feedbacks and a second set of sidelink feedbacks; the one or more first sidelink feedbacks comprising one or more sidelink feedbacks in the first set of sidelink feedbacks; the one or more second sidelink feedbacks comprising one or more sidelink feedbacks in the second set of sidelink feedbacks; at least one first sidelink feedback, of the first set of sidelink feedbacks, comprising beam information; at least one second sidelink feedback, of the second set of sidelink feedbacks, comprising beam information; the first set of sidelink feedbacks comprising at least first sidelink feedback comprising beam information; or none of the one or more second sidelink feedbacks comprising the beam information.

Clause 18. The method of any one of clauses 2-17, wherein the at least one of the one or more first sidelink feedbacks or the one or more second sidelink feedbacks comprises a sidelink feedback comprising hybrid automatic repeat request (HARQ) information.

Clause 19. The method of any one of clauses 2-18, wherein the at least one of the one or more first sidelink feedbacks or the one or more second sidelink feedbacks comprises a sidelink feedback comprising conflict information.

Clause 20. The method of any one of clauses 2-11, wherein the transmitting or the receiving the at least one of the one or more first sidelink feedbacks or the one or more second sidelink feedbacks comprises not transmitting, via the sidelink resource, the one or more first sidelink feedbacks.

Clause 21. The method of any one of clauses 2-11 or 20, further comprising not transmitting, via the sidelink resource, the one or more first sidelink feedbacks is based on at least one of: a second sidelink feedback comprising beam information; the second sidelink feedback having a smallest priority value, among priority values of the one or more first sidelink feedbacks and the one or more second sidelink feedbacks; or the one or more second sidelink feedbacks comprising the second sidelink feedback.

Clause 22. The method of any one of clauses 2-11 or 20-21, wherein the transmitting or the receiving the at least one of the one or more first sidelink feedbacks or the one or more second sidelink feedbacks comprises receiving, via the sidelink resource, a second sidelink feedback of the one or more second sidelink feedbacks.

Clause 23. The method of clause 22, wherein the receiving the second sidelink feedback is based on at least one of: the second sidelink feedback comprising beam information; the second sidelink feedback having a smallest priority value, among priority values of one or more first sidelink feedbacks and the one or more second sidelink feedbacks; or the one or more second sidelink feedbacks comprising the second sidelink feedback.

Clause 24. The method of any one of clauses 2-11 or 20-23, further comprising the not transmitting, via the sidelink resource, the one or more first sidelink feedbacks is based on at least one of: a set of sidelink feedbacks corresponding to a smallest priority value associated with a first set of sidelink feedbacks and a second set of sidelink feedbacks; the set of sidelink feedbacks comprising the second sidelink feedback that has a smallest priority value among priority values of a first set of sidelink feedbacks and a second set of sidelink feedbacks; the one or more first sidelink feedbacks comprising one or more sidelink feedbacks in the first set of sidelink feedbacks; the one or more second sidelink feedbacks comprising one or more sidelink feedbacks in the second set of sidelink feedbacks; at least one first sidelink feedback, of the first set of sidelink feedbacks, comprising beam information; at least one second sidelink feedback, of the second set of sidelink feedbacks, comprising beam information; the second set of sidelink feedbacks comprising at least second sidelink feedback comprising beam information; or none of the one or more first sidelink feedbacks comprising the beam information.

Clause 25. The method of any one of clauses 2-11 or 20-24, further comprising receiving, via the sidelink resource, a set of sidelink feedbacks of the one or more second sidelink feedbacks based on at least one of: the set of sidelink feedbacks corresponding to a smallest priority value associated with a first set of sidelink feedbacks and a second set of sidelink feedbacks; the set of sidelink feedbacks comprising a second sidelink feedback that has a smallest priority value among priority values of a first set of sidelink feedbacks and a second set of sidelink feedbacks; the one or more first sidelink feedbacks comprising one or more sidelink feedbacks in the first set of sidelink feedbacks; the one or more second sidelink feedbacks comprising one or more sidelink feedbacks in the second set of sidelink feedbacks; at least one first sidelink feedback, of the first set of sidelink feedbacks, comprising beam information; at least one second sidelink feedback, of the second set of sidelink feedbacks, comprising the beam information; the second set of sidelink feedbacks comprising at least second sidelink feedback comprising beam information; or none of the one or more first sidelink feedbacks comprising the beam information.

Clause 26. The method of any one of clauses 2-11 or 20-25, wherein the at least one of the one or more first sidelink feedbacks or the one or more second sidelink feedbacks comprises a sidelink feedback comprising hybrid automatic repeat request (HARQ) information.

Clause 27. The method of any one of clauses 2-11 or 20-26, wherein the at least one of the one or more first sidelink feedbacks or the one or more second sidelink feedbacks comprises a sidelink feedback comprising conflict information.

Clause 28. The method of any one of clauses 2-27, wherein at least one of the one or more first sidelink feedbacks comprises a sidelink feedback comprising HARQ information.

Clause 29. The method of any one of clauses 2-27, wherein none of the one or more first sidelink feedbacks comprises a sidelink feedback comprising HARQ information.

Clause 30. The method of any one of clauses 2-29, wherein at least one of the one or more first sidelink feedbacks comprises a sidelink feedback comprising conflict information.

Clause 31. The method of any one of clauses 2-29, wherein none of the one or more first sidelink feedbacks comprises a sidelink feedback comprising conflict information.

Clause 32. The method of any one of clauses 2-31, wherein at least one of the one or more second sidelink feedbacks comprises a sidelink feedback comprising HARQ information.

Clause 33. The method of any one of clauses 2-31, wherein none of the one or more second sidelink feedbacks comprises a sidelink feedback comprising HARQ information.

Clause 34. The method of any one of clauses 2-33, wherein at least one of the one or more second sidelink feedbacks comprises a sidelink feedback comprising conflict information.

Clause 35. The method of any one of clauses 2-33, wherein none of the one or more second sidelink feedbacks comprises a sidelink feedback comprising conflict information.

Clause 36. The method of any one of clauses 2-35, wherein the beam information comprises at least one of: a sidelink beam report; a sidelink beam indication; a sidelink beam failure recovery request; a sidelink beam failure recovery response; an indication or identifier of a sidelink reference signal; an indication or identifier of a sidelink transmission configuration indication; an indication or identifier of a candidate beam; an indication or identifier of a preferred beam; a measurement quantity of a sidelink reference signal; an indication or identifier of a spatial filter for transmission; an indication or identifier of a spatial filter for reception; an indication or identifier of a sidelink beam pair; or an indication or identifier of beam switching.

Clause 37. The method of any one of clauses 2-36, wherein the transmitting or the receiving the at least one of the one or more first sidelink feedbacks or the one or more second sidelink feedbacks is based on at least one of: a sidelink beam management procedure; a sidelink beam failure detection or recovery procedure; or a sidelink beam pairing procedure.

Clause 38. A wireless device comprising: one or more processors; and memory storing instructions that, when executed by the one or more processors, cause the wireless device to perform the method of any one of clauses 1-37.

Clause 39. A non-transitory computer-readable medium comprising instructions that, when executed by one or more processors of a wireless device, cause the wireless device to perform the method of any one of clauses 1-37.

What is claimed is:

1. A first wireless device comprising:
one or more processors; and
memory storing instructions that, when executed by the one or more processors, cause the first wireless device to:
receive a message indicating a plurality of physical sidelink feedback channel (PSFCH) resources;
determine that:
one or more first PSFCHs are scheduled for transmission via a PSFCH resource of the plurality of PSFCH resources; and
one or more second PSFCHs are scheduled for reception via the PSFCH resource;
prioritize a first PSFCH over a second PSFCH based on the first PSFCH comprising beam information, wherein:
the first PSFCH is from one of the one or more first PSFCHs or the one or more second PSFCHs; and
the second PSFCH is from a different one of the one or more first PSFCHs or the one or more second PSFCHs; and
in response to prioritizing the first PSFCH over the second PSFCH:
transmit the first PSFCH via the PSFCH resource based on the first PSFCH being from the one or more first PSFCHs; or
receive the first PSFCH via the PSFCH resource based on the first PSFCH being from the one or more second PSFCHs.

2. The first wireless device of claim 1, wherein the first PSFCH has a higher priority than the second PSFCH.

3. The first wireless device of claim 1, wherein prioritizing the first PSFCH over the second PSFCH is further based on the first PSFCH having a smallest priority value among priority values of the one or more first PSFCHs and the one or more second PSFCHs.

4. The first wireless device of claim 1, wherein the instructions further cause the first wireless device to:
transmit the first PSFCH via the PSFCH resource; and
not receive, via the PSFCH resource, the one or more second PSFCHs.

5. The first wireless device of claim 1, wherein the instructions further cause the first wireless device to:
receive the first PSFCH via the PSFCH resource; and
not transmit, via the PSFCH resource, the one or more first PSFCHs.

6. The first wireless device of claim 1, wherein prioritizing the first PSFCH over the second PSFCH is further based on the second PSFCH comprising:
hybrid automatic repeat request (HARQ) information; or
conflict information.

7. The first wireless device of claim 1, wherein the beam information comprises at least one of:
a sidelink beam report;
a sidelink beam indication;
a sidelink beam failure recovery request; or
a sidelink beam failure recovery response.

8. A method comprising:
receiving, by a first wireless device, a message indicating a plurality of physical sidelink feedback channel (PSFCH) resources;
determining that:
one or more first PSFCHs are scheduled for transmission via a PSFCH resource of the plurality of PSFCH resources; and
one or more second PSFCHs are scheduled for reception via the PSFCH resource;
prioritizing a first PSFCH over a second PSFCH based on the first PSFCH comprising beam information, wherein:
the first PSFCH is from one of the one or more first PSFCHs or the one or more second PSFCHs; and
the second PSFCH is from a different one of the one or more first PSFCHs or the one or more second PSFCHs; and
in response to the prioritizing:
transmitting the first PSFCH via the PSFCH resource based on the first PSFCH being from the one or more first PSFCHs; or
receiving the first PSFCH via the PSFCH resource based on the first PSFCH being from the one or more second PSFCHs.

9. The method of claim 8, wherein the first PSFCH has a higher priority than the second PSFCH.

10. The method of claim 8, wherein the prioritizing the first PSFCH over the second PSFCH is further based on the first PSFCH having a smallest priority value among priority values of the one or more first PSFCHs and the one or more second PSFCHs.

11. The method of claim 8, further comprising:
transmitting the first PSFCH via the PSFCH resource; and
not receiving, via the PSFCH resource, the one or more second PSFCHs.

12. The method of claim 8, further comprising:
receiving the first PSFCH via the PSFCH resource; and
not transmitting, via the PSFCH resource, the one or more first PSFCHs.

13. The method of claim 8, wherein the prioritizing the first PSFCH over the second PSFCH is further based on the second PSFCH comprising:
hybrid automatic repeat request (HARQ) information; or
conflict information.

14. The method of claim 8, wherein the beam information comprises at least one of:
a sidelink beam report;
a sidelink beam indication;
a sidelink beam failure recovery request; or
a sidelink beam failure recovery response.

15. A non-transitory computer-readable medium comprising instructions that, when executed by one or more processors of a first wireless device, cause the first wireless device to:
receive a message indicating a plurality of physical sidelink feedback channel (PSFCH) resources;
determine that:
one or more first PSFCHs are scheduled for transmission via a PSFCH resource of the plurality of PSFCH resources; and
one or more second PSFCHs are scheduled for reception via the PSFCH resource;
prioritize a first PSFCH over a second PSFCH based on the first PSFCH comprising beam information, wherein:
the first PSFCH is from one of the one or more first PSFCHs or the one or more second PSFCHs; and
the second PSFCH is from a different one of the one or more first PSFCHs or the one or more second PSFCHs; and
in response to prioritizing the first PSFCH over the second PSFCH:
transmit the first PSFCH via the PSFCH resource based on the first PSFCH being from the one or more first PSFCHs; or
receive the first PSFCH via the PSFCH resource based on the first PSFCH being from the one or more second PSFCHs.

16. The non-transitory computer-readable medium of claim 15, wherein the first PSFCH has a higher priority than the second PSFCH.

17. The non-transitory computer-readable medium of claim 15, wherein prioritizing the first PSFCH over the second PSFCH is further based on the first PSFCH having a smallest priority value among priority values of the one or more first PSFCHs and the one or more second PSFCHs.

18. The non-transitory computer-readable medium of claim 15, wherein the instructions further cause the first wireless device to:
transmit the first PSFCH via the PSFCH resource; and
not receive, via the PSFCH resource, the one or more second PSFCHs.

19. The non-transitory computer-readable medium of claim 15, wherein the instructions further cause the first wireless device to:
receive the first PSFCH via the PSFCH resource; and
not transmit, via the PSFCH resource, the one or more first PSFCHs.

20. The non-transitory computer-readable medium of claim 15, wherein prioritizing the first PSFCH over the second PSFCH is further based on the second PSFCH comprising:
hybrid automatic repeat request (HARQ) information; or
conflict information.
